(19) United States
(12) Patent Application Publication
(10) Pub. No.: US 2026/0331129 A1
(43) Pub. Date: Oct. 22, 2026

(54) MAGNETIC RECORDING CARTRIDGE

(71) Applicant: SONY GROUP CORPORATION, TOKYO (JP)

(72) Inventors: MINORU YAMAGA, TOKYO (JP); TAKAHIRO TAKAYAMA, TOKYO (JP); NOBORU SEKIGUCHI, TOKYO (JP); FUTOSHI SASAKI, TOKYO (JP)

(21) Appl. No.: 19/122,815

(22) PCT Filed: Oct. 16, 2023
(86) PCT No.: PCT/JP2023/037333

§ 371 Date: Apr. 21, 2025

(30) Foreign Application Priority Data
Oct. 27, 2022 (JP) 2022-172384

(51) Int. Cl. G11B 5/008

(52) U.S. Cl. CPC G11B 5/00813

(57) ABSTRACT

An object is to provide a magnetic recording cartridge suited for storage and running under a high-temperature environment.

A magnetic recording cartridge that includes a cartridge case, a reel, and a magnetic recording medium, in which when a width change amount of the magnetic recording medium wound on the reel is measured, a sign of a width change amount Δout on an outer winding side and a sign of a width change amount Δin on an inner winding side differ, and the width change amount is 0 ppm at a position of one of two regions between which a center line of an entire length of the magnetic recording medium is situated, the two regions being from among four regions into which the entire length is quadrisected; the magnetic recording medium includes a magnetic layer; the magnetic layer has a concavo-convex shape on a magnetic surface thereof; a height range ΔH of a height of the concavo-convex shape satisfies “3.00 nm≤ΔH≤6.00 nm”; a gradient range ΔA of a gradient of the concavo-convex shape satisfies “3.80 degrees≤ΔA≤9.00 degrees”; and the magnetic recording medium includes a base layer.

### TECHNICAL FIELD

The present technology relates to a magnetic recording cartridge.

### BACKGROUND ART

With an increasing demand for archives, tape-type magnetic recording media having high total capacities are being incorporated into cloud systems. Since an actual running and storage environmental temperature range of current tape-type magnetic recording media is narrower than that of an HDD (Hard Disk Drive), a semiconductor memory, and the like, it is desired to expand the actual running and storage environmental temperature range of the tape-type magnetic recording media. If the tape-type magnetic recording media are enabled to be used under a temperature environment similar to that of the HDD, the semiconductor memory, and the like, a range of use of the tape-type magnetic recording media is considered to expand largely.

In a tape-type magnetic recording medium, when a dimension in a width direction of the magnetic recording medium changes significantly due to an environmental change, off-track occurs, and it becomes difficult to ensure stable recording/reproducing characteristics. Patent Literature 1 proposes a tape-type magnetic recording medium capable of correcting, even if the dimension in the width direction of the tape-type magnetic recording medium changes due to an environmental change, a width change by adjusting a tension applied in a longitudinal direction of the tape-type magnetic recording medium using a recording/reproducing device. In addition, in order to deal with the width change in the tape-type magnetic recording medium, Patent Literature 2 proposes that a data write head be arranged to be tilted with respect to the width direction of the tape-type magnetic recording medium.

### CITATION LIST

### Patent Literature

Patent Literature 1: Japanese Patent Application Laid-open No. 2020-173882
Patent Literature 2: Japanese Patent Application Laid-open No. 2005-259198

### DISCLOSURE OF INVENTION

### Technical Problem

It is an object of the present technology to provide a magnetic recording cartridge suited for storage and running under a high-temperature environment.

### Solution to Problem

The present technology provides a magnetic recording cartridge that includes
a cartridge case;
a reel; and
a magnetic recording medium wound on the reel, the wound magnetic recording medium being accommodated in the cartridge case, in which
when a width change amount of the magnetic recording medium is measured across an entire length of the magnetic recording medium after the magnetic recording medium wound on the reel is stored at 65° C. for 360 hours,
   a sign of a width change amount Δout on an outer winding side of the magnetic recording medium and a sign of a width change amount Δin on an inner winding side of the magnetic recording medium differ, and
   the width change amount is 0 ppm at a position of one of two regions between which a center line of the entire length of the magnetic recording medium is situated, the two regions being from among four regions into which the entire length is quadrisected,
the magnetic recording medium includes a magnetic layer,
the magnetic layer has a concavo-convex shape on a magnetic surface thereof,
a height range ΔH obtained from statistical information regarding a height of the concavo-convex shape satisfies “3.00 nm≤ΔH≤6.00 nm”,
a gradient range ΔA obtained from statistical information regarding a gradient of the concavo-convex shape satisfies “3.80 degrees≤ΔA≤9.00 degrees”, and
the magnetic recording medium includes a base layer having a loss elastic modulus of 0.40 GPa or less at 65° C.

In the magnetic recording cartridge according to the present technology, the width change amount Δin of the magnetic recording medium may exhibit a positive value, and the width change amount Δout of the magnetic recording medium may exhibit a negative value.

In the magnetic recording cartridge according to the present technology, when the entire length of the magnetic recording medium in a longitudinal direction of the magnetic recording medium is set to be 100%, the width change amount Δ of the magnetic recording medium after being stored at 65° C. for 360 hours may be 0 ppm at a position corresponding to a length of 25% to 75% as viewed from an end portion of the magnetic recording medium on the outer winding side.

In the magnetic recording cartridge according to the present technology, the width change amount Δin of the magnetic recording medium minus the width change amount Δout of the magnetic recording medium may be 800 ppm or less with respect to the magnetic recording medium.

In the magnetic recording cartridge according to the present technology, a storage elastic modulus of the base layer at 65° C. may be 8.0 GPa or less.

In the magnetic recording cartridge according to the present technology, the base layer may be formed of polyethylene terephthalate (PET), polyethylene naphthalate (PEN), or polyether ether ketone (PEEK).

In the magnetic recording cartridge according to the present technology, an average thickness t_{T} of the magnetic recording medium may be 5.4 μm or less.

In the magnetic recording cartridge according to the present technology, an average thickness t_{B} of the base layer may be 4.6 μm or less.

In the magnetic recording cartridge according to the present technology, the magnetic layer may contain magnetic powder.

In the magnetic recording cartridge according to the present technology, the magnetic layer may contain magnetic particles, first particles having electrical conductivity, and second particles having a polishing effect, the concavo-convex shape may include first protrusions formed of the first particles and second protrusions formed of the second particles, and a ratio H1/H2 of an average height H1 of the first protrusions to an average height H2 of the second protrusions may satisfy “H1/H2≤2.3”.

In the magnetic recording cartridge according to the present technology, the ratio H1/H2 may satisfy “1.0≤H1/H2≤1.7 or less”.

In the magnetic recording cartridge according to the present technology, the height range ΔH may satisfy “3.00 nm≤ΔH≤4.00 nm”.

In the magnetic recording cartridge according to the present technology, the average height H1 of the first protrusions may be 5.0 nm or more and 12.0 nm or less, and the average height H2 of the second protrusions may be 2.0 nm or more and 7.0 nm or less.

In the magnetic recording cartridge according to the present technology, the first particles may be carbon particles.

In the magnetic recording cartridge according to the present technology, the second particles may be alumina particles.

In the magnetic recording cartridge according to the present technology, an average thickness of the magnetic layer may be 80 nm or less.

In the magnetic recording cartridge according to the present technology, the magnetic recording medium may further include an underlayer having an average thickness of 0.9 μm or less.

In the magnetic recording cartridge according to the present technology, an average particle volume of the magnetic particles may be 1600 nm³ or less.

In the magnetic recording cartridge according to the present technology, the magnetic layer may contain magnetic particles, carbon particles, and an abrasive, the concavo-convex shape may include first protrusions formed of the carbon particles, and second protrusions formed of the abrasive, and a ratio H1/H2 of an average height H1 of the first protrusions to an average height H2 of the second protrusions may satisfy “H1/H2≤2.3”.

The present technology provides a magnetic recording medium wound on a reel of a magnetic recording cartridge, the wound magnetic recording medium being accommodated in a cartridge case of the magnetic recording cartridge, in which
when a width change amount of the magnetic recording medium is measured across an entire length of the magnetic recording medium after the magnetic recording medium wound on the reel is stored at 65° C. for 360 hours,
   a sign of a width change amount Δout on an outer winding side of the magnetic recording medium and a sign of a width change amount Δin on an inner winding side of the magnetic recording medium differ, and
   the width change amount is 0 ppm at a position of one of two regions between which a center line of the entire length of the magnetic recording medium is situated, the two regions being from among four regions into which the entire length is quadrisected,
the magnetic recording medium includes a magnetic layer,
the magnetic layer has a concavo-convex shape on a magnetic surface thereof,
a height range ΔH obtained from statistical information regarding a height of the concavo-convex shape satisfies “3.00 nm≤ΔH≤6.00 nm”,
a gradient range ΔA obtained from statistical information regarding a gradient of the concavo-convex shape satisfies “3.80 degrees≤ΔA≤9.00 degrees”, and
the magnetic recording medium includes a base layer having a loss elastic modulus of 0.40 GPa or less at 65° C.

### BRIEF DESCRIPTION OF DRAWINGS

FIG. 1 is an exploded perspective view showing an exemplary configuration of a magnetic recording cartridge according to a first embodiment.

FIG. 2 is a block diagram showing an exemplary configuration of a cartridge memory.

FIG. 3 is a cross-sectional view showing an exemplary configuration of a magnetic tape.

FIG. 4 is a perspective view showing an example of a particle shape.

FIG. 5 is a diagram showing an example of a TEM picture of a magnetic layer.

FIG. 6 is a diagram showing an example of the TEM picture of the magnetic layer.

FIG. 7 is a diagram for explaining a measurement method of a servo band pitch that uses a data recording/reproducing device.

FIG. 8 is a diagram for explaining a measurement method of a servo trace line.

FIG. 9 is a schematic diagram in which the magnetic tape is seen from the side.

FIG. 10 is a schematic diagram in which the magnetic tape is seen from above (magnetic layer side).

FIG. 11 is a diagram showing the data recording/reproducing device.

FIG. 12 is a schematic diagram in which a data write head is seen from below (back layer side).

FIG. 13 is a diagram showing a relationship between an angle range Refθ±x° of an azimuth angle of the data write head and an azimuth loss LO (recording wavelength: 0.1 μm).

FIG. 14 is a diagram showing a relationship between the angle range Refθ±x° at the azimuth angle θ of the data write head and a correction amount with respect to a servo band pitch difference that is based on a width variation of the magnetic tape.

FIG. 15 is a diagram showing the correction amount with respect to the servo band pitch difference that is based on the width variation of the magnetic tape.

FIG. 16 is a diagram showing a relationship between the angle range Refθ±x° at the azimuth angle θ of the data write head and the azimuth loss Lθ (recording wavelength: 0.07 μm).

FIG. 17 is a diagram showing a servo recording/reproducing device.

FIG. 18 is a diagram showing a servo write head and pulse signals input to the servo write head according to Embodiment A.

FIG. 19 is an enlarged view of a servo element included in the servo write head according to Embodiment A.

FIG. 20 is a diagram showing a state where servo patterns are written in the magnetic tape by the servo write head according to Embodiment A.

FIG. 21 is an enlarged view of a servo write head and a servo element included in the servo write head according to Embodiment B.

FIG. 22 is a diagram showing a state where servo patterns are written in the magnetic tape by the servo write head according to Embodiment B.

FIG. 23 is a diagram showing the servo write head using a coordinate system of the servo write head as a reference in Embodiment B.

FIG. 24 is a diagram showing a state where servo patterns are read by a servo read portion of the data write head in a first comparative example, a second comparative example, and the first embodiment.

FIG. 25 is an enlarged view of the diagram on the right side of FIG. 21, that shows an example of specific dimensions of a first servo element and a second servo element (based on XYZ coordinate system).

FIG. 26 is an enlarged view of the diagram on the right side of FIG. 23, that shows an example of specific dimensions of the first servo element and the second servo element (based on X″Y″Z″ coordinate system).

FIG. 27 is a diagram showing a first example of a method of confirming whether the magnetic tape is a magnetic tape used in a data-write-head-tilted-type data recording/reproducing device.

FIG. 28 is a diagram showing a second example of the method of confirming whether the magnetic tape is a magnetic tape used in the data-write-head-tilted-type data recording/reproducing device.

FIG. 29 is a cross-sectional view showing an exemplary configuration of a magnetic tape according to a second embodiment.

FIG. 30 is a schematic diagram showing a configuration of a sputtering device.

FIG. 31 is a cross-sectional view showing an exemplary configuration of a magnetic tape according to a third embodiment.

FIG. 32 is an exploded perspective view showing an exemplary configuration of a cartridge according to a modified example of the first embodiment.

FIG. 33 is a diagram showing a state where an entire length of the magnetic tape is quadrisected into four regions.

FIG. 34 is a diagram showing a width change amount of the magnetic tape in a longitudinal direction after being stored at 65° C. for 360 hours according to Example 1.

FIG. 35 is a diagram showing the width change amount of the magnetic tape in the longitudinal direction after being stored at 65° C. for 360 hours according to Example 2a.

FIG. 36 is a diagram showing the width change amount of the magnetic tape in the longitudinal direction after being stored at 65° C. for 360 hours according to Example 3.

FIG. 37 is a diagram showing the width change amount of the magnetic tape in the longitudinal direction after being stored at 65° C. for 360 hours according to Comparative Example 1a.

FIG. 38 is a diagram showing the width change amount of the magnetic tape in the longitudinal direction after being stored at 65° C. for 360 hours according to Comparative Example 2.

FIG. 39 is a diagram showing the width change amount of the magnetic tape in the longitudinal direction after being stored at 65° C. for 360 hours according to Comparative Example 3.

FIG. 40 is a diagram showing the width change amount of the magnetic tape in the longitudinal direction after being stored at 65° C. for 360 hours according to Comparative Example 4.

FIG. 41 is a schematic diagram for explaining a calculation method of a movement angle of a drive head arranged to be tilted.

FIG. 42 is a cross-sectional view showing an exemplary configuration of a magnetic surface.

FIG. 43 is a diagram showing an example of a FE-SEM image of a surface of the magnetic layer.

FIG. 44 is a diagram showing an example of a synthetic image obtained by an AFM image and the FE-SEM image overlapping.

FIG. 45 is an enlarged view showing an example of the synthetic image obtained by the AFM image and the FE-SEM image overlapping.

FIG. 46 is a diagram showing an example of a cross section profile in Line 1 (Line1) in FIG. 45.

FIG. 47 is a graph showing a first example of a temporal change of a standard deviation σPES.

FIG. 48 is a graph showing a second example of the temporal change of the standard deviation σPES.

FIG. 49 is a diagram that includes a graph showing a third example of the temporal change of the standard deviation σPES, and cross-sectional views schematically showing a change of a state of second protrusions on the surface of the magnetic layer.

FIG. 50 is a set of schematic diagrams each showing a relationship between first and second protrusions and the data write head.

FIG. 51 is an enlarged view showing an exemplary configuration of a servo band that is used for explaining a PES measurement method.

FIG. 52 is a diagram for explaining the PES measurement method.

FIG. 53 is a graph for explaining a correction of a movement in a width direction of the magnetic tape.

A of FIG. 54 is a diagram showing an example of a 2D surface profile image obtained after a filter operation, and B of FIG. 54 is a diagram showing an example of a numerical data matrix of a height ζ(L, W).

FIG. 55 is a diagram showing an example of a numerical data matrix of a relative height Z (L, W).

FIG. 56 is a diagram for explaining a method of calculating gradients G_{L} (L, W) and G_{W} (L, W) at respective points (L, W).

A of FIG. 57 is a diagram showing an example of a numerical data matrix of the gradient G_{L} (L, W), and B of FIG. 57 is a diagram showing an example of a numerical data matrix of the gradient G_{W} (L, W).

A of FIG. 58 is a diagram showing a calculation method of the gradient G_{L} (L, W), and B of FIG. 58 is a diagram showing a calculation method of the gradient G_{W} (L, W).

FIG. 59 is a diagram for explaining data statistical processing of the relative height Z (L, W) and the gradient G_{L}(L, W).

FIG. 60 is a diagram for explaining data statistical processing of the relative height Z (L, W) and the gradient G_{W}(L, W).

FIG. 61 is a diagram for explaining data statistical processing of the relative height Z (L, W), the gradient G_{L} (L, W), and the gradient G_{W} (L, W).

FIG. 62 is a diagram for explaining procedures for creating a distribution map from a numerical data matrix of the number of data M (H, A).

FIG. 63 is a diagram for explaining a calculation method of a height range ΔH.

FIG. 64 is a diagram for explaining the calculation method of the height range ΔH.

FIG. 65 is a diagram for explaining a calculation method of a gradient range ΔA.

FIG. 66 is a diagram for explaining the calculation method of the gradient range ΔA.

### MODES FOR CARRYING OUT THE INVENTION

Hereinafter, favorable modes for carrying out the present technology will be described. It is noted that embodiments described below show representative embodiments of the present technology, and a technical scope of the present technology is not limited to these embodiments.

Descriptions on the present technology will be given in the following order.
1. Descriptions on present technology
2. First embodiment (example of magnetic recording cartridge including coating-type magnetic tape)
   (1) Configuration of magnetic recording cartridge
   (2) Configuration of magnetic tape
   (3) Manufacturing method of magnetic tape
   (4) Descriptions on data band and servo band of magnetic tape
   (5) Operation and effect
3. Second embodiment (example of magnetic recording cartridge including vacuum thin-film-type magnetic tape)
   (1) Configuration of magnetic recording cartridge
   (2) Configuration of magnetic tape
   (3) Configuration of sputtering device
   (4) Manufacturing method of magnetic tape
   (5) Operation and effect
4. Third embodiment (example of magnetic recording cartridge including vacuum-thin-film-type magnetic tape)
   (1) Configuration of magnetic recording cartridge
   (2) Configuration of magnetic tape
   (3) Operation and effect
5. Modified examples
6. Examples

### 1. DESCRIPTIONS ON PRESENT TECHNOLOGY

There is a demand for a further increase in a recording capacity per magnetic recording cartridge. For example, in order to increase the recording capacity, making a magnetic recording medium (hereinafter, will be referred to as “magnetic tape”) included in the magnetic recording cartridge thinner (reducing a total thickness) to increase a tape length per magnetic recording cartridge is conceivable.

However, as the magnetic recording medium becomes thinner, a dimensional change in a track width direction may occur more easily. The dimensional change in the width direction may cause a phenomenon undesired for magnetic recording, such as an off-track phenomenon. The off-track phenomenon refers to a phenomenon in which a target track does not exist at a track position to be read by a magnetic head, or the magnetic head reads a wrong track position.

The magnetic tape included in the magnetic recording cartridge has a narrower usable temperature range than an HDD, and has been used in a temperature range up to 45° C. By enabling the magnetic recording cartridge to be used under a high-temperature environment of 60° C. or more similar to the HDD, it is expected that temperature environment management will become easier when incorporating the magnetic recording cartridge into a data storage system such as a cloud system, and that a range of use of a tape storage system will be greatly expanded.

However, when the magnetic tape wound on a reel of the magnetic recording cartridge is stored under a high-temperature environment of 60° C. or more, a portion on an inner winding side that is subjected to a high winding stress tends to widen in the width direction of the magnetic tape, while a portion on an outer winding side that is pulled in a longitudinal direction by a tension applied to the magnetic tape tends to narrow in the width direction due to a creep phenomenon, with the result that a difference in width between the inner winding side and the outer winding side becomes large.

Conventionally, for suppressing a dimensional change of the magnetic tape, for example, a method of adding a layer for suppressing a dimensional change of the magnetic tape, or the like has been performed.

However, the addition of the layer may increase a thickness of the magnetic tape and does not increase the tape length per cartridge product.

In light of the circumstances described above, the present inventors have discussed a magnetic recording cartridge having a high recording capacity per cartridge. As a result, the present inventors have found that a magnetic recording cartridge having a specific configuration has a high recording capacity, and that even when stored under a high-temperature environment of 60° C. or more, the width in the longitudinal direction can be corrected by performing a running tension adjustment of a tape system or changing a winding direction. It is noted that the change of the winding direction, for example, is realized by winding the magnetic tape on a drive-side reel in advance in a one-reel cartridge, and is realized by rewinding the magnetic tape on a reel opposite to the stored state in a two-reel cartridge. For example, to realize this, if the magnetic tape has been stored in a state of being wound on a left reel, the magnetic tape may be rewound on a right reel.

That is, the present technology provides a magnetic recording cartridge including a cartridge case, a reel, and a magnetic tape wound on the reel, the wound magnetic tape being accommodated in the cartridge case. The magnetic tape includes a base layer having a loss elastic modulus of 0.40 GPa or less at 65° C. When a width change amount of the magnetic tape is measured across an entire length of the magnetic tape after the magnetic tape wound on the reel is stored at 65° C. for 360 hours, a sign of a width change amount Δout on an outer winding side of the magnetic tape and a sign of a width change amount Δin on an inner winding side of the magnetic tape differ, and the width change amount is 0 ppm at a position of one of two regions between which a center line of the entire length of the magnetic tape is situated, the two regions being from among four regions into which the entire length of the magnetic tape is quadrisected. The measurement method of the width change amount of the magnetic tape will be described in (2) in Section 2 below.

The loss elastic modulus of the base layer of the magnetic tape included in the magnetic recording cartridge according to the present technology at 65° C. may be 0.40 GPa or less, favorably 0.35 GPa or less, more favorably 0.30 GPa or less, further more favorably 0.25 GPa or less, further more favorably 0.20 GPa or less. By setting the loss elastic modulus of the base layer of the magnetic tape at 65° C. to be within the numerical value range described above, even when stored under the high-temperature environment of 60° C. or more, the width in the longitudinal direction can be corrected by performing the running tension adjustment of the tape system or changing the winding direction.

Further, a lower limit of the loss elastic modulus of the base layer at 65° C. is not limited in particular and may be, for example, favorably 0.01 GPa or more, more favorably 0.02 GPa or more, further more favorably 0.03 GPa or more. The measurement method of the loss elastic modulus of the base layer at 65° C. will be described in (2) in Section 2 below.

A storage elastic modulus of the base layer of the magnetic tape included in the magnetic recording cartridge according to the present technology at 65° C. may be favorably 8.0 GPa or less, more favorably 7.0 GPa or less, further more favorably 6.0 GPa or less. It is possible to provide a magnetic recording cartridge in which, by setting the storage elastic modulus of the base layer of the magnetic tape at 65° C. to be within the numerical value range described above, even when stored under the high-temperature environment, the width of the magnetic tape in the longitudinal direction can be corrected by performing the running tension adjustment of the tape system or changing the winding direction.

Further, a lower limit of the storage elastic modulus of the base layer at 65° C. is not limited in particular and may be, for example, favorably 0.01 GPa or more, more favorably 0.02 GPa or more, further more favorably 0.03 GPa or more. The measurement method of the storage elastic modulus of the base layer at 65° C. will be described in (2) in Section 2 below.

In the magnetic recording cartridge according to the present technology, when the magnetic tape is reeled in by the reel and the width change amount of the magnetic tape is measured across the entire length of the magnetic tape after being stored at 65° C. for 360 hours, the sign of the width change amount Δout on the outer winding side of the magnetic tape and the sign of the width change amount Δin on the inner winding side of the magnetic tape differ. It is noted that the width change amount Δ can be expressed by the following equation.

Width change amount Δ=(width change amount after storage at 65° C. for 360 hours−width change amount in initial state)/(width change amount in initial state)

When the width change amount Δ exhibits a negative value, it indicates that the width after storage is narrower than the width in the initial state, and when the width change amount Δ exhibits a positive value, it indicates that the width after storage is wider than the width in the initial state.

There are magnetic recording cartridges that have one reel in a cartridge and magnetic recording cartridges that have two reels. In both types of magnetic recording cartridges, a magnetic tape is reeled in by the reel and accommodated in the magnetic cartridge. During manufacturing of the magnetic cartridge, as the magnetic tape is reeled in by the reel, the magnetic tape is laminated to form a laminated body of the magnetic tape. In the present specification, the inner winding side of the magnetic tape refers to a region on an innermost layer side of the laminated body of the magnetic tape in a state where the magnetic tape is reeled in by one reel to form a laminated body on the one reel before first data recording is performed in the magnetic cartridge, and the outer winding side of the magnetic tape refers to a region on an outermost layer side of the laminated body of the magnetic tape. More specifically, the inner winding side of the magnetic tape refers to a region starting from the end portion (hereinafter, will also be referred to as “inner end portion” (EOT)) that is attached to the reel in the magnetic recording cartridge (the reel that reels in the magnetic tape before first data recording is performed in the magnetic cartridge) out of the two end portions of the magnetic tape to a position that is a predetermined distance ahead of the position in a direction of the end portion on the opposite side of the inner end portion (hereinafter, will also be referred to as “outer end portion” (BOT)).

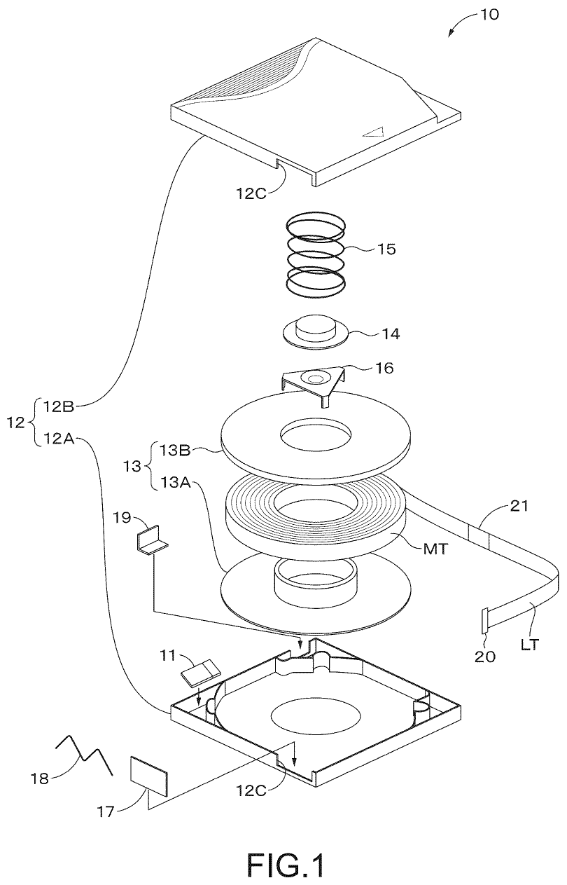

In the magnetic recording cartridge including one reel shown in FIG. 1, the inner winding side of the magnetic tape refers to a region starting from an end portion attached to a reel 13 before first data recording is performed (hereinafter, will also be referred to as “inner end portion” (EOT)) to a position that is a predetermined distance ahead of the position in the direction of the end portion on the opposite side of the inner end portion (hereinafter, will also be referred to as “outer end portion” (BOT)). The outer winding side of the magnetic tape refers to a region starting from the outer end portion out of the two end portions of the magnetic tape to a position that is a predetermined distance ahead of the position in the direction of the inner end portion.

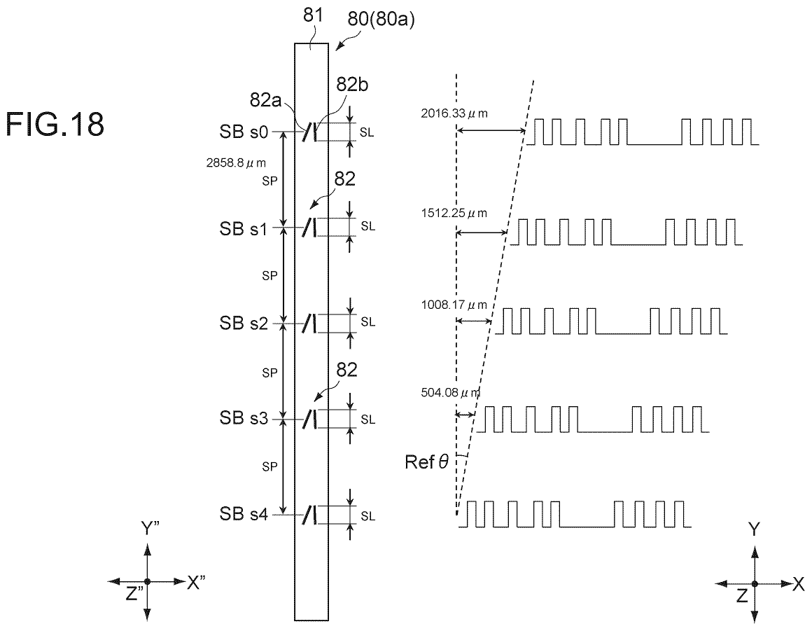

In the magnetic recording cartridge including two reels shown in FIG. 18, the inner winding side of the magnetic tape refers to a region starting from an end portion attached to a reel 307 before first data recording is performed (hereinafter, will also be referred to as “inner end portion” (EOT)) to a position that is a predetermined distance ahead of the position in the direction of the end portion on the opposite side of the inner end portion (hereinafter, will also be referred to as “outer end portion” (BOT)). The outer winding side of the magnetic tape refers to a region starting from the outer end portion out of the two end portions of the magnetic tape to a position that is a predetermined distance ahead of the position in the direction of the inner end portion.

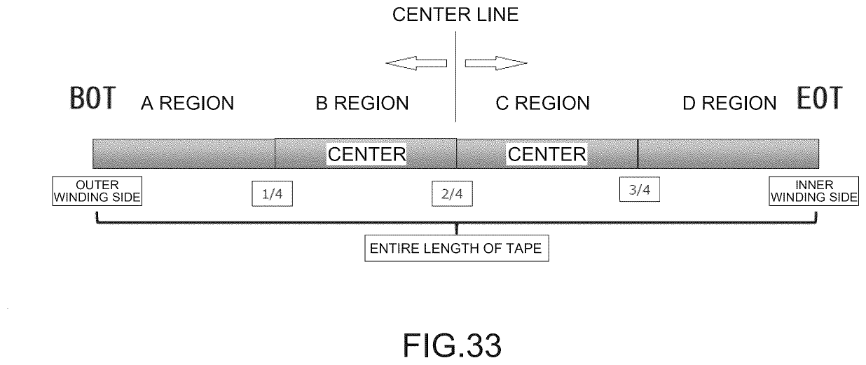

The inner winding side and outer winding side of the magnetic tape will be specifically described with reference to FIG. 33. FIG. 33 is a schematic diagram showing a state where an entire length of the magnetic tape is equally quadrisected into four regions from the inner winding side end portion (EOT) to the outer winding side end portion (BOT). As shown in FIG. 33, the entire length of the tape is divided into four regions including a D region, a C region, a B region, and an A region in the stated order from the EOT toward the BOT. In the present specification, the A region in FIG. 33 is the outer winding side, and the D region is the inner winding side.

In the magnetic recording cartridge according to the present technology, the width change amount is 0 ppm at a position of one of the two regions between which a center line of the entire length of the magnetic tape is situated, the two regions being from among four regions into which the entire length of the magnetic tape is quadrisected. This will be described with reference to FIG. 33. FIG. 33 is a schematic diagram showing the state where the entire length of the magnetic tape is equally quadrisected into four regions from the inner winding side end portion (EOT) to the outer winding side end portion (BOT). As shown in FIG. 33, the entire length of the tape is divided into four regions including the D region, the C region, the B region, and the A region in the stated order from the EOT toward the BOT. As shown in FIG. 33, the center line of the entire length of the magnetic tape is positioned between the B region and the C region and is thus a boundary that sections the B region and the C region, so the two regions between which the center line is situated are the B region and the C region. In the magnetic recording cartridge according to the present technology, the width change amount becomes 0 ppm at either of the positions of the B region and the C region.

In the magnetic recording cartridge according to the present technology, the width change amount Δin on the inner winding side of the magnetic tape may exhibit a positive value. Herein, the width change amount Δin on the inner winding side of the magnetic tape means a maximum amount of the width change amount on the inner winding side of the magnetic tape. The width change amount Δin on the inner winding side of the magnetic tape exhibiting a positive value means that the width on the inner winding side after storage is larger than the width in the initial state.

In the magnetic recording cartridge according to the present technology, the width change amount Δout on the outer winding side of the magnetic tape may exhibit a negative value. Herein, the width change amount Δout on the outer winding side of the magnetic tape means a minimum amount of the width change amount on the outer winding side of the magnetic tape. The width change amount Δout on the outer winding side of the magnetic tape exhibiting a negative value means that the width on the outer winding side after storage is smaller than the width in the initial state.

Further, when the entire length of the magnetic tape in the longitudinal direction is set to be 100%, the width change amount Δ of the magnetic tape after being stored at 65° C. for 360 hours may favorably be 0 ppm at a position corresponding to a length of 25% to 75% as viewed from the outer winding side end portion (BOT) of the magnetic tape. In the magnetic tape shown in FIG. 33, the width change amount Δ of the magnetic tape after being stored at 65° C. for 360 hours may be 0 ppm at either of the positions of the B region and the C region that correspond to the position corresponding to a length of 25% to 75% as viewed from the outer winding side end portion (BOT) of the magnetic tape.

Furthermore, in the magnetic tape in which the entire length is quadrisected into four regions as shown in FIG. 33, an average value of the width changes Δ in the A region corresponding to a ¼ portion of the magnetic tape on the outer winding side may favorably be a negative value, and an average value of the width changes Δ in the D region corresponding to a ¼ portion of the magnetic tape on the inner winding side may favorably be a positive value.

Moreover, in the magnetic tape, width change amount Δin on inner winding side of magnetic tape minus width change amount Δout on outer winding side of magnetic tape may be 800 ppm or less.

The magnetic tape included in the magnetic recording cartridge according to the present technology is favorably an elongated magnetic tape and may be, for example, a magnetic recording tape (elongated magnetic recording tape in particular).

The magnetic tape included in the magnetic recording cartridge according to the present technology may include a magnetic layer, a base layer, and a back layer, and may include other layers in addition to these layers. The other layers may be selected as appropriate in accordance with the type of the magnetic tape. The magnetic tape may be, for example, a coating-type magnetic tape or a vacuum thin-film-type magnetic tape. The coating-type magnetic tape will be described in more detail in Section 2 below. The vacuum thin-film-type magnetic tape will be described in more detail in Section 3 below. For layers other than the three layers described above that are included in the magnetic tape, refer to these descriptions.

The magnetic tape included in the magnetic recording cartridge according to the present technology may include, for example, at least one data band and at least two servo bands. The number of data bands may be, for example, 2 to 10, particularly 3 to 6, more particularly 4 or 5. The number of servo bands may be, for example, 3 to 11, particularly 4 to 7, more particularly 5 or 6. For example, these servo bands and data bands may be arranged to extend in the longitudinal direction of the elongated magnetic tape, particularly, to be substantially parallel. The data band and the servo band may be provided in the magnetic layer. An example of the magnetic tape including the data band and the servo band in this manner is a magnetic recording tape conforming to an LTO (Linear Tape-Open) standard. In other words, the magnetic tape may be a magnetic recording tape conforming to the LTO standard. For example, the magnetic tape may be a magnetic recording tape conforming to an LTO9 standard or subsequent standards (for example, LTO10, LTO11, LTO12, or the like).

The width of the elongated magnetic tape (magnetic recording tape in particular) may be, for example, 5 mm to 30 mm, particularly 7 mm to 25 mm, more particularly 10 mm to 20 mm, further more particularly 11 mm to 19 mm. The length of the elongated magnetic tape may be, for example, 500 m to 1500 m. For example, a tape width conforming to an LTO8 standard is 12.65 mm, and a length is 960 m.

### 2. FIRST EMBODIMENT (EXAMPLE OF MAGNETIC RECORDING CARTRIDGE INCLUDING COATING-TYPE MAGNETIC TAPE)

### (1) Configuration of Magnetic Recording Cartridge

### [Magnetic Recording Cartridge]

First, a configuration of the magnetic recording cartridge according to the present technology will be described with reference to FIG. 1. FIG. 1 is an exploded perspective view showing an example of a magnetic recording cartridge 10 according to the present technology. In the descriptions of the present technology, a magnetic recording cartridge conforming to the LTO standard will be exemplified as the magnetic recording cartridge 10.

The magnetic recording cartridge 10 is a single-reel-type cartridge and includes, inside a cartridge case 12 constituted of a lower shell 12A and an upper shell 12B: one reel 13 on which a tape-type magnetic tape MT is wound; a reel lock 14 and a reel spring 15 used for locking a rotation of the reel 13; a spider 16 for releasing a locked state of the reel 13; a slide door 17 which opens and closes a tape drawing outlet 12C provided in the cartridge case 12 across the lower shell 12A and the upper shell 12B; a door spring 18 which biases the slide door 17 to a closing position of the tape drawing outlet 12C; a write protect 19 for preventing an accidental deletion from occurring; and a cartridge memory 11. The reel 13 for winding the magnetic tape MT has substantially a disk shape including an opening at a center portion thereof, and is constituted of a reel hub 13A and a flange 13B that are formed of a hard material such as plastic. A leader tape LT is connected at an end portion of the magnetic tape MT on an outer circumferential side. A leader pin 20 is provided at a tip end of the leader tape LT.

The magnetic recording cartridge 10 may be a magnetic tape cartridge conforming to the LTO (Linear Tape-Open) standard, or may be a magnetic tape cartridge conforming to a standard different from the LTO standard.

The cartridge memory 11 is provided in the vicinity of one corner portion of the magnetic recording cartridge 10. In a state where the magnetic recording cartridge 10 is loaded in a recording/reproducing device, the cartridge memory 11 is provided to oppose a reader/writer of the recording/reproducing device. The cartridge memory 11 communicates with the recording/reproducing device, specifically the reader/writer, under a wireless communication standard conforming to the LTO standard.

### [Cartridge Memory]

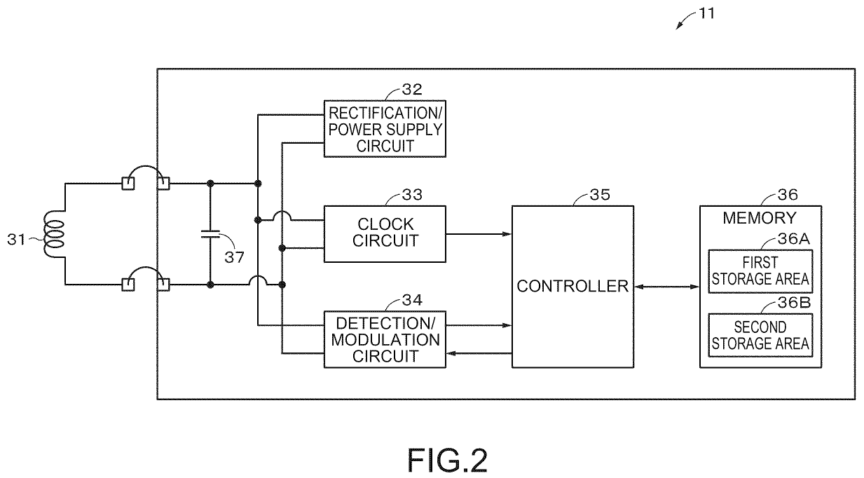

FIG. 2 is a block diagram showing an exemplary configuration of the cartridge memory 11. The cartridge memory 11 includes: an antenna coil (communication unit) 31 which communicates with the reader/writer under a specified communication standard; a rectification/power supply circuit 32 which generates power using an induced electromotive force from radio waves received by the antenna coil 31, and rectifies it to generate a power supply; a clock circuit 33 which generates clocks also using the induced electromotive force from the radio waves received by the antenna coil 31; a detection/modulation circuit 34 which performs detection of the radio waves received by the antenna coil 31 and modulation of signals to be transmitted by the antenna coil 31; a controller (control unit) 35 constituted of a logic circuit or the like for discriminating commands and data from digital signals extracted from the detection/modulation circuit 34, and processing the commands and data; and a memory (storage unit) 36 which stores information. Further, the cartridge memory 11 includes a capacitor 37 connected in parallel with the antenna coil 31, and the antenna coil 31 and the capacitor 37 form a resonance circuit.

The memory 36 stores information related to the magnetic recording cartridge 10, and the like. The memory 36 is a nonvolatile memory (Non Volatile Memory: NVM). A storage capacity of the memory 36 is favorably about 32 KB or more.

The memory 36 may include a first storage area 36A and a second storage area 36B. The first storage area 36A is an area for storing first information. The first information includes, for example, at least one type selected from the group consisting of manufacturing information regarding the magnetic recording cartridge 10 (for example, a unique number of the magnetic recording cartridge 10), a usage history of the magnetic recording cartridge 10 (for example, the number of times the magnetic tape MT has been drawn out (Thread Count)), and the like. The second storage area 36B is an area for storing second information. The second information includes, for example, at least one type selected from the group consisting of tension adjustment information, management ledger data, Index information, thumbnail information, and the like.

The tension adjustment information is information for adjusting a tension applied in the longitudinal direction of the magnetic tape MT. The tension adjustment information includes, for example, at least one type of information selected from the group consisting of information obtained by intermittently measuring a width between servo bands in the longitudinal direction of the magnetic tape MT, tension information regarding the recording/reproducing device, information on a temperature and humidity of the recording/reproducing device, and the like. These pieces of information are sometimes managed in link with information related to a usage condition of the magnetic recording cartridge 10, and/or the like. It is favorable for the tension adjustment information to be acquired when recording data or before recording data onto the magnetic tape MT. The tension information regarding the recording/reproducing device refers to information on a tension applied in the longitudinal direction of the magnetic tape MT.

The management ledger data is data including at least one type selected from a capacity, created date, edited date, storage location, and the like of a data file recorded on the magnetic tape MT. The Index information is metadata for searching a content of a data file, or the like. The thumbnail information is a moving image or still image thumbnail stored in the magnetic tape MT. In descriptions below, the information stored in the first storage area 36A may be referred to as “first information”, and the information stored in the second storage area 36B may be referred to as “second information”.

The memory 36 may include a plurality of banks. In this case, the first storage area 36A may be constituted of some of the plurality of banks, and the second storage area 36B may be constituted of the rest of the banks.

The antenna coil 31 induces an induced voltage by electromagnetic induction. The controller 35 communicates with the recording/reproducing device under the specified communication standard via the antenna coil 31. Specifically, for example, mutual authentications, transmissions and receptions of commands, exchanges of data, and the like are performed.

The controller 35 stores information received from the recording/reproducing device via the antenna coil 31 in the memory 36. For example, the tension adjustment information received from the recording/reproducing device via the antenna coil 31 is stored in the second storage area 36B of the memory 36. The controller 35 reads out information from the memory 36 in response to a request from the recording/reproducing device, and transmits the information to the recording/reproducing device via the antenna coil 31. For example, the tension adjustment information is read out from the second storage area 36B of the memory 36 in response to a request from the recording/reproducing device, and the tension adjustment information is transmitted to the recording/reproducing device via the antenna coil 31.

### (2) Configuration of Magnetic Tape

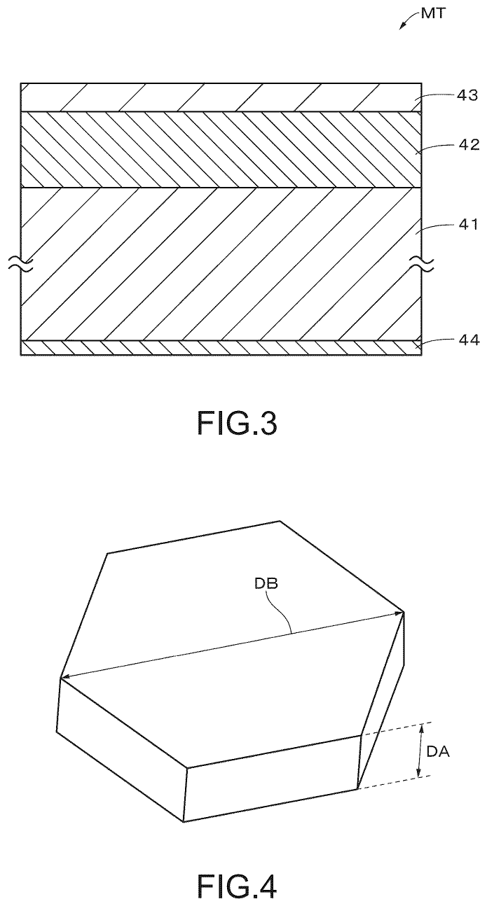

FIG. 3 is a cross-sectional view showing an exemplary configuration of the magnetic tape MT. The magnetic tape MT includes an elongated base layer 41, an underlayer 42 provided above one of main surfaces (first main surface) of the base layer 41, a magnetic layer 43 provided above the underlayer 42, and a back layer 44 provided on the other one of the main surfaces (second main surface) of the base layer 41. It is noted that the underlayer 42 and the back layer 44 are provided as necessary and do not need to be provided. The magnetic tape MT may be a vertical-recording-type magnetic tape, or may be a longitudinal-recording-type magnetic tape. It is favorable for the magnetic tape MT to contain a lubricant from a viewpoint of improving running performance. The lubricant may be contained in at least one of the underlayer 42 or the magnetic layer 43.

The magnetic tape MT may be a magnetic tape conforming to the LTO standard, or may be a magnetic tape conforming to a standard different from the LTO standard. A width of the magnetic tape MT may be ½ inch, or may be larger than ½ inch. When the magnetic tape MT conforms to the LTO standard, the width of the magnetic tape MT is ½ inch. The magnetic tape MT may have a configuration with which the width of the magnetic tape MT can be maintained constant or almost constant by adjusting a tension applied in the longitudinal direction of the magnetic tape MT during running by the recording/reproducing device (drive).

The magnetic tape MT has an elongated shape and runs in the longitudinal direction during recording/reproduction. It is favorable for the magnetic tape MT to be used in a recording/reproducing device that includes a ring-type head as a recording head. It is favorable for the magnetic tape MT to be used in a recording/reproducing device configured to be capable of recording data at a data track width of 1500 nm or less or 1000 nm or less.

### [Base Layer]

The base layer 41 is a non-magnetic supporting body that supports the underlayer 42 and the magnetic layer 43. The base layer 41 has an elongated film shape. An upper limit value of an average thickness of the base layer 41 is, for example, favorably 4.6 μm or less, more favorably 4.4 μm or less, 4.2 μm or less, or 4.0 μm or less, further more favorably 3.8 μm or less, particularly favorably 3.6 μm or less, most favorably 3.4 μm or less. When the upper limit value of the average thickness of the base layer 41 is 4.6 μm or less, a recording capacity that can be recorded in a single data cartridge can be made higher than that of a general magnetic tape. A lower limit value of the average thickness of the base layer 41 is favorably 3.0 μm or more, more favorably 3.2 μm or more. When the lower limit value of the average thickness of the base layer 41 is 3.0 μm or more, lowering of an intensity of the base layer 41 can be suppressed.

The average thickness of the base layer 41 is obtained as follows. First, the magnetic tape MT accommodated in the magnetic recording cartridge 10 is unwound, and the magnetic tape MT is cut out at a length of 250 mm from each of a range of 10 m to 20 m, a range of 30 m to 40 m, and a range of 50 m to 60 m from a connection portion 21 between the magnetic tape MT and the leader tape LT in the longitudinal direction, to thus produce three samples. In the present specification, the “longitudinal direction” used in “from a connection portion 21 between the magnetic tape MT and the leader tape LT in the longitudinal direction” refers to a direction that is directed from one end on the leader tape LT side toward the other end on the opposite side.

Subsequently, layers of each sample other than the base layer 41 (that is, the underlayer 42, the magnetic layer 43, and the back layer 44) are removed by using a solvent such as MEK (methyl ethyl ketone) or dilute hydrochloric acid. Next, using a laser hologauge (LGH-110C) manufactured by Mitutoyo Corporation as a measurement device, a thickness of each sample (base layer 41) is measured at five positions, and those measurement values (sample thicknesses at a total of 15 positions) are arithmetically averaged, to thus calculate the average thickness of the base layer 41. It is noted that the five measurement positions are randomly selected from each sample such that the five measurement positions become different positions in the longitudinal direction of the magnetic tape MT.

The base layer 41 contains, for example, at least one type selected from polyesters, polyolefins, cellulose derivatives, vinyl-based resins, and other polymer resins. When the base layer 41 contains two or more types out of the materials described above, those two or more types of materials may be mixed, copolymerized, or laminated.

Of the polymer resins described above, the base layer 41 favorably contains polyesters. By the base layer 41 containing polyesters, a storage elastic modulus E′ of the base layer 41 in the longitudinal direction can be reduced to favorably 9.0 GPa or less, more favorably 7.5 GPa or less, further more favorably 6.0 GPa or less, particularly favorably 5.5 GPa or less, most favorably 4.5 GPa or less. Accordingly, when the tension applied in the longitudinal direction of the magnetic tape MT during running is adjusted by the recording/reproducing device, this particularly makes it easy to control the width of the magnetic tape MT to be constant or almost constant. A measurement method of the storage elastic modulus E′ of the base layer 41 in the longitudinal direction will be described later.

Polyesters include, for example, at least one type selected from PET (polyethylene terephthalate), PEN (polyethylene naphthalate), PBT (polybutylene terephthalate), PBN (polybutylene naphthalate), PCT (polycyclohexylene dimethylene terephthalate), PEB (polyethylene-p-(oxybenzoate)), and polyethylene bisphenoxy carboxylate. When the base layer 41 contains two or more types of polyesters, those two or more types of polyesters may be mixed, copolymerized, or laminated. At least one of a terminal or side chain of polyesters may be denaturalized. For improving the intensity of the base layer 41, PA (polyamide) may be added to PET (polyethylene terephthalate).

The fact that polyesters are contained in the base layer 41 is confirmed as follows, for example. First, the magnetic tape MT accommodated in the magnetic recording cartridge 10 is unwound, and the magnetic tape MT is cut out from the range of 30 m to 40 m from the connection portion 21 between the magnetic tape MT and the leader tape LT in the longitudinal direction to produce a sample, and after that, layers of the sample other than the base layer 41 are removed. Next, an IR spectrum of the sample (base layer 41) is acquired by infrared absorption spectrometry (Infrared Absorption Spectrometry: IR). Based on this IR spectrum, the fact that polyesters are contained in the base layer 41 can be confirmed.

Polyolefins include, for example, at least one type selected from PE (polyethylene) and PP (polypropylene). The cellulose derivative includes, for example, at least one type selected from cellulose diacetate, cellulose triacetate, CAB (cellulose acetate butyrate), and CAP (cellulose acetate propionate). The vinyl-based resin includes, for example, at least one type selected from PVC (polyvinyl chloride) and PVDC (polyvinylidene chloride).

The other polymer resins include, for example, at least one type selected from PA (polyamide, nylon), aromatic PA (aromatic polyamide, aramid), PI (polyimide), aromatic PI (aromatic polyimide), PAI (polyamide imide), aromatic PAI (aromatic polyamide imide), PBO (polybenzoxazole; for example, Zylon®), polyether, PEK (polyether ketone), PEEK (polyether ether ketone), polyether ester, PES (polyether sulfone), PEI (polyetherimide), PSF (polysulfone), PPS (polyphenylene sulfide), PC (polycarbonate), PAR (polyarylate), and PU (polyurethane).

The base layer 41 may be biaxially stretched in the longitudinal direction and the width direction. It is favorable for the polymer resin contained in the base layer 41 to be oriented in an oblique direction with respect to the width direction of the base layer 41.

### [Magnetic Layer]

The magnetic layer 43 is a recording layer for recording signals by magnetization patterns. The magnetic layer 43 may be a coated film. The magnetic layer 43 may be a vertical-recording-type recording layer, or may be a longitudinal-recording-type recording layer. The magnetic layer 43 contains, for example, magnetic powder, a binding agent, a lubricant, and carbon. The magnetic layer 43 may further contain, as necessary, at least one type of additive selected from an antistatic agent, an abrasive, a curing agent, a rust inhibitor, non-magnetic reinforcement particles, and the like. The magnetic layer 43 may include a surface having a concavo-convex shape.

The magnetic layer 43 includes a plurality of data bands in which data is written and a plurality of servo bands in which servo patterns are written. The data bands and the servo bands will be described later in detail.

The magnetic layer 43 is configured to be capable of forming a plurality of data tracks in the data bands. An upper limit value of an average value of data track widths is favorably 1100 nm or less, more favorably 1000 nm or less, further more favorably 800 nm or less, particularly favorably 600 nm or less from a viewpoint of improving a track recording density and securing a high recording capacity. A lower limit value of the average value of the data track widths W is favorably 20 nm or more in view of a magnetic particle size.

The average value of the data track widths is obtained as follows. First, the magnetic recording cartridge 10 in which data is recorded on an entire surface of the magnetic tape MT is prepared, the magnetic tape MT is unwound from this magnetic recording cartridge 10, and the magnetic tape MT is cut out at a length of 250 mm from each of the range of 10 m to 20 m, the range of 30 m to 40 m, and the range of 50 m to 60 m from the connection portion 21 between the magnetic tape MT and the leader tape LT in the longitudinal direction, to thus produce three samples. Subsequently, a data recording pattern of a data band portion of the magnetic layer 43 of each sample is observed using a magnetic force microscope (Magnetic Force Microscope: MFM) to obtain an MFM image. As the MFM, Dimension 3100 and analysis software therefor manufactured by Digital Instruments are used. A measurement region of the MFM image is 10 μm×10 μm, and the 10 μm×10 μm measurement region is divided into 512×512 (=262,144) measurement points. The measurement using the MFM is performed for the 10 μm×10 μm measurement region in each sample, that is, three MFM images are obtained. The track width is measured at 10 positions in each of the obtained three MFM images using the analysis software accompanying Dimension 3100, and an average value (simple average) is obtained. The average value is the average value of the data track widths. It is noted that measurement conditions of the MFM are a sweep speed: 1 Hz, a used chip: MFMR-20, a lift height: 20 nm, and correction: Flatten order 3.

An upper limit value of an average thickness of the magnetic layer 43 is favorably 90 nm or less, more favorably 80 nm or less, further more favorably 70 nm or less, particularly favorably 60 nm or less, most favorably 50 nm or less. When the upper limit value of the average thickness of the magnetic layer 43 is 90 nm or less, an effect of demagnetization can be reduced in the case where a ring-type head is used as the recording head, and thus additionally excellent electromagnetic conversion characteristics can be obtained.

A lower limit value of the average thickness of the magnetic layer 43 is favorably 35 nm or more. When the lower limit value of the average thickness of the magnetic layer 43 is 35 nm or more, an output can be secured when an MR-type head is used as a reproducing head, and thus additionally excellent electromagnetic conversion characteristics can be obtained.

The average thickness of the magnetic layer 43 is obtained as follows. First, the magnetic tape MT accommodated in the magnetic recording cartridge 10 is unwound, and the magnetic tape MT is cut out at a length of 250 mm from each of the range of 10 m to 20 m, the range of 30 m to 40 m, and the range of 50 m to 60 m from the connection portion 21 between the magnetic tape MT and the leader tape LT in the longitudinal direction, to thus produce three samples. Subsequently, each sample is processed and sectioned by an FIB method or the like. When using the FIB method, a carbon layer and a tungsten layer are formed as protective films as preprocessing for observing a TEM image of a cross section to be described later. The carbon layer is formed on a surface of the magnetic tape MT on the magnetic layer 43 side and a surface thereof on the back layer 44 side by a vapor deposition method, and then the tungsten layer is further formed on the surface on the magnetic layer 43 side by the vapor deposition method or a sputtering method. The sectioning is performed along a length direction (longitudinal direction) of the magnetic tape MT. In other words, by the sectioning, a cross section parallel to both the longitudinal direction and the thickness direction of the magnetic tape MT is formed.

The cross section of each of the obtained sectioned samples is observed using a transmission electron microscope (Transmission Electron Microscope: TEM) under the following conditions to obtain a TEM image of each of the sectioned samples. It is noted that a magnification and an acceleration voltage may be adjusted as appropriate in accordance with a type of the device.
Device: TEM (H9000NAR manufactured by Hitachi, Ltd.)
Acceleration voltage: 300 kV
Magnification: 100,000 folds

Next, using the TEM image of each of the obtained sectioned samples, the thickness of the magnetic layer 43 is measured at 10 positions in each of the sectioned samples. It is noted that the 10 measurement positions in each of the sectioned samples are randomly selected from each of the samples such that the 10 positions become different positions in the longitudinal direction of the magnetic tape MT. An average value obtained by arithmetically averaging the measurement values of each of the obtained sectioned samples (thicknesses of the magnetic layer 43 at a total of 30 positions) is set as the average thickness [nm] of the magnetic layer 43.

### [Magnetic Powder]

Magnetic powder includes a plurality of magnetic particles. For example, the magnetic particles are particles containing metal oxide (hereinafter, will be referred to as “metal oxide particles”). For example, the metal oxide particles are particles containing hexagonal ferrite (hereinafter, will be referred to as “hexagonal ferrite particles”), particles containing epsilon iron oxide (c iron oxide) (hereinafter, will be referred to as “ε iron oxide particles”), or particles containing Co-containing spinel ferrite (hereinafter, will be referred to as “cobalt ferrite particles”). It is favorable for the magnetic powder to have a crystalline orientation preferentially in a vertical direction of the magnetic tape MT. In the present specification, the vertical direction (thickness direction) of the magnetic tape MT refers to a thickness direction of the magnetic tape MT in a planar state.

### [Hexagonal Ferrite Particles]

The hexagonal ferrite particles have, for example, a plate shape such as a hexagonal plate shape or a column shape such as a hexagonal column shape (provided that a thickness or height is smaller than a long diameter of a plate surface or bottom surface). In the present specification, the hexagonal plate shape includes a substantially hexagonal plate shape. Hexagonal ferrite favorably includes at least one type selected from Ba, Sr, Pb, and Ca, or more favorably includes at least one type selected from Ba and Sr. Specifically, for example, hexagonal ferrite may be barium ferrite or strontium ferrite. Barium ferrite may further include at least one type selected from Sr, Pb, and Ca in addition to Ba. Strontium ferrite may further include at least one type selected from Ba, Pb, and Ca in addition to Sr.

More specifically, hexagonal ferrite has an average composition expressed by a general formula MFe₁₂O₁₉. It is noted that M is, for example, at least one type of metal selected from Ba, Sr, Pb, and Ca, favorably at least one type of metal selected from Ba and Sr. M may be a combination of Ba and one or more types of metal selected from the group consisting of Sr, Pb, and Ca. Alternatively, M may be a combination of Sr and one or more types of metal selected from the group consisting of Ba, Pb, and Ca. A part of Fe in the general formula described above may be substituted by other metal elements.

When the magnetic powder contains hexagonal ferrite particle powder, an average particle size of the magnetic powder is favorably 13 nm or more and 22 nm or less, more favorably 13 nm or more and 19 nm or less, further more favorably 13 nm or more and 18 nm or less, particularly favorably 14 nm or more and 17 nm or less, most favorably 14 nm or more and 16 nm or less. When the average particle size of the magnetic powder is 22 nm or less, additionally excellent electromagnetic conversion characteristics (for example, SNR) can be obtained in the magnetic tape MT having a high recording density. Meanwhile, when the average particle size of the magnetic powder is 13 nm or more, dispersibility of the magnetic powder is improved, and additionally excellent electromagnetic conversion characteristics (for example, SNR) can be obtained.

When the magnetic powder contains hexagonal ferrite particle powder, an average aspect ratio of the magnetic powder is favorably 1.0 or more and 3.0 or less, more favorably 1.5 or more and 2.8 or less, further more favorably 1.8 or more and 2.7 or less. When the average aspect ratio of the magnetic powder is within the range of 1.0 or more and 3.0 or less, an agglomeration of the magnetic powder can be suppressed. In addition, resistance applied to the magnetic powder when vertically orienting the magnetic powder in a process of forming the magnetic layer 43 can be suppressed. Accordingly, a vertical orientation of the magnetic powder can be improved.

When the magnetic powder contains hexagonal ferrite particle powder, the average particle size and average aspect ratio of the magnetic powder are obtained as follows. First, the magnetic tape MT accommodated in the magnetic recording cartridge 10 is unwound, and the magnetic tape MT is cut out from the range of 30 m to 40 m from the connection portion 21 between the magnetic tape MT and the leader tape LT in the longitudinal direction. Subsequently, the cut-out magnetic tape MT is processed and sectioned by the FIB method or the like. When using the FIB method, a carbon layer and a tungsten layer are formed as protective films as preprocessing for observing a TEM image of a cross section to be described later. The carbon layer is formed on the surface of the magnetic tape MT on the magnetic layer 43 side and the surface thereof on the back layer 44 side by the vapor deposition method, and then the tungsten layer is further formed on the surface on the magnetic layer 43 side by the vapor deposition method or the sputtering method. The sectioning is performed along the length direction (longitudinal direction) of the magnetic tape MT. In other words, by the sectioning, a cross section parallel to both the longitudinal direction and the thickness direction of the magnetic tape MT is formed.

Using a transmission electron microscope (H-9500 manufactured by Hitachi High-Tech Corporation), the cross section of the obtained sectioned sample is subjected to a cross-sectional observation at an acceleration voltage of 200 kV and a total magnification of 500,000 folds in such a manner that the entire magnetic layer 43 is included with respect to the thickness direction of the magnetic layer 43, to thus capture a TEM picture. The TEM picture is prepared in a number with which 50 particles for which a plate diameter DB and a plate thickness DA (see FIG. 4) described below can be measured can be extracted.

In the present specification, when a shape of the particle observed in the TEM picture described above is a plate shape or a column shape (provided that the thickness or height is smaller than the long diameter of the plate surface or bottom surface) as shown in FIG. 4, the long diameter of the plate surface or bottom surface of the particle is set as a value of the plate diameter DB. A thickness or height of the particle observed in the TEM picture described above is set as a value of the plate thickness DA. When the thickness or height of the particle is not constant within the particle, a maximum thickness or height of the particle is set as the plate thickness DA.

Next, 50 particles extracted from the captured TEM picture are picked out based on the following criteria. A particle that is partially sticking out from a visual field of the TEM picture is not measured, and a particle that has a sharp outline and exists in isolation is measured. When the particles overlap, particles in which a boundary between the particles is clear and the shape of the entire particle is determinable are each measured as an independent particle, but particles in which the boundary is unclear and the entire shape of the particle is unclear are not measured assuming that the shape of the particle is undeterminable.

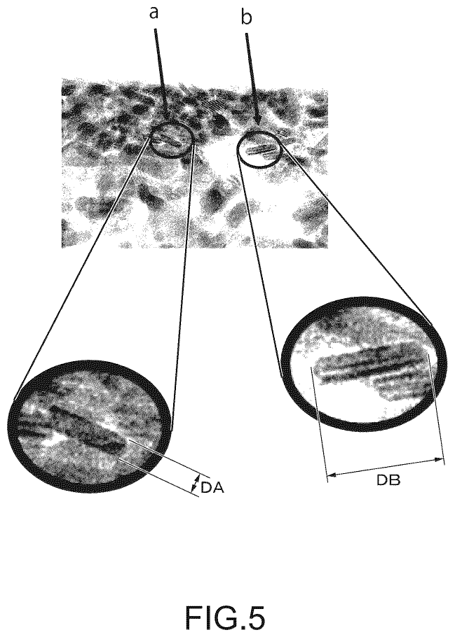

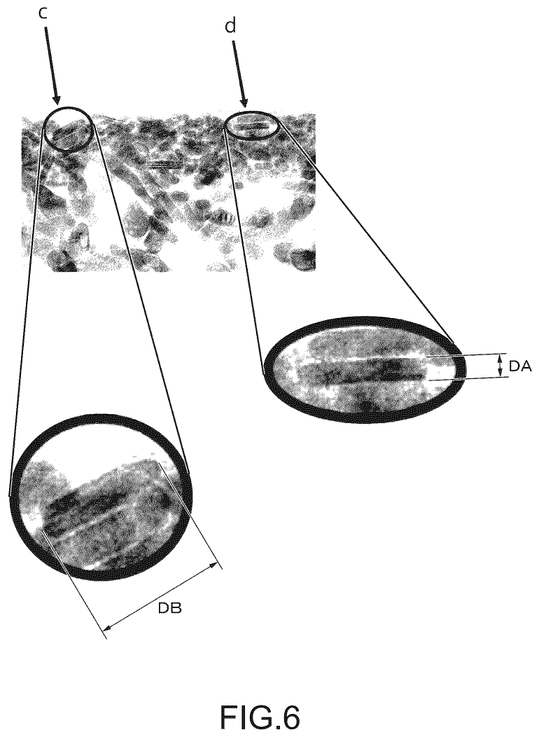

FIGS. 5 and 6 each show an example of the TEM picture. In FIGS. 5 and 6, for example, particles respectively indicated by arrows a and d are selected since the plate thicknesses (thicknesses or heights of the particles) DA of the particles can be visibly confirmed. The plate thickness DA of each of the selected 50 particles is measured. The plate thicknesses DA obtained in this manner are arithmetically averaged to obtain an average plate thickness DAₐᵥₑ. The average plate thickness DAₐᵥₑ is an average particle plate thickness. Subsequently, the plate diameter DB of the magnetic powder is measured. For measuring the plate diameter DB of each of the particles, 50 particles whose particle plate diameter DB can be visibly confirmed are picked out from the captured TEM picture. In FIGS. 5 and 6, for example, particles respectively indicated by arrows b and c are selected since the plate diameters DB thereof can be visibly confirmed. The plate diameter DB of each of the selected 50 particles is measured. The plate diameters DB obtained in this manner are simply averaged (arithmetic average) to obtain an average plate diameter DBₐᵥₑ. The average plate diameter DBₐᵥₑ is an average particle size. Then, an average aspect ratio (DBₐᵥₑ/DAₐᵥₑ) of the particles is obtained from the average plate thickness DAₐᵥₑ and the average plate diameter DBₐᵥₑ.

When the magnetic powder contains hexagonal ferrite particle powder, an average particle volume of the magnetic powder is favorably 500 nm³ or more and 2500 nm³ or less, more favorably 500 nm³ or more and 1600 nm³ or less, further more favorably 500 nm³ or more and 1500 nm³ or less, particularly favorably 600 nm³ or more and 1200 nm³ or less, most favorably 600 nm³ or more and 1000 nm³ or less. When the average particle volume of the magnetic powder is 2500 nm³ or less, effects similar to those of a case where the average particle size of the magnetic powder is 22 nm or less can be obtained. Meanwhile, when the average particle volume of the magnetic powder is 500 nm³ or more, effects similar to those of a case where the average particle size of the magnetic powder is 13 nm or more can be obtained.

The average particle volume of the magnetic powder is obtained as follows. First, as described above in relation to the method of calculating the average particle size of the magnetic powder, the average plate thickness DAₐᵥₑ and the average plate diameter DBₐᵥₑ are obtained. Next, an average volume V of the magnetic powder is obtained by the following equation.

$$V = \frac{3 \sqrt{3}}{8} \times D {A}_{ave} \times {DB}_{ave} \times {DB}_{ave} \qquad [ Math . 1 ]$$

### [ε Iron Oxide Particles]

The ε iron oxide particles are hard magnetic particles with which a high coercive force can be obtained even with fine particles. The ε iron oxide particles have a spherical shape or a cubic shape. In the present specification, the spherical shape includes a substantially spherical shape. Further, the cubic shape includes a substantially cubic shape. Since the ε iron oxide particles have the shape as described above, when the c iron oxide particles are used as the magnetic particles, it is possible to reduce a contact area of the particles in the thickness direction of the magnetic tape MT and suppress the agglomeration of the particles as compared to a case where barium ferrite particles having a hexagonal plate shape are used as the magnetic particles. Accordingly, it is possible to enhance dispersibility of the magnetic particles and obtain additionally excellent electromagnetic conversion characteristics (for example, SNR).

The ε iron oxide particles may have a composite particle structure. More specifically, the ε iron oxide particle includes an ε iron oxide portion and a portion having a soft magnetic property or a portion having a magnetic property in which a saturation magnetization amount σs is larger and a coercive force Hc is smaller than those of ε iron oxide (hereinafter, will be referred to as “portion having a soft magnetic property or the like”).

The ε iron oxide portion contains ε iron oxide. ε iron oxide contained in the ε iron oxide portion is favorably one having an ε-Fe₂O₃ crystal as a main phase, more favorably one constituted of single-phase ε-Fe₂O₃.

The portion having a soft magnetic property or the like is partially in contact with at least the ε iron oxide portion. Specifically, the portion having a soft magnetic property or the like may partially cover the ε iron oxide portion, or may cover an entire circumference of the ε iron oxide portion.

The portion having a soft magnetic property (the portion having a magnetic property in which the saturation magnetization amount σs is larger and the coercive force Hc is smaller than those of ε iron oxide) contains, for example, a soft magnetic material such as α-Fe, a Ni—Fe alloy, or an Fe—Si—Al alloy. α-Fe may be obtained by reducing ε iron oxide contained in the ε iron oxide portion.

Further, the portion having a soft magnetic property may contain, for example, Fe₃O₄, γ-Fe₂O₃, spinel ferrite, or the like.

When the ε iron oxide particle includes the portion having a soft magnetic property or the like as described above, this makes it possible to adjust the coercive force Hc of the ε iron oxide particle (composite particle) as a whole to a coercive force Hc suited for recording, while maintaining the coercive force Hc of the ε iron oxide portion alone at a large value for securing thermal stability.

The ε iron oxide particle may contain an additive in place of the composite particle structure, or may contain an additive together with the composite particle structure. In this case, a part of Fe in the ε iron oxide particle is substituted by the additive. When the ε iron oxide particle contains the additive, this also makes it possible to adjust the coercive force Hc of the ε iron oxide particle as a whole to a coercive force Hc suited for recording. As a result, easiness of recording can be improved. The additive is a metal element other than iron, favorably a trivalent metal element, more favorably at least one type selected from the group consisting of Al, Ga, and In, further more favorably at least one type selected from the group consisting of Al and Ga.

Specifically, ε iron oxide containing the additive is an ε-Fe₂₋ₓMₓO₃ crystal (provided that: M is a metal element other than iron, favorably a trivalent metal element, more favorably at least one type selected from the group consisting of Al, Ga, and In, further more favorably at least one type selected from the group consisting of Al and Ga; and x is, for example, 0<x<1).

When the magnetic particles are the ε iron oxide particles, the average particle size of the magnetic particles is favorably 10 nm or more and 20 nm or less, more favorably 10 nm or more and 18 nm or less, further more favorably 10 nm or more and 16 nm or less, particularly favorably 10 nm or more and 15 nm or less, most favorably 10 nm or more and 14 nm or less. In the magnetic tape MT, a region of a size that is ½ the recording wavelength becomes the actual magnetization region. Therefore, by setting the average particle size of the magnetic particles to be less than half the shortest recording wavelength, additionally excellent electromagnetic conversion characteristics (for example, SNR) can be obtained. Accordingly, when the average particle size of the magnetic particles is 20 nm or less, additionally excellent electromagnetic conversion characteristics (for example, SNR) can be obtained in the magnetic tape MT having a high recording density (for example, the magnetic tape MT configured to be capable of recording signals at the shortest recording wavelength of 40 nm or less). Meanwhile, when the average particle size of the magnetic particles is 10 nm or more, dispersibility of the magnetic particles is improved, and additionally excellent electromagnetic conversion characteristics (for example, SNR) can be obtained.

When the magnetic particles are the ε iron oxide particles, the average aspect ratio of the magnetic particles is favorably 1.0 or more and 3.0 or less, more favorably 1.0 or more and 2.5 or less, further more favorably 1.0 or more and 2.1 or less, particularly favorably 1.0 or more and 1.8 or less. When the average aspect ratio of the magnetic particles is within the range of 1.0 or more and 3.0 or less, the agglomeration of the magnetic particles can be suppressed. In addition, resistance applied to the magnetic particles when vertically orienting the magnetic particles in the process of forming the magnetic layer 43 can be suppressed. Accordingly, the vertical orientation of the magnetic particles can be improved.

When the magnetic particles are the ε iron oxide particles, the average particle size and average aspect ratio of the magnetic particles are obtained as follows. First, the magnetic tape MT accommodated in the magnetic recording cartridge 10 is unwound, and the magnetic tape MT is cut out at a position that is 30 m to 40 m from the connection portion between the magnetic tape MT and the leader tape in the longitudinal direction. Subsequently, the magnetic tape MT as the measurement target is processed and sectioned by the FIB (Focused Ion Beam) method or the like. When using the FIB method, a carbon layer and a tungsten layer are formed as protective layers as preprocessing for observing a TEM image of a cross section to be described later. The carbon layer is formed on the surface of the magnetic tape MT on the magnetic layer 43 side and the surface thereof on the back layer 44 side by the vapor deposition method, and then the tungsten layer is further formed on the surface on the magnetic layer 43 side by the vapor deposition method or the sputtering method. The sectioning is performed along the length direction (longitudinal direction) of the magnetic tape MT. In other words, by the sectioning, a cross section parallel to both the longitudinal direction and the thickness direction of the magnetic tape MT is formed.

Using the transmission electron microscope (H-9500 manufactured by Hitachi High-Tech Corporation), the cross section of the obtained sectioned sample is subjected to a cross-sectional observation at an acceleration voltage of 200 kV and a total magnification of 500,000 folds in such a manner that the entire magnetic layer 43 is included with respect to the thickness direction of the magnetic layer 43, to thus capture a TEM image. Next, from the captured TEM image, 50 particles whose particle shapes can be visibly confirmed are picked out, and a long axis length DL and short axis length DS of each particle are measured. Herein, the long axis length DL refers to a maximum distance (so-called maximum Feret's diameter) out of distances among two parallel lines drawn from various angles so as to come into contact with an outline of each of the particles. On the other hand, the short axis length DS refers to a maximum length out of lengths of a particle in a direction orthogonal to the long axis (DL) of the particle. Subsequently, the measured long axis lengths DL of the 50 particles are simply averaged (arithmetic average) to obtain an average long axis length DLₐᵥₑ. The average long axis length DLₐᵥₑ obtained in this manner is set as the average particle size of the magnetic particles. Further, the measured short axis lengths DS of the 50 particles are simply averaged (arithmetic average) to obtain an average short axis length DSₐᵥₑ. Then, an average aspect ratio (DLₐᵥₑ/DSₐᵥₑ) of the particles is obtained from the average long axis length DLₐᵥₑ and the average short axis length DSₐᵥₑ.

When the magnetic particles are the ε iron oxide particles, the average particle volume of the magnetic particles is favorably 500 nm³ or more and 4000 nm³ or less, more favorably 500 nm³ or more and 3000 nm³ or less, further more favorably 500 nm³ or more and 2000 nm³ or less, particularly favorably 600 nm³ or more and 1600 nm³ or less, most favorably 600 nm³ or more and 1300 nm³ or less. Since noises of the magnetic tape MT are inversely proportional to a square root of the number of particles (that is, proportional to a square root of a particle volume) in general, additionally excellent electromagnetic conversion characteristics (for example, SNR) can be obtained by further reducing the particle volume. Accordingly, when the average particle volume of the magnetic particles is 4000 nm³ or less, additionally excellent electromagnetic conversion characteristics (for example, SNR) can be obtained similar to the case where the average particle size of the magnetic particles is 20 nm or less. Meanwhile, when the average particle volume of the magnetic particles is 500 nm³ or more, effects similar to those of the case where the average particle size of the magnetic particles is 10 nm or more can be obtained.

When the ε iron oxide particle has a spherical shape, the average particle volume of the magnetic particles is obtained as follows. First, the average long axis length DLₐᵥₑ is obtained similarly to the method of calculating the average particle size of the magnetic particles. Next, the average volume V of the magnetic particles is obtained by the following equation.

V=(π/6)×DLₐᵥₑ³

When the ε iron oxide particle has a cubic shape, the average volume of the magnetic particles is obtained as follows. First, the magnetic tape MT accommodated in the magnetic recording cartridge 10 is unwound, and the magnetic tape MT is cut out at a position that is 30 m to 40 m from the connection portion between the magnetic tape MT and the leader tape LT in the longitudinal direction. Subsequently, the cut-out magnetic tape MT is processed and sectioned by the FIB (Focused Ion Beam) method or the like. When using the FIB method, a carbon film and a tungsten thin film are formed as protective films as preprocessing for observing a TEM image of a cross section to be described later. The carbon film is formed on the surface of the magnetic tape MT on the magnetic layer 43 side and the surface thereof on the back layer 44 side by the vapor deposition method, and then the tungsten thin film is further formed on the surface on the magnetic layer 43 side by the vapor deposition method or the sputtering method. The sectioning is performed along the length direction (longitudinal direction) of the magnetic tape MT. In other words, by the sectioning, a cross section parallel to both the longitudinal direction and the thickness direction of the magnetic tape MT is formed.

Using the transmission electron microscope (H-9500 manufactured by Hitachi High-Tech Corporation), the obtained sectioned sample is subjected to a cross-sectional observation at an acceleration voltage of 200 kV and a total magnification of 500,000 folds in such a manner that the entire magnetic layer 43 is included with respect to the thickness direction of the magnetic layer 43, to thus obtain a TEM image. It is noted that the magnification and acceleration voltage may be adjusted as appropriate in accordance with the type of the device. Next, from the captured TEM image, 50 particles whose particle shapes can be visibly confirmed are picked out, and a side length DC of each particle is measured. Subsequently, the measured side lengths DC of the 50 particles are simply averaged (arithmetic average) to obtain an average side length DCₐᵥₑ. Next, an average volume Vₐᵥₑ (particle volume) of the magnetic particles is obtained by the following equation using the average side length DCₐᵥₑ.

Vₐᵥₑ=DCₐᵥₑ³

### [Cobalt Ferrite Particles]

It is favorable for the cobalt ferrite particles to have a uniaxial crystal anisotropy. By the uniaxial crystal anisotropy of the cobalt ferrite particles, the magnetic powder can have a crystalline orientation preferentially in the vertical direction of the magnetic tape MT. The cobalt ferrite particles have, for example, a cubic shape. In the present specification, the cubic shape includes a substantially cubic shape. Co-containing spinel ferrite may further include at least one type selected from Ni, Mn, Al, Cu, and Zn in addition to Co.

Co-containing spinel ferrite has an average composition expressed by the following formula, for example.

CoₓM_{y}Fe₂O_{z}
(provided that in the formula, M is, for example, at least one type of metal selected from Ni, Mn, Al, Cu, and Zn, x is a value within the range of 0.4≤x≤1.0, and y is a value within the range of 0≤y≤0.3; and provided that x and y satisfy a relationship of (x+y)≤1.0, z is a value within the range of 3≤z≤4, and a part of Fe may be substituted by other metal elements.)

When the magnetic powder contains cobalt ferrite particle powder, an average particle size of the magnetic powder is favorably 8 nm or more and 16 nm or less, more favorably 8 nm or more and 13 nm or less, further more favorably 8 nm or more and 10 nm or less. When the average particle size of the magnetic powder is 16 nm or less, additionally excellent electromagnetic conversion characteristics (for example, SNR) can be obtained in the magnetic tape MT having a high recording density. Meanwhile, when the average particle size of the magnetic powder is 8 nm or more, dispersibility of the magnetic powder is additionally improved, and additionally excellent electromagnetic conversion characteristics (for example, SNR) can be obtained. The method of calculating the average particle size of the magnetic powder is similar to the method of calculating the average particle size of the magnetic powder in the case where the magnetic powder contains ε iron oxide particle powder.

When the magnetic powder contains cobalt ferrite particle powder, the average aspect ratio of the magnetic powder is favorably 1.0 or more and 2.5 or less, more favorably 1.0 or more and 2.1 or less, further more favorably 1.0 or more and 1.8 or less. When the average aspect ratio of the magnetic powder is within the range of 1.0 or more and 2.5 or less, the agglomeration of the magnetic powder can be suppressed. In addition, resistance applied to the magnetic powder when vertically orienting the magnetic powder in the process of forming the magnetic layer 43 can be suppressed. Accordingly, the vertical orientation of the magnetic powder can be improved. The method of calculating the average aspect ratio of the magnetic powder is similar to the method of calculating the average aspect ratio of the magnetic powder in the case where the magnetic powder contains ε iron oxide particle powder.

When the magnetic powder contains cobalt ferrite particle powder, the average particle volume of the magnetic powder is favorably 500 nm³ or more and 4000 nm³ or less, more favorably 600 nm³ or more and 2000 nm³ or less, further more favorably 600 nm³ or more and 1000 nm³ or less. When the average particle volume of the magnetic powder is 4000 nm³ or less, effects similar to those of the case where the average particle size of the magnetic powder is 16 nm or less can be obtained. Meanwhile, when the average particle volume of the magnetic powder is 500 nm³ or more, effects similar to those of the case where the average particle size of the magnetic powder is 8 nm or more can be obtained. The method of calculating the average particle volume of the magnetic powder is similar to the method of calculating the average particle volume in the case where the c iron oxide particles have a cubic shape.

### [First Particles]

The magnetic layer may contain first particles that partially protrude from the magnetic surface.

As shown in FIG. 42, some of first particles 91A contained in the magnetic layer 43 protrude from the magnetic surface to form first protrusions 91B. When a data write head 60 slides on the magnetic tape MT, the first protrusions 91B come into contact with the data write head 60.

The first particles 91A have electrical conductivity. It is favorable for the first particles 91A to be an antistatic agent and a solid lubricant. The first particles 91A are particles containing carbon. As the particles containing carbon, for example, at least one type selected from the group consisting of carbon particles and hybrid particles can be used, and it is favorable to use carbon particles.

As the carbon particles, for example, one or more types selected from the group consisting of carbon black, acetylene black, Ketjenblack, carbon nanotubes, and graphene can be used, and it is favorable to use carbon black even out of these carbon particles. As carbon black, for example, SEAST TA manufactured by Tokai Carbon Co., Ltd. or Asahi #15, #15HS, or the like manufactured by Asahi Carbon Co., Ltd. can be used.

The hybrid particles contain carbon and a material other than carbon. The material other than carbon is, for example, an organic material or an inorganic material. The hybrid particle may be a hybrid particle in which carbon has adhered onto an inorganic particle surface and may specifically be, for example, hybrid carbon in which carbon has adhered onto a silica particle surface.

### [Second Particles]

The magnetic layer may contain second particles that partially protrude from the magnetic surface.

As shown in FIG. 42, some of second particles 92A contained in the magnetic layer 43 protrude from the magnetic surface to form second protrusions 92B. When the data write head 60 slides on the magnetic tape MT, the second protrusions 92B come into contact with the data write head 60.

The second particles 92A may be an abrasive. A lower limit value of a Mohs hardness of the second particles 92A is 7.0 or more, favorably 7.5 or more, more favorably 8.0 or more, further more favorably 8.5 or more from the viewpoint of suppressing deformation due to contact with the data write head 60. An upper limit value of the Mohs hardness of the second particles 92A is favorably 9.5 or less from the viewpoint of suppressing abrasion of the data write head 60.

It is favorable for the second particles 92A to be inorganic particles. Examples of the inorganic particles include α-alumina having an alpha conversion rate of 90% or more, β-alumina, γ-alumina, silicon carbide, chromium oxide, cerium oxide, alpha iron oxide, corundum, silicon nitride, titanium carbide, titanium oxide, silicon dioxide, tin oxide, magnesium oxide, tungsten oxide, zirconium oxide, boron nitride, zinc oxide, calcium carbonate, calcium sulfate, barium sulfate, molybdenum disulfide, acicular alpha iron oxide obtained by dehydrating and annealing raw materials of magnetic iron oxide, resultants obtained by treating surfaces of those with aluminum and/or silica as necessary, diamond powder, and the like. As the inorganic particles, it is favorable to use alumina particles of α-alumina, β-alumina, γ-alumina, and the like and/or silicon carbide. The second particles 92A may have any shape including an acicular shape, a spherical shape, a cubic shape, and the like, but a shape having a corner at one portion thereof is favorable for its high abrasivity.

### [Binding Agent]

Examples of the binding agent include a thermoplastic resin, a thermoset resin, a reactive resin, and the like. Examples of the thermoplastic resin include vinyl chloride, vinyl acetate, a vinyl chloride-vinyl acetate copolymer, a vinyl chloride-vinylidene chloride copolymer, a vinyl chloride-acrylonitrile copolymer, an acrylic acid ester-acrylonitrile copolymer, an acrylic acid ester-vinyl chloride-vinylidene chloride copolymer, an acrylic acid ester-acrylonitrile copolymer, an acrylic acid ester-vinylidene chloride copolymer, a methacrylic acid ester-vinylidene chloride copolymer, a methacrylic acid ester-vinyl chloride copolymer, a methacrylic acid ester-ethylene copolymer, polyvinyl fluoride, a vinylidene chloride-acrylonitrile copolymer, an acrylonitrile-butadiene copolymer, a polyamide resin, polyvinyl butyral, cellulose derivatives (cellulose acetate butyrate, cellulose diacetate, cellulose triacetate, cellulose propionate, nitrocellulose), a styrene butadiene copolymer, a polyurethane resin, a polyester resin, an amino resin, synthetic rubber, and the like.

Examples of the thermoset resin include a phenol resin, an epoxy resin, a polyurethane curable resin, a urea resin, a melamine resin, an alkyd resin, a silicone resin, a polyamine resin, a urea formaldehyde resin, and the like.

For the purpose of improving dispersibility of the magnetic powder, polar functional groups including —SO₃M, —OSO₃M, —COOM, P═O(OM)₂ (provided that in the formulae, M represents a hydrogen atom or alkali metal such as lithium, potassium, and sodium), side chain type amine including terminal groups expressed by —NR1R2 and —NR1R2R3⁺X⁻, main chain type amine expressed by >NR1R2⁺X⁻ (provided that in the formulae, R1, R2, and R3 each represent a hydrogen atom or a hydrocarbon group, and X⁻ represents a halogen element ion of fluorine, chlorine, bromine, iodine, and the like, an inorganic ion, or an organic ion), and further, —OH, —SH, —CN, an epoxy group, and the like may be introduced into all of the binding agents described above. An introduction amount of these polar functional groups into the binding agent is favorably 10⁻¹ mol/g or more and 10⁻⁸ mol/g or less, more favorably 10⁻² mol/g or more and 10⁻⁶ mol/g or less.

### [Lubricant]

The lubricant includes, for example, at least one type selected from fatty acid and fatty acid ester, or favorably both of fatty acid and fatty acid ester. The magnetic layer 43 containing the lubricant, in particular, the magnetic layer 43 containing both of fatty acid and fatty acid ester, contributes to an improvement of running stability of the magnetic tape MT.

Fatty acid may favorably be a compound indicated by the following general formula (1) or (2). For example, one of the compound indicated by the following general formula (1) or the compound indicated by the general formula (2), or both may be contained as fatty acid.

Further, fatty acid ester may favorably be a compound indicated by the following general formula (3) or (4). For example, one of the compound indicated by the following general formula (3) or the compound indicated by the general formula (4), or both may be contained as fatty acid ester.

By the lubricant containing one or both of the compound indicated by the general formula (1) and the compound indicated by the general formula (2) and one or both of the compound indicated by the general formula (3) and the compound indicated by the general formula (4), or the compound indicated by the general formula (5), an increase of a kinetic friction coefficient due to repetitive recording or reproduction of the magnetic tape MT can be suppressed.

CH₃(CH₂)ₖCOOH (1)
(provided that in the general formula (1), k is an integer selected from a range of 14 or more and 22 or less, more favorably a range of 14 or more and 18 or less.)

CH₃(CH₂)ₙCH═CH(CH₂)ₘCOOH (2)
(provided that in the general formula (2), a sum of n and m is an integer selected from a range of 12 or more and 20 or less, more favorably a range of 14 or more and 18 or less.)

CH₃(CH₂)ₚCOO(CH₂)_{q}CH₃ (3)
(provided that in the general formula (3), p is an integer selected from a range of 14 or more and 22 or less, more favorably a range of 14 or more and 18 or less, and q is an integer selected from a range of 2 or more and 5 or less, more favorably a range of 2 or more and 4 or less.)

CH₃(CH₂)ᵣCOO—(CH₂)ₛCH(CH₃)₂ (4)
(provided that in the general formula (4), r is an integer selected from a range of 14 or more and 22 or less, and s is an integer selected from a range of 1 or more and 3 or less.)

CH₃(CH₂)ₜCOO—(CH)(CH₃)CH₂(CH₃)ᵤ (5)
(provided that in the general formula (5), t is an integer selected from a range of 14 or more and 22 or less, and u is an integer selected from a range of 1 or more and 3 or less.)

### [Antistatic Agent]

Examples of the antistatic agent include a natural surfactant, a non-ionic surfactant, a cationic surfactant, and the like.

### [Curing Agent]

Examples of the curing agent include polyisocyanate and the like. Examples of polyisocyanate include aromatic polyisocyanate such as an adduct of tolylene diisocyanate (TDI) and an active hydrogen compound, aliphatic polyisocyanate such as an adduct of hexamethylene diisocyanate (HMDI) and an active hydrogen compound, and the like. A weight average molecular weight of these polyisocyanates is desirably within the range of 100 or more and 3000 or less.

### [Rust Inhibitor]

Examples of the rust inhibitor include phenols, naphthols, quinones, a heterocyclic compound containing a nitrogen atom, a heterocyclic compound containing an oxygen atom, a heterocyclic compound containing a sulfur atom, and the like.

### [Non-Magnetic Reinforcement Particles]

Examples of the non-magnetic reinforcement particles include aluminum oxide (α, β or γ alumina), chromium oxide, silicon oxide, diamond, garnet, emery, boron nitride, titanium carbide, silicon carbide, titanium carbide, titanium oxide (rutile-type or anatase-type titanium oxide), and the like.

### [Underlayer]

The underlayer 42 is formed for mitigating asperities on the surface of the base layer 41 and adjusting asperities on the surface of the magnetic layer 43. The underlayer 42 is a non-magnetic layer containing non-magnetic powder, a binding agent, and a lubricant. The underlayer 42 supplies the lubricant to the surface of the magnetic layer 43. The underlayer 42 may further contain at least one type of additive selected from an antistatic agent, a curing agent, a rust inhibitor, and the like as necessary.

An upper limit value of an average thickness of the underlayer 42 is favorably 1.0 μm or less, more favorably 0.9 μm or less, further more favorably 0.8 μm or less, particularly favorably 0.7 μm or less, most favorably 0.6 μm or less. When the upper limit value of the average thickness of the underlayer 42 is 1.0 μm or less, the thickness of the magnetic tape MT can be reduced, and thus a recording capacity that can be recorded in a single data cartridge can be made higher than that of a general magnetic tape. Further, when the average thickness of the underlayer 42 is 1.0 μm or less, stretchability of the magnetic tape MT by an external force becomes higher, and thus an adjustment of the width of the magnetic tape MT by the tension adjustment becomes easier. A lower limit value of the average thickness of the underlayer 42 is favorably 0.3 μm or more. When the lower limit value of the average thickness of the underlayer 42 is 0.3 μm or more, lowering of a function as the underlayer 42 can be suppressed. It is noted that the average thickness of the underlayer 42 is obtained similarly to the average thickness of the magnetic layer 43. It is noted that a magnification of a TEM image is adjusted as appropriate according to the thickness of the underlayer 42.

### [Non-Magnetic Powder]

The non-magnetic powder includes, for example, at least one type of inorganic particle powder or organic particle powder. Further, the non-magnetic powder may include carbon powder such as carbon black. It is noted that one type of non-magnetic powder may be used alone, or two or more types of non-magnetic powder may be used in combination. The inorganic particles include, for example, metal, metal oxide, metal carbonate, metal sulfate, metal nitride, metal carbide, metal sulfide, and the like. Examples of the shape of the non-magnetic powder include various shapes such as an acicular shape, a spherical shape, a cubic shape, and a plate shape, but are not limited to these shapes.

The average particle size of the non-magnetic powder is favorably 10 nm or more and 150 nm or less, more favorably 15 nm or more and 110 nm or less. The average particle size of the non-magnetic powder is obtained similarly to the average particle size of the magnetic powder. The non-magnetic powder may contain non-magnetic powder having two or more particle size distributions.

### [Binding Agent, Lubricant]

The binding agent and the lubricant are similar to those of the magnetic layer 43 described above.

### [Additive]

The antistatic agent, the curing agent, and the rust inhibitor are similar to those of the magnetic layer 43 described above.

### [Back Layer]

The back layer 44 contains a binding agent and non-magnetic powder. The back layer 44 may further contain at least one type of additive selected from a lubricant, a curing agent, an antistatic agent, and the like as necessary. The binding agent and the non-magnetic powder are similar to those of the underlayer 42 described above. The curing agent and the antistatic agent are similar to those of the magnetic layer 43 described above.

An upper limit value of an average thickness t_{b} of the back layer 44 is favorably 0.6 μm or less. When the upper limit value of the average thickness t_{b} of the back layer 44 is 0.6 μm or less, the thicknesses of the underlayer 42 and the base layer 41 can be maintained thick even when the average thickness of the magnetic tape MT is 5.3 μm or less, and thus the running stability of the magnetic tape MT in the recording/reproducing device can be maintained. A lower limit value of the average thickness t_{b} of the back layer 44 is not limited in particular and is, for example, 0.2 μm or more.

The average thickness t_{b} of the back layer 44 is obtained as follows. First, an average thickness t_{T} of the magnetic tape MT is measured. The measurement method of the average thickness t_{T} is as described in the following “average thickness of magnetic tape”. Subsequently, the magnetic tape MT accommodated in the magnetic recording cartridge 10 is unwound, and the magnetic tape MT is cut out at a length of 250 mm from each of the range of 10 m to 20 m, the range of 30 m to 40 m, and the range of 50 m to 60 m from the connection portion 21 between the magnetic tape MT and the leader tape LT in the longitudinal direction, to thus produce three samples. Next, the back layer 44 of the sample is removed using a solvent such as MEK (methyl ethyl ketone) or dilute hydrochloric acid. Next, using the laser hologauge (LGH-110C) manufactured by Mitutoyo Corporation, the thickness of the sample is measured at five positions, and those measurement values (sample thicknesses at a total of 15 positions) are arithmetically averaged, to calculate an average value t_{B} [μm]. After that, the average thickness t_{b} [μm] of the back layer 44 is obtained by the following equation. It is noted that the five measurement positions are randomly selected from the sample such that the positions become different positions in the longitudinal direction of the magnetic tape MT.

t_{b} [μm]=t_{T} [μm]−t_{B} [μm]

### [Width Change Amount Δ of Magnetic Tape]

When a width change amount Δ of the magnetic tape is measured across the entire length of the magnetic tape after being stored at 65° C. for 360 hours, a sign of a width change amount Δout on the outer winding side of the magnetic tape and a sign of a width change amount Δin on the inner winding side of the magnetic tape differ. By the difference between the sign of the width change amount Δout on the outer winding side of the magnetic tape and the sign of the width change amount Δin on the inner winding side of the magnetic tape, excellent running stability can be obtained even when stored under a high-temperature environment. Further, the width change amount Δ is 0 ppm at a position of one of two regions between which a center line of the entire length of the magnetic tape is situated, the two regions being from among four regions into which the entire length of the magnetic tape is quadrisected. In this manner, by the width change amount Δ being 0 ppm in a specific region in the longitudinal direction of the magnetic tape, excellent running stability can be obtained even when stored under a high-temperature environment. Furthermore, the width change amount Δ in any of the four regions in the longitudinal direction of the magnetic tape is favorably 300 ppm or less, more favorably 250 ppm or less, further more favorably 200 ppm or less, much further more favorably 150 ppm or less.

The width change amount Δ of the magnetic tape is measured as follows.

First, a servo band pitch in the longitudinal direction of the magnetic tape in an initial state before storage at 65° C. for 360 hours is measured using a data recording/reproducing device 50. It is noted that the servo band pitch refers to an array interval of the servo bands.

It is noted that, in a state where the magnetic tape MT is wound into the magnetic recording cartridge 10 at a tension of 0.55 N for measuring the servo band pitch, the servo band pitch is measured at each position in the longitudinal direction of the magnetic tape MT across the entire length of the magnetic tape MT, while running the magnetic tape MT accommodated in the magnetic recording cartridge 10 so that the magnetic tape MT is wound into the data recording/reproducing device 50 (while running the magnetic tape MT in a so-called forward direction) under an environment of 32° C. and 55 RH %. In the measurement, a tension applied to the magnetic tape MT is 0.55 N, and a running speed is 3 to 6 m/s.

Next, after the magnetic tape MT is stored at 65° C. and 40 RH % for 24 hours in the state where the magnetic tape MT is wound into the magnetic recording cartridge 10 at a tension of 0.55 N, the magnetic tape MT is caused to reciprocate once at a tension of 0.55 N in the data recording/reproducing device 50 under an environment of 32° C. and 55 RH % and is stored again under the environment of 65° C. and 40 RH % for 24 hours, and after that, the magnetic tape MT is caused to reciprocate once at the tension of 0.55 N in the data recording/reproducing device 50 under the environment of 32° C. and 55 RH %. This process is repeated so as to store for a total of 360 hours.

A ratio of the servo band pitch after storage at each position in the longitudinal direction of the magnetic tape MT and the servo band pitch at each of the corresponding positions in the longitudinal direction in the initial state (corresponding positions in the longitudinal direction refer to positions at which ratios of the lengths within the entire length become the same) is set as the width change amount Δ. A portion where the width change amount Δ becomes minimum and a portion where the width change amount Δ becomes maximum are specified, and a difference between a width change amount maximum value Δₘₐₓ and a width change amount minimum value Δₘ in is calculated.

The measurement method of the servo band pitch will be specifically described below.

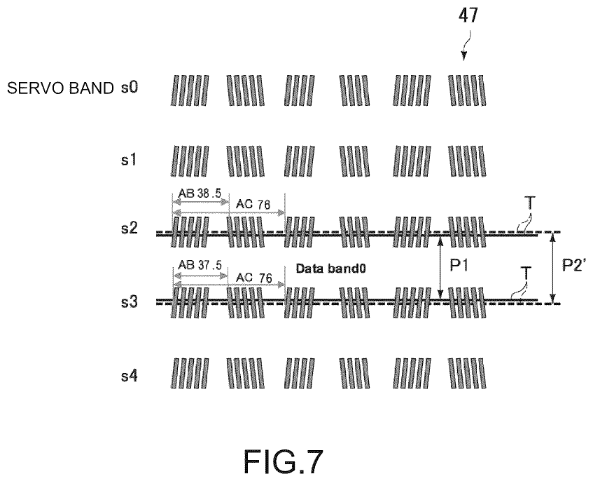

Herein, descriptions will be given on an example where the data write head 60 tracks a data band d0 situated between a servo band s2 and a servo band s3 as shown in FIG. 7.

As described above, the measurement method of the servo band pitch that uses the data recording/reproducing device 50 involves causing the magnetic tape MT to run across the entire length by the data recording/reproducing device 50, measuring numerical values representing relative positions of servo trace lines T of two servo read portions 62 with respect to servo patterns 47 on the respective servo bands, and calculating the servo band pitch from the measured relative positions of the respective servo trace lines T with respect to the servo patterns 47. An interval between the servo trace lines T indicated by solid lines in FIG. 7 indicates a servo band pitch when the width of the magnetic tape MT is not changed (a first pitch P1 that is an arrangement interval of the two servo read portions 62 of the data write head 60). In addition, an interval between the servo trace lines T indicated by broken lines in FIG. 7 corresponds to a servo band pitch (P2′) when the width of the magnetic tape MT is expanded.

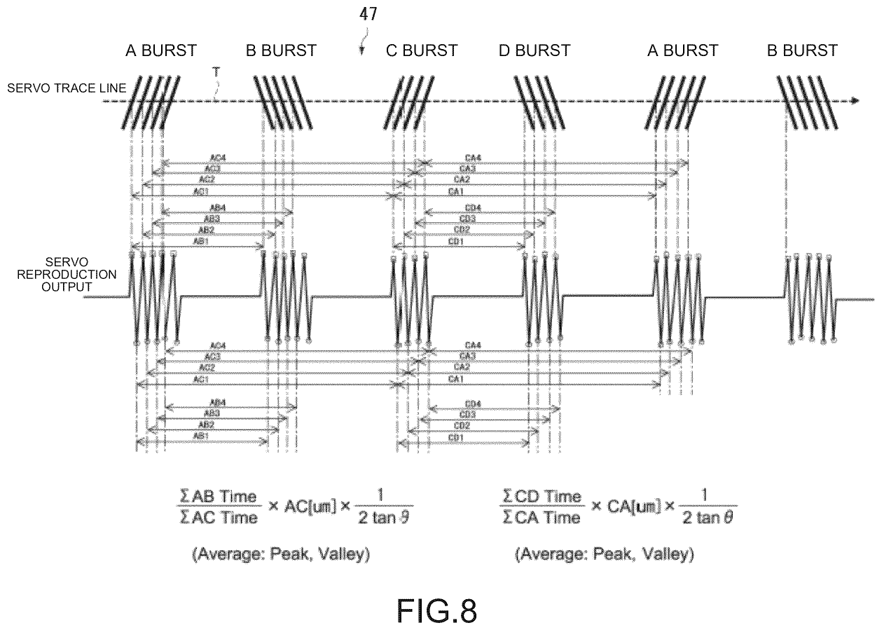

FIG. 8 is a diagram for explaining a measurement method of the servo trace line T. The data recording/reproducing device 50 outputs a servo reproduction signal having a waveform corresponding to the position of the servo trace line T with respect to the servo pattern 47. Typically, a distance AC between an A burst and a C burst which are arrays of tilted patterns of the same type of shape and a distance AB between the A burst and a B burst which are arrays of tilted patterns of different types of shapes are calculated, and numerical values representing the relative positions of the servo trace lines T of the respective servo read portions 62 with respect to the servo patterns 47 are calculated using Formula 1 below. It is noted that 0 represents an azimuth angle of each of the tilted patterns and is set to 12° in the present example.

$$\begin{matrix}[ Math . 2 ] & \\ \frac{\sum AB Time}{\sum AC Time} \times AC [ um ] \times \frac{1}{2 tan θ} & ( Formula 1 )\end{matrix}$$

Herein, the distance AC may be a distance AC1 between first tilted portions of the A burst and the C burst, a distance AC2 between second tilted portions thereof, a distance AC3 between third tilted portions thereof, or a distance AC4 between fourth tilted portions thereof. These distances AC (AC1 to AC4) each refer to a distance between positions that show maximum positive values of an amplitude in a servo reproduction waveform (upper peak positions).

Similarly, the distance AB may be a distance AB1 between the first tilted portions of the A burst and the B burst, a distance AB2 between the second tilted portions thereof, a distance AB3 between the third tilted portions thereof, or a distance AB4 between the fourth tilted portions thereof. Typically, the distance AB1 is adopted when the distance AC1 is adopted, the distance AB2 is adopted when the distance AC2 is adopted, the distance AB3 is adopted when the distance AC3 is adopted, and the distance AB4 is adopted when the distance AC4 is adopted.

Then, the servo band pitch is obtained from a difference between the numerical values representing the positions of the servo trace lines T on the servo patterns that are obtained from a ratio between the distance AB and the distance AC, the numerical values having been calculated using Formula 1. Herein, a difference of a measurement value of the servo band on a tape center side (servo band s2) from a measurement value of the servo band on a tape edge side (servo band s3) out of the two servo bands to be measured is obtained. Positive and negative of the value indicate tape width change directions, and a positive value corresponds to narrowing of the servo band pitch whereas a negative value corresponds to widening of the servo band pitch. If the difference is zero, it means that the tape width has not varied.

It is favorable for the servo band pitch to be obtained from differences among many servo frames, and may be, for example, an average value of measurement values calculated from differences among 100 to 100,000 servo frames. A tape tension during the measurement is a tension applied during recording of the servo pattern 47 (reference tension; for example, 0.55 N), and the measurement is performed at a constant tension across the entire length of the magnetic tape MT.

It is noted that the measurement method of the servo trace line T is not limited to the example described above. For example, a distance CA between the C burst and the A burst and a distance CD between the C burst and the D burst may be calculated, and the position of the servo trace line T may be measured using Formula 2 below.

$$\begin{matrix}[ Math . 3 ] & \\ \frac{\sum CD Time}{\sum CA Time} \times CA [ um ] \times \frac{1}{2 tan θ} & ( Formula 2 )\end{matrix}$$

Herein, the distance CA may be a distance CA1 between the first tilted portions of the C burst and the A burst, a distance CA2 between the second tilted portions thereof, a distance CA3 between the third tilted portions thereof, or a distance CA4 between the fourth tilted portions thereof. These distances CA (CA1 to CA4) each refer to a distance between positions that show maximum positive values of the amplitude in the servo reproduction waveform.

Similarly, the distance CD may be a distance CD1 between the first tilted portions of the C burst and the D burst, a distance CD2 between the second tilted portions thereof, a distance CD3 between the third tilted portions thereof, or a distance CD4 between the fourth tilted portions thereof. Typically, the distance CD1 is adopted when the distance CA1 is adopted, the distance CD2 is adopted when the distance CA2 is adopted, the distance CD3 is adopted when the distance CA3 is adopted, and the distance CD4 is adopted when the distance CA4 is adopted.

Further, for the measurement of the servo band pitch, an average value of the measurement value obtained by using Formula 1 and the measurement value obtained by using Formula 2 may be used. Furthermore, a distance between positions that show maximum negative values of the amplitude in the servo reproduction waveform (lower peak positions) may be adopted as the distances AC and AB in Formula 1 and the distances CA and CD in Formula 2. Alternatively, an average value of the distance between the positions that show the maximum positive values of the amplitude in the servo reproduction waveform (upper peak positions) and the distance between the positions that show the maximum negative values (lower peak positions) may be adopted as the distances AC and AB in Formula 1 and the distances CA and CD in Formula 2.

As shown in FIG. 7, when the servo trace lines T are located at the positions indicated by the broken lines, the distance AB is 38.5 μm and the distance AC is 76 μm in the servo band s2, and the distance AB is 37.5 μm and the distance AC is 76 μm in the servo band s3.

In the servo band s2,

(38.5/76)×(76/2 tan 12°)=90.5641 [μm]

In the servo band s3,

(37.5/76)×(76/2 tan 12°)=88.2118 [μm]

A difference between these values becomes

88.2118−90.5641=−2.3523 [μm]

Accordingly, the servo band pitch P2 in this case is obtained as a value that is 2.3523 μm wider than the servo read head pitch P1.

It is noted that as shown in FIG. 7, when the servo trace lines T are located at the positions indicated by the solid lines, the distance AB is 38 μm and the distance AC is 76 μm in both the servo band s2 and the servo band s3. In this case, the pitch is 89.3880 [μm] in both the servo band s2 and the servo band s3, and a difference between those values is 0 [μm]. In other words, the servo band pitch in this case is the same as the servo read head pitch P1.

### [Tension Control]

The data recording/reproducing device 50 may control the tension of the magnetic tape MT based on the servo pattern pitch measured as described above so that the measured servo pattern pitch and the servo read head pitch P1 become the same.

In the present embodiment, prior to recording of data on the magnetic tape MT or reproduction of data from the magnetic tape MT, servo signals may be read from two servo bands between which one data band for recording or reproducing data is situated, and whether the pitch of these two servo bands is wider or narrower than the servo read head pitch P1 may be determined from the respective read servo signals. The tension may be increased when the servo band pitch is wider than the servo read head pitch P1, and the tension may be decreased when the servo band pitch is narrower than the servo read head pitch P1. By adjusting a magnitude of the tension according to the size of the servo band pitch in this manner, it is possible to stably perform desired tracking control for the data band.

The data recording/reproducing device 50 may acquire a relationship between the servo band pitch and the tension for one data band by one reciprocating running of the tape, and record the acquired data in the cartridge memory 11. The data recording/reproducing device 50 may similarly apply the relationship between the servo band pitch measured for the one data band and the tension to the data recording/reproduction with respect to other data bands.

It is noted that the width change amount of the magnetic tape MT in the longitudinal direction can be adjusted as follows, for example. For reducing distortions and creeps caused in the magnetic tape MT, the material of the base layer, horizontal and vertical strength of the base layer (horizontal and vertical stretching condition), the type of the magnetic layer (coating-type magnetic layer, vacuum thin-film-type magnetic layer), and in the case of the coated layer, Tg of the binding agent, the amount of the curing agent, and the like may be selected as appropriate. Further, for mitigating distortions, the magnetic tape MT may be stored at a temperature of 65° C. or more for a long time before cutting, and may be further stored at a temperature of 55° C. or more for a long time before servo writing.

### [Loss Elastic Modulus, Storage Elastic Modulus]

The loss elastic modulus of the base layer 41 at 65° C. may be 0.40 GPa or less, favorably 0.35 GPa or less, more favorably 0.30 GPa or less, further more favorably 0.25 GPa or less, favorably 0.20 GPa or less. By setting the loss elastic modulus within this range, it is possible to provide a magnetic recording cartridge in which the width of the magnetic tape in the longitudinal direction can be corrected by adjusting the running tension of the tape system or changing the winding direction, even when stored under a high-temperature environment of 60° C. or more.

The storage elastic modulus of the base layer 41 at 65° C. may be favorably 8.0 GPa or less, more favorably 7.0 GPa or less, further more favorably 6.0 GPa or less. By setting the storage elastic modulus within the numerical range described above, it is possible to provide a magnetic recording cartridge in which the width of the magnetic tape in the longitudinal direction can be corrected by adjusting the running tension of the tape system or changing the winding direction, even after storage under a high-temperature environment.

Further, a lower limit of the storage elastic modulus of the base layer at 65° C. is not limited in particular and may be, for example, favorably 0.01 GPa or more, more favorably 0.02 GPa or more, further more favorably 0.03 GPa or more.

The loss elastic modulus and the storage elastic modulus are measured by dynamic viscoelasticity measurement. The dynamic viscoelasticity measurement is a temperature-dependent measurement and is specifically performed as follows.

The magnetic tape MT accommodated in the magnetic recording cartridge 10 is unwound and cut at a length of 250 mm from three positions that are 10 m to 20 m, 30 m to 40 m, and 50 m to 60 m, respectively, from the connection portion between the magnetic tape MT and the leader tape LT, and the cut-out magnetic tape MT is cut into a measurement tape length of 22.0 mm and a width of 4.0 mm using a punch, to thus prepare a sample. Layers of the sample other than the base layer 41 (that is, the non-magnetic layer (underlayer) 42, the magnetic layer 43, and the back layer 44) are removed using acetone, ethanol, or the like. Both ends of the sample in the longitudinal direction are clamped by a measurement portion of a dynamic viscoelasticity measurement device (RSA II manufactured by TA Instruments). Then, the dynamic viscoelasticity measurement is performed under the following measurement conditions. The measurement is performed at five positions for each sample with an n number of 3, and those measurement values (at a total of 15 positions) are simply averaged (arithmetic average) to calculate the loss elastic modulus and the storage elastic modulus. It is noted that the five measurement positions are randomly selected from each sample such that the positions become different positions in the longitudinal direction of the magnetic tape MT.
Measurement temperature range: −10° C. to 180° C.
Temperature increase rate: 2° C./min
Amplitude: expansion and contraction at amplitude of 0.1% with respect to initial tape length
Measurement frequency: 10 Hz
Test Type: “Strain-Controlled”
Measurement Type: “Dynamic”
Environment in which device is placed: temperature of 25° C., humidity of 50 RH %
Humidity control of measurement portion: none
Measurement N number: 3

More detailed settings regarding the measurement conditions of the device are as follows. That is, as described below, in the measurement, the tension is adjusted so that the tension does not become 0 or less, and the distortion is adjusted so that it does not fall below a lower limit value of a transducer. The measurement conditions for these adjustments may be set as appropriate by those skilled in the art, but the following settings may be adopted for the dynamic viscoelasticity measurement device, for example.

### Option Settings

Delay Before Test: OFF
Auto Tension (setting for adjusting tension so that tension does not become 0 or less)
Mode Static Force Tracking Dynamic Force
   Auto Tension Direction Tension
   Initial Static Force 10.0 g
   Static>Dynamic Force by 5.0%
   Minimum Static Force 1.0 g
   Auto Tension Sensitivity 1.0 g
Auto Strain (setting for adjusting strain so that it does not fall below lower limit of transducer)
   Max Applied Strain 0.1%
   Max Allowed Force 100.0 g
   Min Allowed Force 2.0 g
   Strain Adjustment 3.0%
Meas Ops: Default setting

By performing the dynamic viscoelasticity measurement described above on the base layer 41, values of the loss elastic modulus and the storage elastic modulus at a measurement temperature of 65° C. can be obtained.

The loss elastic modulus and the storage elastic modulus of the base layer 41 can be adjusted, for example, by the type of material forming the base layer, a stretching state of the base layer in the longitudinal direction and the width direction, and/or a coating and drying process, a calender process, a curing process, an Aging process, and/or the like.

For example, by using PEN, PET, or PEEK as the material forming the base layer, the loss elastic modulus and the storage elastic modulus can be smaller than those of a case where other materials are used.

### [Arithmetic Average Roughness Ra]

The arithmetic average roughness Ra of the magnetic surface is favorably 2.5 nm or less, more favorably 2.0 nm or less. When Ra is 2.5 nm or less, additionally excellent SNR can be obtained.

The arithmetic average roughness Ra is obtained as follows. First, a surface on a side on which the magnetic layer 43 is provided is observed using an AFM (Atomic Force Microscope) (Dimension Icon manufactured by Bruker) to acquire a cross-sectional profile. Next, the arithmetic average roughness Ra is obtained from the acquired cross-sectional profile in accordance with JIS B0601:2001.

### [Average Thickness t_{T} of Magnetic Tape MT]

An average thickness t_{T} of the magnetic tape MT is favorably 5.6 μm or less, more favorably 5.4 μm or less, further more favorably 5.0 μm or less, particularly favorably 4.6 μm or less. When the average thickness t_{T} of the magnetic tape MT satisfies “t_{T}≤5.6 μm”, the recording capacity that can be recorded in one data cartridge can be made higher than that of the conventional case. A lower limit value of the average thickness t_{T} of the magnetic tape MT is not limited in particular and satisfies, for example, “3.5 μm≤t_{T}”.

The average thickness t_{T} of the magnetic tape MT is obtained as follows. First, the magnetic tape MT accommodated in the magnetic recording cartridge 10 is unwound and cut at a length of 250 mm from three positions that are 10 m to 20 m, 30 m to 40 m, and 50 m to 60 m, respectively, from the connection portion between the magnetic tape MT and the leader tape LT, to produce samples. Next, using the laser hologauge (LGH-110C) manufactured by Mitutoyo Corporation as a measurement device, a thickness of each sample is measured at five positions, and those measurement values (at a total of 15 positions) are simply averaged (arithmetic average), to thus calculate the average thickness t_{T} [μm]. It is noted that the five measurement positions are randomly selected from each sample such that the five measurement positions become different positions in the longitudinal direction of the magnetic tape MT.

### [Ratio H1/H2 of Average Height H1 of First Protrusions to Average Height H2 of Second Protrusions]

An upper limit value of a ratio H1/H2 of an average height H1 of the first protrusions 91B to an average height H2 of the second protrusions 92B (hereinafter, will be referred to as average height ratio H1/H2 of the protrusions) is represented using “H1/H2≤2.3”, favorably “H1/H2≤2.0”, more favorably “H1/H2≤1.7”, further more favorably “H1/H2≤1.5”. When the average height ratio H1/H2 of the protrusions satisfies “H1/H2≤2.3”, a contact area between the first protrusions 91B and the data write head 60 can be adjusted to an appropriate range, and frequentness of contact between the second protrusions 92B and the data write head 60 can be adjusted to an appropriate range, so that the abrasion of the first protrusions 91B caused by the running of the magnetic tape MT can be suppressed. Accordingly, an increase in friction of the magnetic surface due to many times of running can be suppressed. Thus, an increase of the standard deviation σPES of the PES value due to many times of running can be suppressed.

A lower limit value of the average height ratio H1/H2 of the protrusions is favorably represented using “1.0≤H1/H2”, more favorably “1.1≤H1/H2”, further more favorably “1.2≤H1/H2”. Since the second protrusions 92B are more easily crushed than the first protrusions 91B during calender processing of the magnetic surface, the average height H2 of the second protrusions 92B is lower than the average height H1 of the first protrusions 91B. Therefore, it is difficult to adjust the average height ratio H1/H2 of the protrusions on the magnetic surface after the calender processing such that H1/H2<1.0.

### [Average Height H1 of First Protrusions]

An upper limit value of the average height H1 of the first protrusions 91B is favorably 12.0 nm or less, more favorably 11.5 nm or less, further more favorably 10.5 nm or less, 9.5 nm or less, or 8.5 nm or less. When the average height H1 of the first protrusions 91B exceeds 12.0 nm, a spacing amount between the data write head 60 and the magnetic tape MT becomes large, and there is a fear that it will not be possible to obtain predetermined electromagnetic conversion characteristics.

A lower limit value of the average height H1 of the first protrusions 91B is not limited in particular and is favorably 5.0 nm or more, more favorably 5.5 nm or more, further more favorably 6.0 nm or more.

### [Average Height H2 of Second Protrusions]

An upper limit value of the average height H2 of the second protrusions 92B is favorably 7.0 nm or less, more favorably 6.5 nm or less, further more favorably 6.0 nm or less, 5.5 nm or less, or 5.3 nm or less. When the average height H2 of the second protrusions 92B exceeds 7.0 nm, the spacing amount between the data write head 60 and the magnetic tape MT becomes large, and there is a fear that it will not be possible to obtain predetermined electromagnetic conversion characteristics.

A lower limit value of the average height H2 of the second protrusions 92B is not limited in particular and is favorably 2.0 nm or more, more favorably 2.5 nm or more, further more favorably 3.0 nm or more.

### [Measurement Method of Average Height H1 of First Protrusions, Average Height H2 of Second Protrusions 92B, and Average Height Ratio H1/H2 of Protrusions]

The average height H1 of the first protrusions 91B, the average height H2 of the second protrusions 92B, and the average height ratio H1/H2 of the protrusions are, as described below, obtained by acquiring an AFM image using the atomic force microscope (Atomic Force Microscope: AFM) and an FE-SEM image using a field-emission scanning electron microscope (Field-Emission Scanning Electron Microscope: FE-SEM) at the same position in a measurement sample, and associating the AFM image and the FE-SEM image with each other.

The height of each protrusion can be measured by the AFM, and which of the first particle 91A and the second particle 92A each protrusion is formed of can be specified by the FE-SEM. The image obtained by the AFM and the image obtained by the FE-SEM for the same position overlap to obtain a synthetic image, and the type of particle forming each protrusion (which of the first particle 91A and the second particle 92A the protrusion is) and the height of each protrusion can be associated with each other from the obtained synthetic image.

Hereinafter, descriptions will sequentially be given on (A) Production of measurement sample and acquisition of AFM image, (B) Method of specifying type of particle forming protrusion using FE-SEM, (C) Method of associating height of protrusion and type of particle forming protrusion, (D) Method of measuring height of protrusion using AFM, and (E) Method of calculating average height H1 of first protrusions, average height H2 of second protrusions, and average height ratio H1/H2 of protrusions.

### (A) Production of Measurement Sample and Acquisition of AFM Image

First, the magnetic tape MT accommodated in the cartridge 10 is unwound, and the magnetic tape MT is cut out at a position 30 to 40 m in the longitudinal direction from the connection portion 21 between the magnetic tape MT and the leader tape LT into a size that can be placed on an AFM observation sample stage and an SEM observation sample stage, to thus produce a measurement sample. Next, marking is performed on a surface of the measurement sample, with a center portion of the measurement sample being avoided. As the marking method, there are a method of forming a linear or dot-like dent on the magnetic tape MT using a manipulator, a naindenter, or the like, a method of forming a convex portion on the magnetic tape MT using silver paste or the like, and the like. It is noted that since a marking portion is scanned with a probe in the AFM, depending on a state of the marking portion, a tip end of the probe may be smeared, and an accurate AFM image may not be obtained. Therefore, it is favorable to make the marking small and shallow so that the probe is not smeared.

Next, the marking portion on the measurement sample surface is subjected to a shape analysis by the AFM. Since the marked marking portion is dented or is protruding, the measurement sample surface is measured by the AFM at a viewing angle of 5 μm×5 μm so that the marking portion is as close to an edge of the visual field as possible. It is noted that the protrusions in a peripheral portion of the marking portion are not a measurement target. Specifically, the measurement is performed at a viewing angle of 10 μm×10 μm, a portion to become a mark is determined, and the measurement sample surface of a portion with no marking is measured at a viewing angle of 5 μm×5 μm in accordance with the portion to become a mark. The measurement conditions for the shape analysis are as described below.

### <AFM Measurement Conditions>

Measurement device: AFM Dimension 3100 microscope (including Nanoscope IV controller) (manufactured by Digital Instruments)
Measurement mode: Tapping
Tapping frequency during tuning: 200 kHz or more and 400 kHz or less
Cantilever: SNL-10 (manufactured by Bruker)
Scan size: 5 μm×5 μm
Scan rate: 1 Hz
Scan line: 256
   <Method of Calculating Reference Surface Used when Calculating Protrusion Height>

The AFM image is divided into 256×256 (=65,536) measurement points, a height Z(i) (i: measurement point number, i=1 to 65,536) is measured at each measurement point, and the measured heights Z(i) at the respective measurement points are simply averaged (arithmetic average), to obtain an average height (reference surface) Zₐᵥₑ (=(Z(1)+Z(2)+ . . . +Z(65,536))/65,536).

### (B) Method of Specifying Type of Particle Forming Protrusion Using FE-SEM

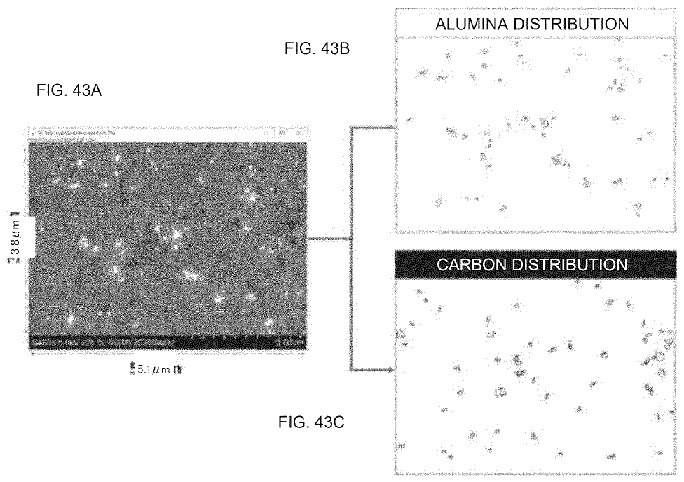

The marking portion of the measurement sample is imaged using a FE-SEM under the FE-SEM measurement conditions described below to obtain a FE-SEM image. A of FIG. 43 is an example of the FE-SEM image. From the obtained FE-SEM image, a type of the particle forming the protrusion can be specified using a brightness difference that is due to a difference between a secondary electron emission amount of the first particle 91A and that of the second particle 92A. Image processing for the specification will be described later. Further, positions of the protrusions formed of the first particle 91A and the second particle 92A in the FE-SEM image are identified.

### <FE-SEM Measurement Conditions>

Measurement device: HITACHI S-4800 (manufactured by Hitachi High-Tech Corporation)
Viewing angle: 5.1 μm×3.8 μm
Acceleration voltage: 5 kV
Measurement magnification: 25000 folds

The obtained FE-SEM image (A of FIG. 43) is subjected to binarization processing using image processing software Image J under each of two processing conditions described below. From the image obtained by the binarization processing, information on the number of protrusions is obtained for the first protrusions 91B and the second protrusions 92B respectively formed of the first particles 91A and the second particles 92A. It is noted that during the binarization processing, the conditions are changed as follows for the second particles 92A having high brightness (white parts in A of FIG. 43) and the first particles 91A having low brightness (black parts in A of FIG. 43).

### <Binarization Processing Conditions for Obtaining Information Related to First Particles>

Software: Image J Ver 1.44p
Binarization threshold: Threshold (0.65)
Binarization target size: 0.002 μm-infinity

### <Binarization Processing Conditions for Obtaining Information Related to Second Particles>

Software: Image J Ver 1.44p
Binarization threshold: Threshold (220,255)
Binarization target size: 0.001 μm-infinity

B of FIG. 43 is an image obtained by performing the binarization processing on the FE-SEM image shown in A of FIG. 43 under the binarization processing conditions for the second particles (alumina particles) 92A, that is, an image that shows a position distribution of the second protrusions 92B formed of the second particles (alumina particles) 92A. The following information related to the second particles 92A can be obtained from the obtained image.

### <Obtained Information Related to Second Particles>

Number of particles: 58

C of FIG. 43 is an image obtained by performing the binarization processing on the FE-SEM image shown in A of FIG. 43 under the binarization processing conditions for the first particles (carbon black particles) 91A, that is, an image that shows a position distribution of the first protrusions 91B formed of the first particles (carbon black particles) 91A. The following information related to the first particles 91A can be obtained from the obtained image.

### <Obtained Information Related to First Particles>

Number of particles: 55

### (C) Method of Associating Height of Protrusion and Type of Particle Forming Protrusion

The obtained AFM image and the FE-SEM image obtained before the binarization processing overlap to obtain a synthetic image. Using the synthetic image, it is specified which of the first particle 91A and the second particle 92A the particle forming each protrusion is.

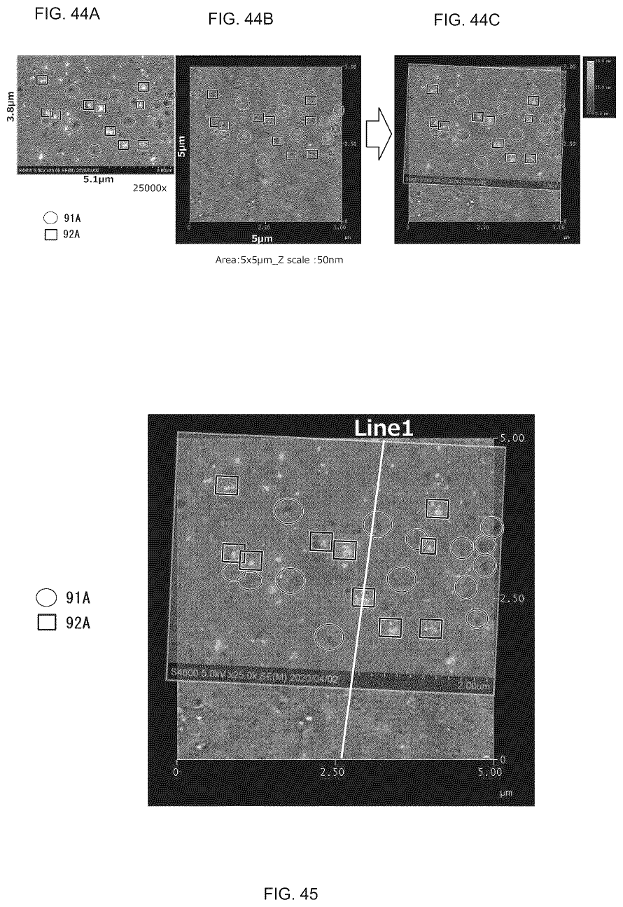

For example, C of FIG. 44 is a synthetic image in which an AFM image (B of FIG. 44) and a FE-SEM image (A of FIG. 44) overlap such that positions of corresponding protrusions match. In the FE-SEM image (A of FIG. 44) obtained before the image synthesis, different marks (“∘” or “□”) are allocated to respective positions so that the positions of the first protrusions 91B and the positions of the second protrusions 92B determined by the binarization processing can be distinguished. Similarly, in the AFM image (B of FIG. 44) obtained before the image synthesis, different marks (“∘” or “□”) are allocated to the respective positions so that the positions of the first protrusions 91B and the positions of the second protrusions 92B determined by the binarization processing can be distinguished. From the synthetic image (C of FIG. 44) in which the AFM image (B of FIG. 44) and the FE-SEM image (A of FIG. 44) overlap such that the positions of the corresponding protrusions match, it is determined which of the first particle 91A and the second particle 92A each of the protrusions is formed of. It is noted that in B of FIG. 44, since the marking portion is measured at a viewing angle of 10 μm×10 μm using the AFM and then the portion with no marking is measured at a viewing angle of 5 μm×5 μm, marking is not present in the image.

### (D) Method of Measuring Height of Protrusion Using AFM

Using AFM analysis software (Software version 5.12 Rev. B for Dimension 3100, manufactured by Veeco Instruments Inc.), heights of 20 first protrusions 91B in the synthetic image are measured, and heights of 20 second protrusions 92B are also measured.

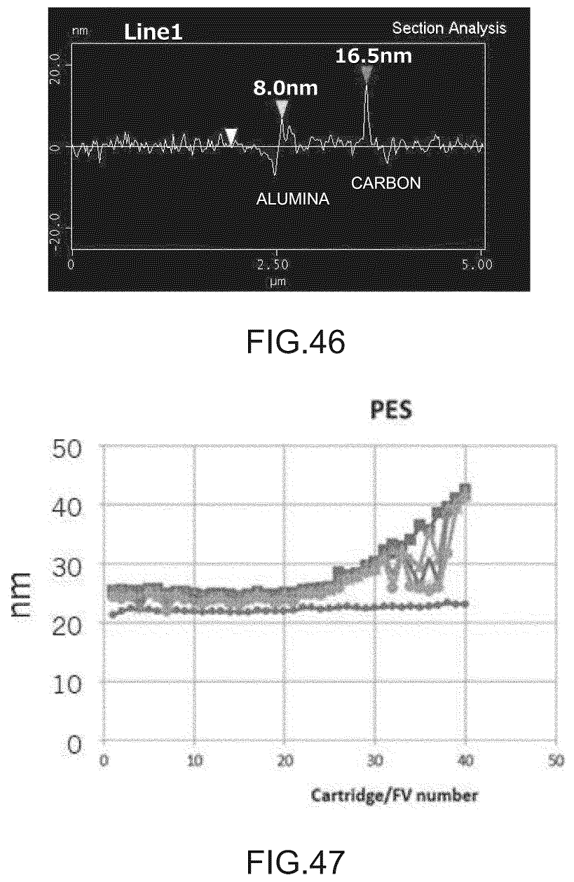

For example, FIG. 45 is an enlarged view of a synthetic image obtained by an AFM image and a FE-SEM image overlapping. FIG. 46 is a diagram showing an analysis result (a measurement result on the heights of the protrusions) by the AFM for Line 1 (Line 1) set at an arbitrary position in FIG. 45. As shown in FIG. 46, it is possible to specify the heights of the first protrusions 91B and the second protrusions 92B respectively formed of the first particles (carbon black particles) 91A and the second particles (alumina particles) 92A present on Line 1. In this manner, the heights of the first protrusions 91B and the second protrusions 92B are specified from the synthetic image and the AFM analysis result.

When 20 or more protrusions can be specified in one visual field of the AFM from one measurement sample for each of the first protrusions 91B and the second protrusions 92B, one visual field is measured by the AFM. When the number of protrusions that can be specified in one visual field of the AFM is smaller than 20 for each of the first protrusions 91B and the second protrusions 92B, a plurality of (for example, 3 to 5) visual fields is measured from one measurement sample. Thus, for each of the first protrusions 91B and the second protrusions 92B, 20 points that are each specified as the first protrusion 91B or the second protrusion 92B by the binarization processing described above are secured. It is noted that when measuring a plurality of visual fields from one measurement sample as described above, the plurality of visual fields is randomly selected from one measurement sample.

### (E) Method of Calculating Average Height H1 of First Protrusions, Average Height H2 of Second Protrusions, and Average Height Ratio H1/H2 of Protrusions

The heights of the 20 first protrusions 91B obtained as described above are simply averaged (arithmetic average) to obtain an average value, which is set as the average height H1 of the first protrusions. Similarly, the heights of the 20 second protrusions 92B obtained as described above are simply averaged (arithmetic average) to obtain an average value, which is set as the average height H2 of the second protrusions. The average height ratio H1/H2 of the protrusions is calculated using the average height H1 of the first protrusions 91B and the average height H2 of the second protrusions 92B that have been obtained as described above.

### [Standard Deviation σPES of PES Value]

A standard deviation σPES of a PES value of the magnetic tape MT is favorably smaller than 50 nm, more favorably 40 nm or less, further more favorably 30 nm or less, particularly favorably 25 nm or less within 40 FV number.

PES (Position Error Signal) indicates a deviation amount (error) of a reading position of a servo pattern in the width direction of the magnetic tape MT when the servo pattern is reproduced (read) by the data recording/reproducing device. In order to adjust the tension in the longitudinal direction of the magnetic tape MT with high accuracy, it is favorable for the linearity of the servo band when the servo pattern is read by the data recording/reproducing device to be as high as possible, that is, a standard deviation σPES of a PES value indicating the deviation amount of the reading position to be as low as possible. When the standard deviation σPES of the PES value of the magnetic tape MT is a low value as described above, the linearity of the servo band is high, and the tension of the magnetic tape MT can be adjusted with high accuracy. In addition, the standard deviation σPES is related to the friction of the magnetic surface, and when the friction of the magnetic surface increases, the standard deviation σPES tends to increase.

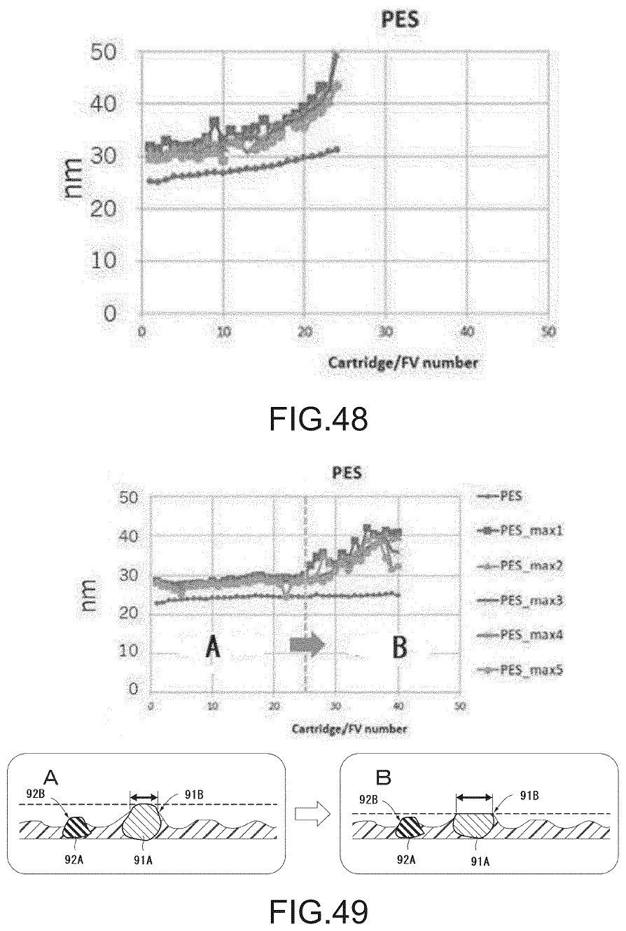

FIG. 47 is a diagram showing a first example of a temporal change of the standard deviation σPES of the PES value accompanying the running of the magnetic tape MT. As shown in FIG. 47, when σPES is smaller than 50 nm within 40 FV number, no track deviation occurs. In addition, an increase in friction of the magnetic surface is suppressed and is kept almost constant. FIG. 48 is a diagram showing a second example of the temporal change of the standard deviation σPES of the PES value accompanying the running of the magnetic tape MT. As shown in FIG. 48, when σPES exceeds 50 nm within 40 FV number, track deviation occurs frequently to cause the running of the magnetic tape MT to stop. In addition, the friction of the magnetic surface increases.

The upper diagram of FIG. 49 is a diagram showing a third example of the temporal change of the standard deviation σPES accompanying the running of the magnetic tape MT. The lower left diagram of FIG. 49 is a cross-sectional view schematically showing a relationship between the first protrusion 91B and second protrusion 92B and the data write head 60 in a region A where the value of σPES in the upper diagram is almost constant (stable friction). The broken line in the diagram is a virtual line indicating a contact position between the first protrusion 91B and a surface of the data write head 60. The lower right diagram of FIG. 49 is a cross-sectional view schematically showing a relationship between the first protrusion 91B and second protrusion 92B and the data write head 60 in a region B where the value of σPES in the upper diagram is on the rise (increasing friction). The broken line in the diagram is a virtual line indicating the contact position between the first protrusion 91B and the surface of the data write head 60.

As shown in FIG. 49, the standard deviation σPES is almost constant in the region A, while the standard deviation σPES increases in the region B. The reason is presumed to be that the contact area between the first protrusion 91B and the surface of the data write head 60 is small and the friction is constant in the region A, while in the region B, the first particle 91A (carbon particle) is worn down by the magnetic tape MT along with the running of the magnetic tape MT, so that the first protrusion 91B gradually loses its shape, and the contact area between the first protrusion 91B and the surface of the data write head 60 increases so as to increase the friction.

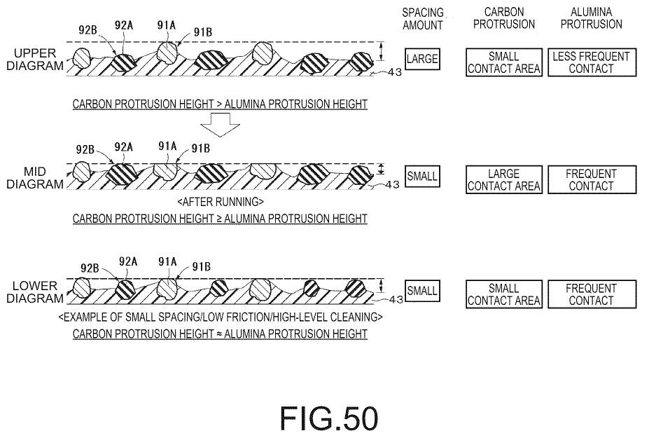

FIG. 50 is a set of cross-sectional views each schematically showing a relationship between the first protrusions 91B and second protrusions 92B on the magnetic surface and the data write head 60. The broken lines in FIG. 50 are each a virtual line indicating a contact position between the first protrusions 91B on the magnetic surface and the surface of the data write head 60.

The upper diagram of FIG. 50 is a diagram schematically showing a relationship between the first protrusions 91B and second protrusions 92B and the data write head 60 before running of the magnetic tape MT. As shown in the upper diagram of FIG. 50, before running of the magnetic tape MT, the height of the first protrusions 91B is larger than the height of the second protrusions 92B, and a spacing amount between the data write head 60 and the magnetic tape MT is large, and thus it is predicted that the contact area between the first protrusions 91B and the data write head 60 is small and the second protrusions 92B and the data write head 60 come into contact with each other less frequently.

The mid diagram of FIG. 50 is a diagram schematically showing the relationship between the first protrusions 91B and second protrusions 92B and the data write head 60 after running of the magnetic tape MT. As shown in the mid diagram of FIG. 50, after the running of the magnetic tape MT, the first protrusions 91B are gradually worn down by contact with the magnetic tape MT, and the height of the first protrusions 91B becomes higher than or equal to the height of the second protrusions 92B, and thus it is predicted that the spacing amount between the data write head 60 and the magnetic tape MT becomes small, the contact area between the first protrusions 91B and the data write head 60 becomes large, and the second protrusions 92B and the data write head 60 come into contact with each other more frequently. In this state, the friction is high, and the standard deviation σPES deteriorates.

The lower diagram of FIG. 50 is a diagram schematically showing the relationship between the first protrusions 91B and second protrusions 92B and the data write head 60 according to the present embodiment. As shown in the lower diagram of FIG. 50, it is predicted that, by reducing the contact area between the first protrusions 91B and the data write head 60 and causing the second protrusions 92B and the data write head 60 to come into contact with each other more frequently by making the relationship between the height of the first protrusions 91B and the height of the second protrusions 92B take the shape of the present embodiment (a concavo-convex shape with an average height ratio H1/H2 of the protrusions that satisfies “H1/H2≤2.3”), the abrasion of the first protrusions 91B accompanying the running of the magnetic tape MT is suppressed, and as a result, an increase of the standard deviation σPES is suppressed.

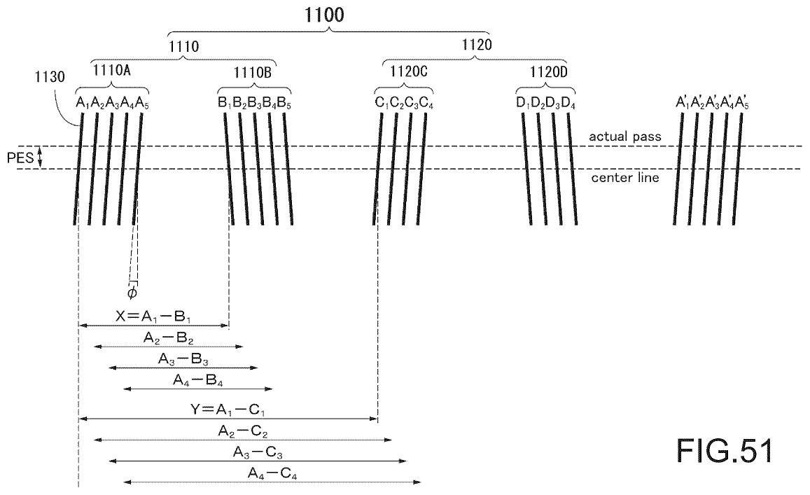

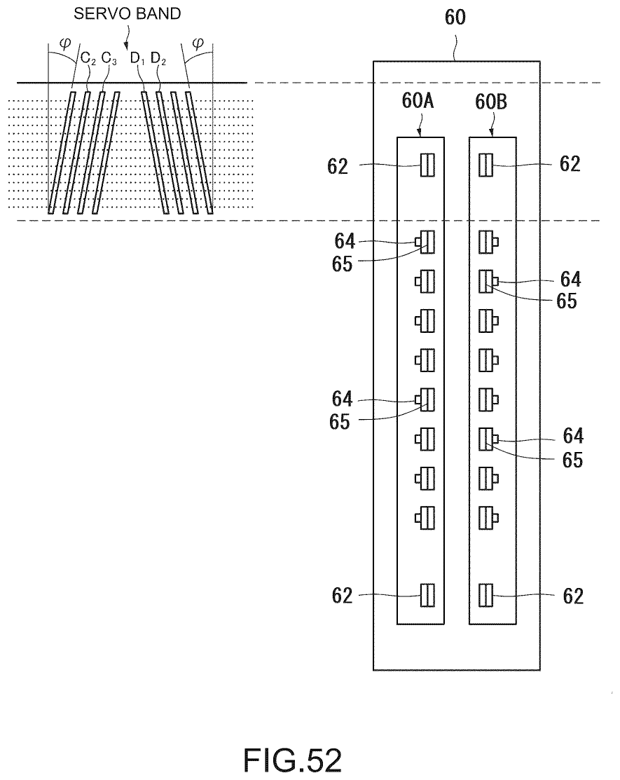

A measurement method of the standard deviation σPES will be described below with reference to FIGS. 51 and 52. The PES value is measured to obtain the standard deviation σPES. For measuring the PES value, for example, a PES measurement data write head 60 shown in FIG. 52 is prepared. An LTO2 head (a head conforming to an LTO2 standard) manufactured by HPE (Hewlett Packard Enterprise) is used as the data write head 60. The data write head 60 includes two data write head portions 60A and 60B arranged next to each other along the longitudinal direction of the magnetic tape MT. Each head portion includes a plurality of data write portions 64 for recording data signals onto the magnetic tape MT, a plurality of data read portions 65 for reproducing the data signals recorded on the magnetic tape MT, and a plurality of servo read portions 62 for reproducing servo signals recorded on the magnetic tape MT. It is noted that when the data write head 60 is used only for measuring the PES value, the data write portions 64 and the data read portions 65 do not have to be included in the data write head.

Herein, a servo band for explaining the method of measuring the PES will be described with reference to FIG. 51. As shown in FIG. 51, a servo pattern constituted of a plurality of servo stripes (linear magnetization regions) 1130 each tilted with respect to the width direction of the magnetic tape MT is formed on the servo band.

The servo band includes a plurality of servo frames 1110. Each of the servo frames 1110 is constituted of 18 servo stripes 1130. Specifically, each of the servo frames 1110 is constituted of a servo sub-frame 1 (1110) and a servo sub-frame 2 (1120).

The servo sub-frame 1 (1110) is constituted of an A burst 1110A and a B burst 1110B. The B burst 1110B is arranged next to the A burst 1110A. The A burst 1110A includes five servo stripes 1130 formed at specified intervals and tilted at a predetermined angle φ with respect to the width direction of the magnetic tape MT. In FIG. 51, symbols A1, A2, A3, A4, and A5 are respectively allocated to these five servo stripes 1130 from an EOT (End Of Tape) toward a BOT (Beginning Of Tape) of the magnetic tape MT. Similar to the A burst 1110A, the B burst 1110B includes five servo stripes formed at specified intervals and tilted at a predetermined angle φ with respect to the width direction of the magnetic tape MT. In FIG. 51, symbols B1, B2, B3, B4, and B5 are respectively allocated to these five servo stripes from the EOT toward the BOT of the magnetic tape MT. The servo stripes 1130 of the B burst 1110B are tilted in the opposite direction from the servo stripes 1130 of the A burst 1110A. In other words, the servo stripes 1130 of the A burst 1110A and the servo stripes 1130 of the B burst 1110B are arranged in an inverted V shape.

The servo sub-frame 2 (1120) is constituted of a C burst 1120C and a D burst 1120D. The D burst 1120D is arranged next to the C burst 1120C. The C burst 1120C includes four servo stripes 1130 formed at specified intervals and tilted at the predetermined angle φ with respect to the tape width direction. In FIG. 51, symbols C1, C2, C3, and C4, are respectively allocated to these four servo stripes 1130 from the EOT toward the BOT of the magnetic tape MT. Similar to the C burst 1120C, the D burst 1120D includes four servo stripes 1130 formed at specified intervals and tilted at the predetermined angle φ with respect to the tape width direction. In FIG. 51, symbols D1, D2, D3, and D4, are respectively allocated to these four servo stripes 1130 from the EOT toward the BOT of the magnetic tape MT. The servo stripes 1130 of the D burst 1120D are tilted in the opposite direction from the servo stripes 1130 of the C burst 1120C. In other words, the servo stripes 1130 of the C burst 1120C and the servo stripes 1130 of the D burst 1120D are arranged in the inverted V shape.

The predetermined angle φ of the servo stripes 1130 in the A burst 1110A, the B burst 1110B, the C burst 1120C, and the D burst 1120D may be, for example, 11° or more and 40° or less, favorably 11° or more and 36° or less, more favorably 11° or more and 25° or less, further more favorably 17° or more and 25° or less.

By reading the servo band by the data write head 60, information for acquiring a tape speed and a position of the data write head 60 in the longitudinal direction can be obtained. The tape speed is calculated from times among four timing signals (A1-C1, A2-C2, A3-C3, A4-C4). A head position is calculated from the times among the four timing signals described above and times among four other timing signals (A1-B1, A2-B2, A3-B3, A4-B4). The servo pattern may be of a shape including two parallel lines.

As shown in FIG. 51, it is favorable for the servo pattern (that is, the plurality of servo stripes 1130) to be arrayed linearly in the longitudinal direction of the magnetic tape MT. In other words, it is favorable for the servo band to have a linear shape in the longitudinal direction of the magnetic tape MT.

Hereinafter, the measurement method of the standard deviation σPES will be described in detail with reference to FIG. 52. First, the data write head 60 is used to reproduce (read) servo patterns in a predetermined servo band provided in the magnetic tape MT. At this time, the servo read portion 62 of the data write head portion 60A and the servo read portion 62 of the data write head portion 60B sequentially oppose each of the servo patterns in the predetermined servo band, and the servo patterns are sequentially reproduced by these two servo read portions 62. At this time, a portion of the servo pattern recorded on the magnetic tape MT that is opposing the servo read portion 62 is read and output as a servo signal.

The value of the PES value of each head portion is calculated for each servo frame as shown in FIG. 51 using the following calculation formula.

$$PES [ μm ] = \frac{X [ μm ] - [ \frac{\begin{matrix}( {B}_{a 1} - {A}_{a 1} ) + ( {B}_{a 2} - {A}_{a 2} ) + ( {B}_{a 3} - {A}_{a 3} ) + ( {B}_{a 4} - {A}_{a 4} ) + \\ ( {D}_{a 1} - {C}_{a 1} ) + ( {D}_{a 2} - {C}_{a 2} ) + ( {D}_{a 3} - {C}_{a 3} ) + ( {D}_{a 4} - {C}_{a 4} )\end{matrix}}{\begin{matrix}( {C}_{a 1} - {A}_{a 1} ) + ( {C}_{a 2} - {A}_{a 2} ) + ( {C}_{a 3} - {A}_{a 3} ) + ( {C}_{a 4} - {A}_{a 4} ) + \\ ( {A}_{a 1}^{′} - {C}_{a 1} ) + ( {A}_{a 2}^{′} - {C}_{a 2} ) + ( {A}_{a 3}^{′} - {C}_{a 3} ) + ( {A}_{a 4}^{′} - {C}_{a 4} )\end{matrix}} ] \times Y [ μm ]}{2 \times tan φ} \qquad [ Math . 4 ]$$

Herein, the center line shown in FIG. 51 is a center line of the servo band. X [μm] is a distance between a servo pattern A1 and a servo pattern B1 on the center line shown in FIG. 51, and Y [μm] is a distance between the servo pattern A1 and a servo pattern C1 on the center line shown in FIG. 51. X and Y are obtained by developing the magnetic tape MT with ferricolloid developer and using a universal tool microscope (TOPCON TUM-220ES) and a data processing apparatus (TOPCON CA-1B). At any position in the tape length direction, 50 servo frames are selected, X and Y are obtained for each of the servo frames, and the 50 pieces of data are simply averaged, to obtain X and Y to be used in the calculation formula described above.

The difference (Bₐ₁−Aₐ₁) indicates a time [sec] on an actual path between the two corresponding servo patterns B1 and A1. Similarly, other terms of differences also indicate the time [sec] on the actual path between two corresponding servo patterns. These times are obtained from the times among timing signals obtained from the waveform of the servo signal and the tape running speed. In the present specification, the actual path refers to an actual running position of the data write head on the servo signal. φ is an azimuth angle. φ is obtained by developing the magnetic tape MT with the ferricolloid developer and using the universal tool microscope (TOPCON TUM-220ES) and the data processing apparatus (TOPCON CA-1B).

In the present technology, the standard deviation σPES of the PES value is calculated using a servo signal obtained by correcting a lateral movement of the tape. Further, the servo signal is subjected to high pass filter processing to reflect trackability of the head. In the present technology, the standard deviation σPES is obtained by using a signal obtained by performing the correction and the high pass filter processing on the servo signal, and is so-called Written in PESσ. The measurement method of the standard deviation σPES of the PES value will be described hereinafter.

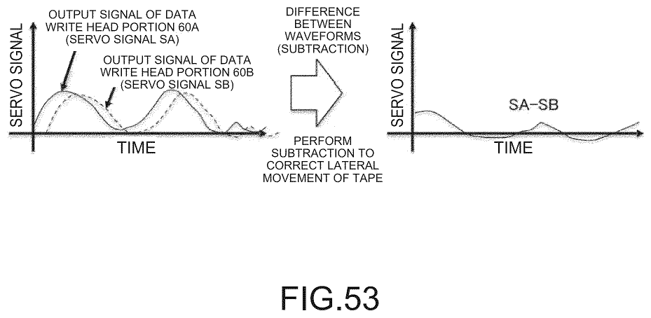

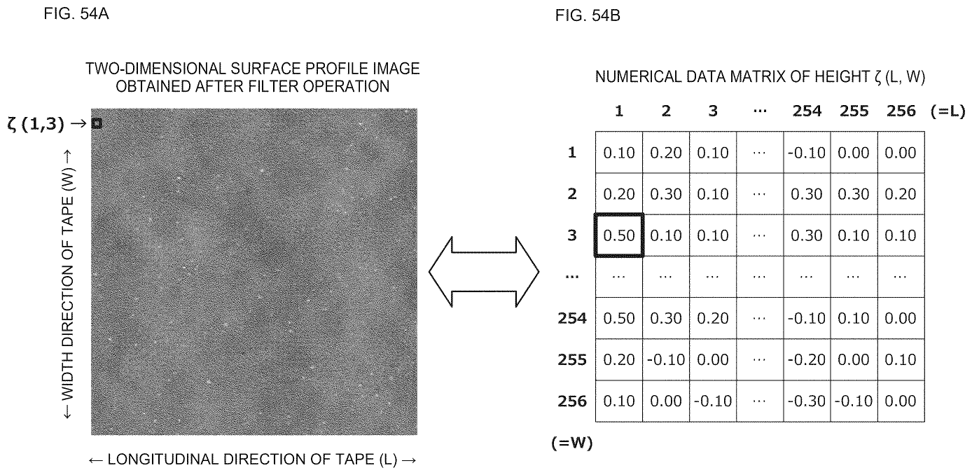

First, the data write head 60 reads servo signals from an arbitrary 1 m range of a data recording area of the magnetic tape MT. The signal acquired by each of the data write head portions 60A and 60B is subtracted as shown in FIG. 53 to obtain a servo signal in which the lateral movement of the magnetic tape MT is corrected. Then, the corrected servo signal is subjected to the high pass filter processing. When actually causing the magnetic tape MT to run by a drive, the data write head mounted on the drive moves in the width direction of the magnetic tape MT by an actuator so as to follow the servo signal. Since Written in PESσ is a noise value obtained after taking into account the trackability of the head in the width direction, the high pass filter processing becomes necessary. Accordingly, although the high pass filter is not limited in particular, there is a need to use a function that can reproduce the trackability of the data write head in the width direction. Using the signal obtained by the high pass filter processing, the PES value is calculated for each servo frame according to the calculation formula described above. The standard deviation of the PES values calculated over the range of 1 m (Written in PESσ) is the standard deviation σPES of the PES values in the present technology.

### [Height Range ΔH, Gradient Range ΔA]

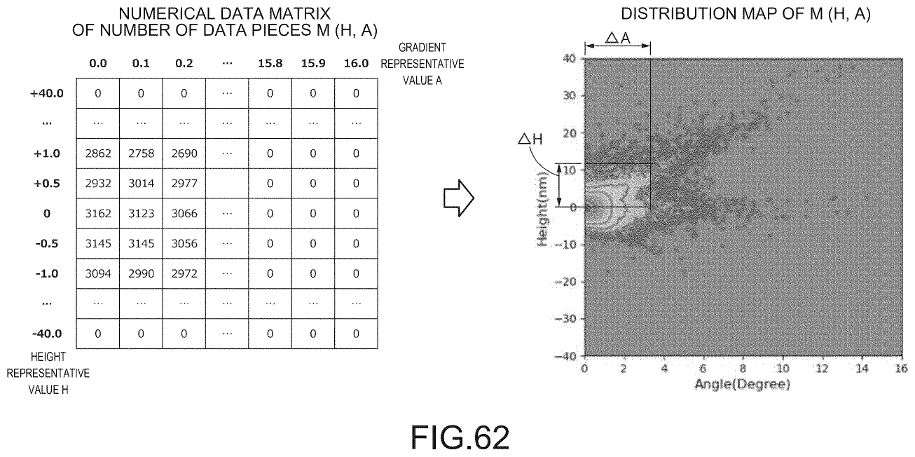

A height range ΔH (see FIG. 62) obtained from statistical information (distribution) of the height of the concavo-convex shape on the magnetic surface satisfies “3.00 nm≤ΔH≤6.00 nm”, favorably “3.00 nm≤ΔH≤4.00 nm”, more favorably “3.00 nm≤ΔH≤3.50 nm”. When the height range ΔH satisfies “ΔH<3.00 nm”, friction is high and the data write head 60 sticks to the magnetic tape MT, thus making it difficult for the magnetic tape MT to run. On the other hand, when the height range ΔH satisfies “6.00 nm<ΔH”, the electromagnetic conversion characteristics (for example, SNR) are lowered due to spacing loss.

A gradient range ΔA (see FIG. 62) obtained from statistical information (distribution) of the gradient of the concavo-convex shape on the magnetic surface satisfies “3.80 degrees≤ΔA≤9.00 degrees”, favorably “4.00 degrees≤ΔA≤9.00 degrees”. When the gradient range ΔA satisfies “ΔA<3.80 degrees”, the gradient of the protrusions (the protrusions including the first protrusions 91B, the second protrusions 92B, and the like) on the magnetic surface becomes too gentle, and the friction increases. Accordingly, the standard deviation σPES of the PES values increases. On the other hand, when the gradient range ΔA satisfies “9.00 degrees<ΔA”, the gradient of the protrusions (the protrusions including the first protrusions 91B, the second protrusions 92B, and the like) on the magnetic surface becomes too steep, and the protrusion portions are scraped off during the running of the magnetic tape MT, to thus cause powder to fall.

The method of calculating the height range ΔH and the gradient range ΔA will be described in the following order.
(A) Surface profile measurement (AFM)
(B) Calculation of relative height at each point
(C) Calculation of gradient at each point
(D) Statistical processing of height and gradient data
(E) Calculation of height range ΔH
(F) Calculation of gradient range ΔA

### (A) Surface Profile Measurement (AFM)

By measuring a two-dimensional surface profile of the magnetic surface of the magnetic tape MT, a numerical data matrix of a height ζ (L, W) is obtained from a two-dimensional surface profile image obtained after a filter operation. It is noted that the measurement conditions are as follows.
Measurement device: AFM (device name: Nanoscope Dimension 3100 manufactured by Digital Instruments)
Measurement range: 10 μm×10 μm
Number of measurement points: 256 points×256 points
Scan rate: 1 Hz
Filter condition: [Flatten] order 2
[Plane Fit] not performed

A of FIG. 54 is a diagram showing an example of the two-dimensional surface profile image obtained after the filter operation. B of FIG. 54 is a diagram showing an example of the numerical data matrix of the height ζ (L, W) at each point (L, W). The coordinate L indicates the coordinate in the longitudinal direction of the magnetic tape MT, and the coordinate W indicates the coordinate in the width direction of the magnetic tape MT. In each cell of the numerical data matrix, the height ζ (L, W) at each point (L, W) is written. In the example shown in B of FIG. 54, for example, the height ζ (1, 3) at the measurement point (1, 3) is “0.50”. The number of pieces of numerical data (that is, heights ζ (L, W)) is 256×256=65,536 in total.

### (B) Calculation of Relative Height at Each Point

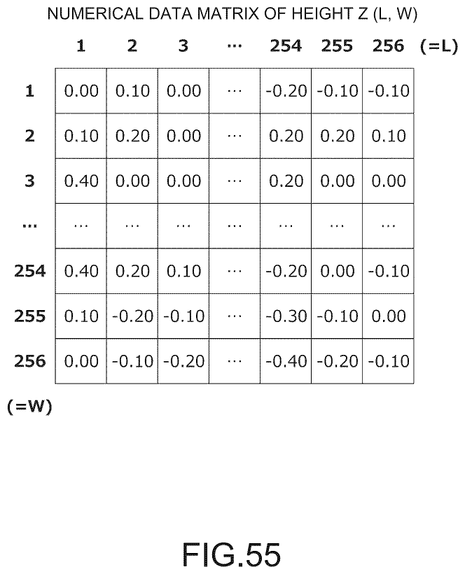

From the numerical data matrix of the heights ζ (L, W), a relative height Z (L, W) (hereinafter, will simply be referred to as “height Z (L, W)”) at each point (L, W) is calculated to obtain a numerical data matrix of the height Z (L, W). Specifically, height Z (L, W) at each point (L, W) is obtained as follows. That is, all of the heights ζ (L, W) are simply averaged (arithmetic average) to obtain an average value, which is set as an average center height ζₐᵥₑ. Then, the height ζ (L, W) at each point (L, W) is converted into a relative height that uses the average center height ζₐᵥₑ as a reference, to obtain the height Z (L, W) at each point (L, W). The calculation method of the height Z (L, W) is expressed as follows. FIG. 55 is a diagram showing an example of the numerical data matrix of the height Z (L, W).

$${ζ}_{ave} = \frac{{\sum }_{W = 1}^{256} {\sum }_{L = 1}^{256} ζ ( L , W )}{256 \times 256} \qquad [ Math . 5 ]$$

$$Z ( L , W ) = ζ ( L , W ) - {ζ}_{ave} \qquad [ Math . 6 ]$$

### (C) Calculation of Gradient at Each Point

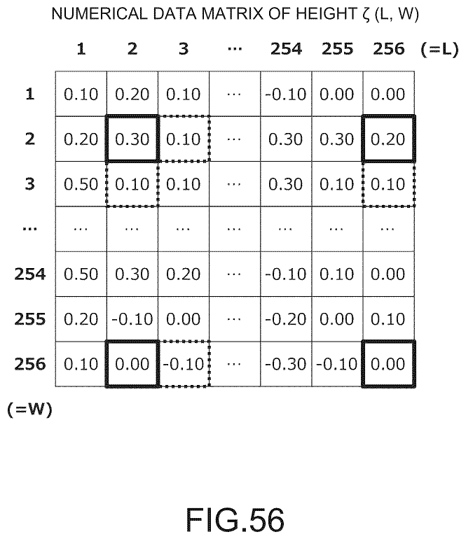

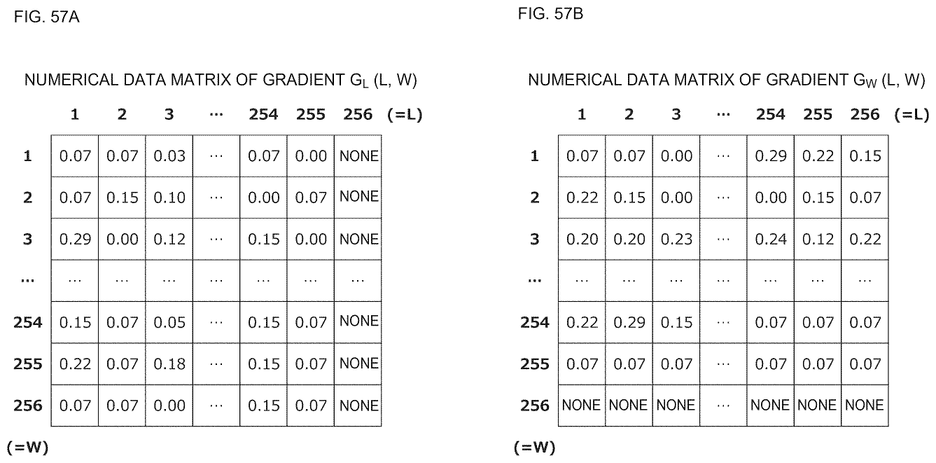

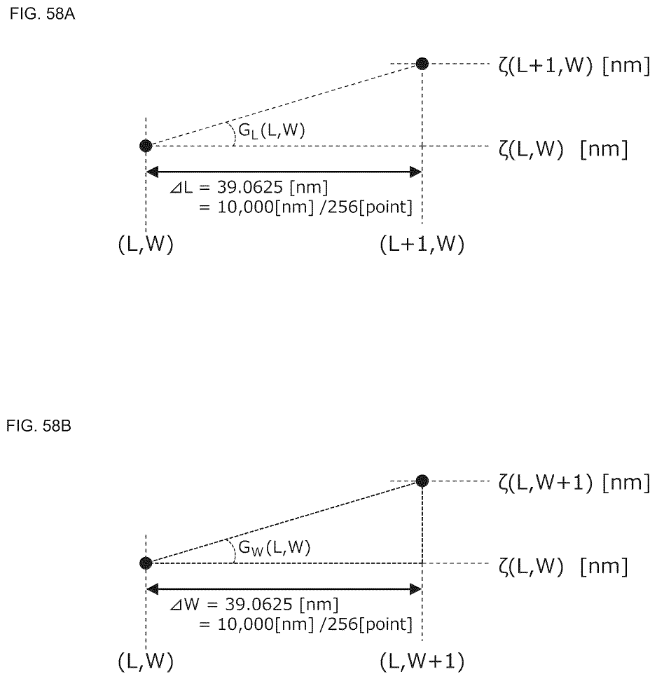

FIG. 56 is a diagram for explaining a method of calculating gradients G_{L} (L, W) and G_{L} (L, W) at each point (L, W). Herein, the gradient G_{L} (L, W) indicates the gradient in the longitudinal direction of the magnetic tape MT, and the gradient G_{W} (L, W) indicates the gradient in the width direction of the magnetic tape MT.

By calculating the gradients G_{L} (L, W) and G_{W} (L, W) at each point (L, W) in the two directions from the numerical data matrix of the height ζ (L, W), the numerical data matrix of each of the gradients G_{L} (L, W) and G_{W} (L, W) is obtained. A of FIG. 57 is a diagram showing an example of the numerical data matrix of the gradient G_{L} (L, W). B of FIG. 57 is a diagram showing an example of the numerical data matrix of the gradient G_{W} (L, W).

The gradient G_{L} (L, W) is calculated as follows. The gradient G (L, W) is calculated using a height ζL, W) at a certain point (L, W) and a height ζ (L+1, W) at a point (L+1, W) adjacent to that point (L, W) in the longitudinal direction of the magnetic tape MT. As shown in FIG. 56, for example, a gradient G_{L} (2, 2) is calculated using a height ζ (2, 2) (=0.30) at a point (2, 2) and a height ζ (3, 2) (=0.10) at a point (3, 2).

The gradient G_{W} (L, W) is calculated as follows. The gradient G_{W} (L, W) is calculated using a height ζ (L, W) at a certain point (L, W) and a height ζ (L, W+1) at a point (L, W+1) adjacent to that point (L, W) in the width direction of the magnetic tape MT. As shown in FIG. 56, for example, a gradient G_{W} (2, 2) is calculated using the height ζ (2, 2) (=0.30) at the point (2, 2) and a height ζ (2, 3) (=0.10) at a point (2, 3).

As described above, the “adjacent point” used in calculating G_{L} (L, W) at each point (L, W) is the point (L+1, W). The adjacent point in the opposite direction, that is, the point (L−1, W), should not be used. Similarly, the “adjacent point” used in calculating G_{W} (L, W) at each point (L, W) is the point (L, W+1). The adjacent point in the opposite direction, that is, the point (L, W−1), should not be used.

As shown in FIG. 56, the gradient G_{L} (256, W) cannot be calculated at each point (256, W) of L=256 (that is, the rightmost column in FIG. 56) in the numerical data matrix. Therefore, as shown in A of FIG. 57, in the numerical data matrix of the gradient G_{L} (L, W), each point (256, W) of L=256 has no value. Meanwhile, as shown in FIG. 56, the gradient G_{W} (L, 256) cannot be calculated at each point (L, 256) of W=256 (that is, the bottom row in FIG. 56) in the numerical data matrix. Therefore, as shown in B of FIG. 57, in the numerical data matrix of the gradient G_{W} (L, W), each point (L, 256) of W=256 has no value.

However, as shown in FIG. 56, at the point (L, W) of L=256, W=256 (rightmost column and bottom row) in the numerical data matrix, neither the gradient G_{L} (256, 256) nor the gradient G_{W} (256, 256) can be calculated, so the point (256, 256) has neither the gradient G_{L} (256, 256) nor the gradient G_{W} (256, 256).

A of FIG. 58 is a diagram showing the method of calculating the gradient G_{L} (L, W). B of FIG. 58 is a diagram showing the method of calculating the gradient G_{W} (L, W). When expressed by calculation formulae, the calculation methods for the gradients G_{L} (L, W) and G_{W} (L, W) are as follows.

$${G}_{L} ( L , W ) [ ° ] = {tan}^{- 1} ( \frac{\vert ζ ( L + 1 , W ) - ζ ( L , W ) \vert}{39.0625} ) \qquad [ Math . 7 ]$$

$${G}_{W} ( L , W ) [ ° ] = {tan}^{- 1} ( \frac{\vert ζ ( L , W + 1 ) - ζ ( L , W ) \vert}{39.0625} ) \qquad [ Math . 8 ]$$

### (D) Statistical Processing of Height and Gradient Data

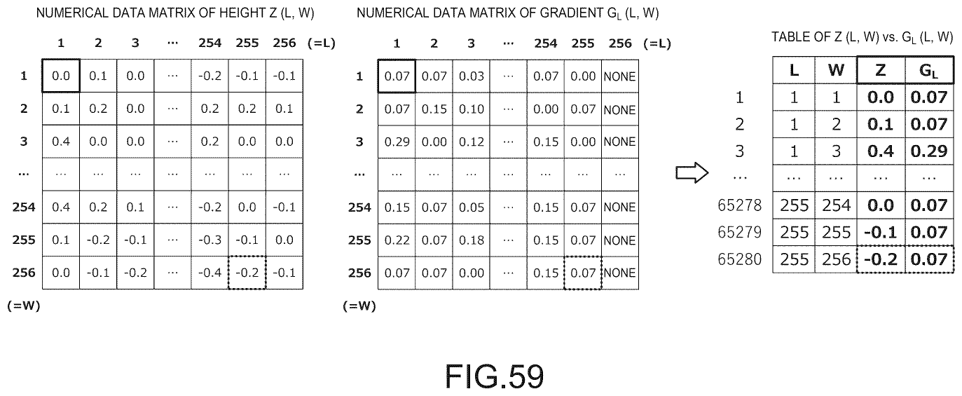

FIGS. 59, 60, and 61 are diagrams for explaining the statistical processing of data on the height Z (L, W), the gradient G_{L} (L, W), and the gradient G_{W} (L, W). The numerical data matrices of the height Z (L, W) and the gradient G_{L} (L, W) obtained as described above are organized, and a table showing a relationship between the height Z (L, W) and the gradient G_{L} (L, W) (see FIG. 59) is created. However, since the gradient G_{L}(256, W) does not exist, the total number of pieces of data in the created table is 255×256=65,280.

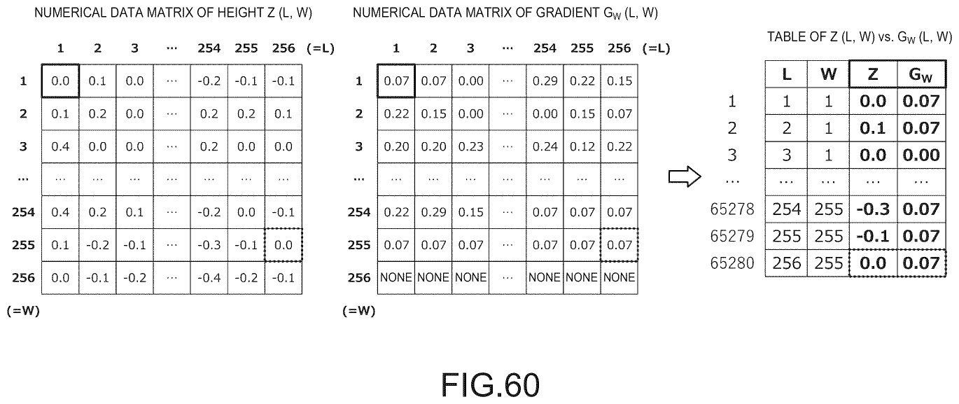

Further, the numerical data matrices of the height Z (L, W) and the gradient G_{W} (L, W) are organized, and a table showing a relationship between the height Z (L, W) and the gradient G_{W} (L, W) (see FIG. 60) is created. However, since the gradient G_{W} (L, 256) does not exist, the total number of pieces of data in the created table is 256×255=65,280.

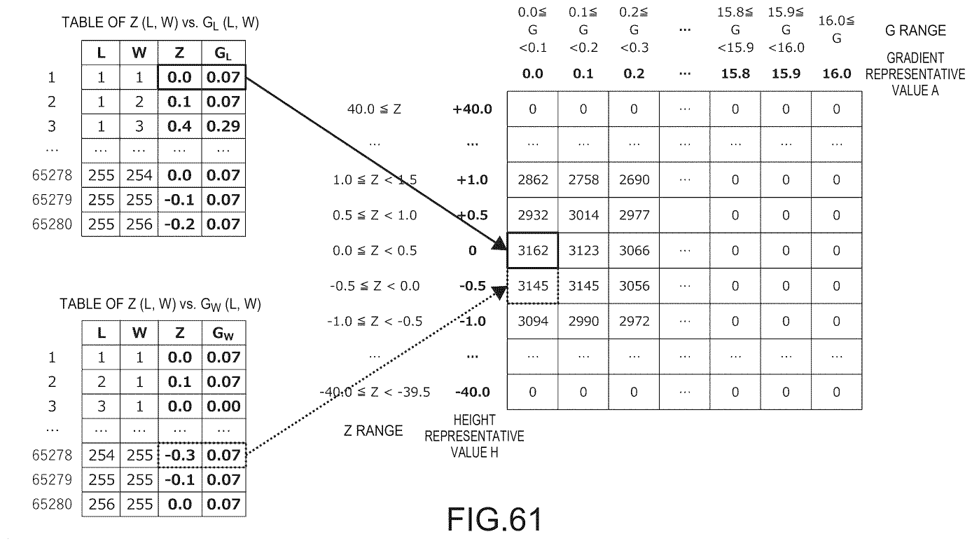

All pieces of data in the created two tables (that is, 130,560 pieces=65,280+65,280) are aggregated, to create a numerical data matrix of the number of data pieces M (H, A) as shown in FIG. 61. When all the numerical values of the respective cells in the numerical data matrix of the number of data pieces M (H, A) are added, the total number of data pieces becomes 130,560.

In FIG. 61, the range of the height Z (L, W) and a representative value H thereof are listed alongside the columns of the numerical data matrix of the number of data pieces M (H, A). In addition, the range of the gradient G (L, W) and a representative value A thereof are listed alongside the rows of the numerical data matrix of the number of data pieces M (H, A). It is noted that when not distinguishing the gradient G_{L} (L, W) and the gradient G_{W} (L, W) from each other in particular, the gradient G_{L} (L, W) and the gradient G_{W} (L, W) are collectively referred to as gradient G (L, W).

The numerical value of each cell in the numerical data matrix of the number of data pieces M (H, A) (see FIG. 61) represents the number of data pieces M (H, A) that corresponds to a specified range of the height Z (L, W) and also corresponds to a specified range of the gradient G (L, W) (specifically, the gradient G (L, W) or the gradient G_{W} (L, W)). For example, data in the first row in the table of Z (L, W) vs. G_{L} (L, W) is counted in the (H, A)=(0.0, 0.00) cell in M (H, A). Further, 65278-th data in the table of Z (L, W) vs. G_{W} (L, W) is counted in the (H, A)=(−0.5, 0.00) cell in M (H, A).

When the numerical data matrix M (H, A) (see FIG. 61) obtained as described above is drawn as a distribution map with an abscissa axis A and an ordinate axis H, the distribution map as shown in FIG. 62 is obtained.

### (E) Calculation of Height Range ΔH

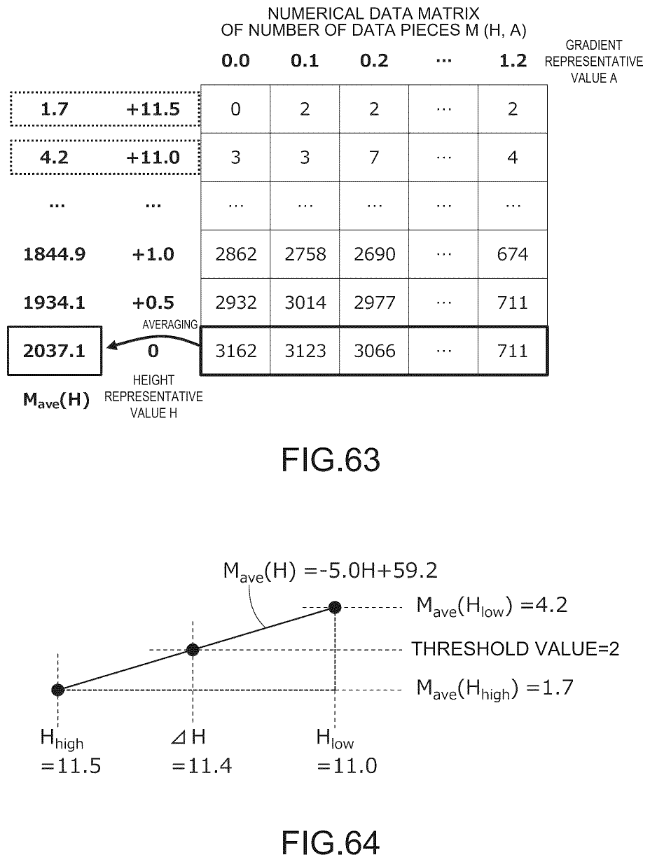

FIGS. 63 and 64 are diagrams for explaining the method of calculating the height range ΔH. When calculating the height range ΔH, only components (cells) within the ranges of 0≤H, 0.00≤A≤1.20 are used out of the numerical data matrix of the number of data pieces M (H, A). The reason why only the components within the range of 0≤H are used regarding the height H is because only the convex portions of the magnetic surface are taken into account. In other words, it is considered that the concave portions of the magnetic surface do not affect the electromagnetic conversion characteristics or friction. Meanwhile, the reason why only the components within the range of 0.00≤A≤1.20 are used regarding the gradient A is because it is considered that using only this range for the calculation is sufficient for defining a rough outline of the distribution (see FIG. 62).

As shown in FIG. 63, an average value in each row (height H) of the numerical data matrix of the number of data pieces M (H, A) is set as Mₐᵥₑ (H), and calculations are sequentially performed from the average value Mₐᵥₑ (0) to the average value Mₐᵥₑ (40.0). It is noted that in calculating the average value Mₐᵥₑ (H), only components of columns (angle A) within the range of 0.00≤A≤1.20 are used.

The height H when the average value Mₐᵥₑ (H) falls below a threshold value (provided that the threshold value is set to “2”) for the first time is set as a height H_{high}, and the average value Mₐᵥₑ (H) at that time is set as the average value Mₐᵥₑ (H_{high}). In addition, the height H immediately before that is set as a height H_{low}, and the average value Mₐᵥₑ (H) at that time is set as the average value Mₐᵥₑ (H_{low}). Setting the threshold value to “1” results in poor reproducibility. In other words, an element of chance has a large effect. Therefore, the threshold value is set to “2”, which is the lowest frequency at which the reproducibility can be secured.

In the example of FIG. 63, the height H_{high}, the average value Mₐᵥₑ (H_{high}), the height H_{low}, and the average value Mₐᵥₑ (H_{low}) are as follows.
H_{high}=11.5, Mₐᵥₑ (H_{high})=1.9
H_{low}=11.0, Mₐᵥₑ (H_{low})=4.2

As shown in FIG. 64, using the four values described above, the height H obtained when Mₐᵥₑ (H)=threshold value=2 is calculated and defined as the height range ΔH. It is noted that when calculating the height H, a two-point linear approximation is used.

### (F) Calculation of Gradient Range ΔA

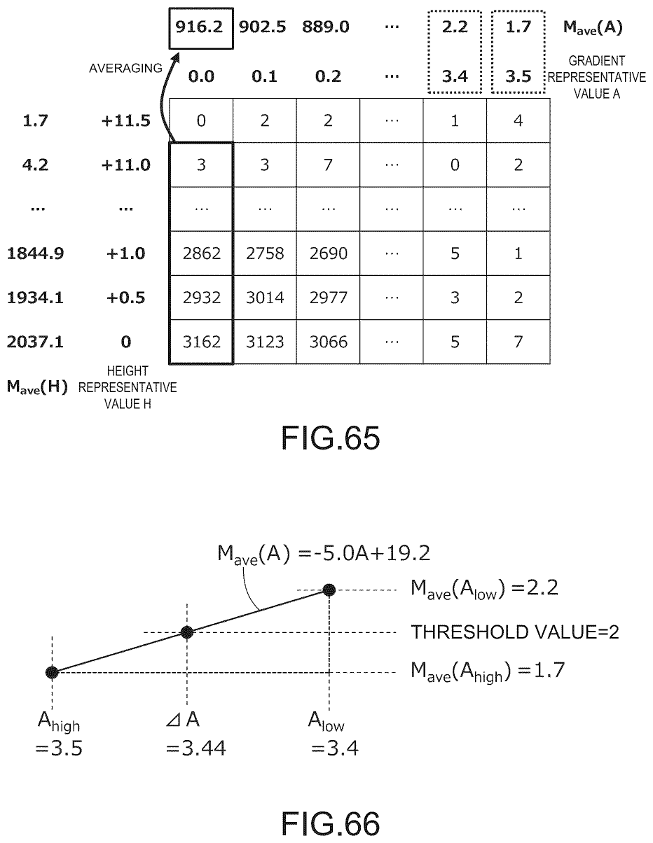

FIGS. 65 and 66 are diagrams for explaining the method of calculating the gradient range ΔA. When calculating the gradient range ΔA, only components (cells) within the ranges of 0≤H≤ΔH, 0.00≤A≤16.00 are used out of the numerical data matrix of the number of data pieces M (H, A). A value obtained in “(5) Calculation of height range ΔH” described above is used for ΔH. The reason why only the components within the range of 0.00≤A≤16.00 are used regarding the gradient A is because the gradient A usually satisfies “0.00≤A≤16.00”, and it is considered that using only this range for the calculation is sufficient.

As shown in FIG. 65, an average value of M (H, A) in each column (angle A) of the numerical data matrix of the number of data pieces M (H, A) is set as Mₐᵥₑ (A), and calculations are sequentially performed from the average value Mₐᵥₑ (0) to the average value Mₐᵥₑ (16.00). It is noted that in calculating the average value Mₐᵥₑ (A), only components of rows (height H) within the range of 0.00≤H≤ΔH (height H) are used regarding the rows (height H).

When the height range ΔH is not a multiple of 0.5, the average value Mₐᵥₑ (A) is calculated using the components of the rows (height H) within the range up to the height H_{low} that have been used in calculating the height range ΔH. For example, as shown in FIG. 65, in a case where the height range ΔH exists between 11.0 and 11.5, the components of the rows (height H) within the range of 0.00≤H≤11.0 are used.

The angle A when the average value Mₐᵥₑ (A) falls below a threshold value (provided that the threshold value is set to “2”) for the first time is set as A_{high}, and the average value Mₐᵥₑ(A) at that time is set as the average value Mₐᵥₑ (A_{high}). In addition, the angle A immediately before that is set as an angle A_{low}, and the average value Mₐᵥₑ (A) at that time is set as the average value Mₐᵥₑ (A_{low}). The reason for setting the threshold value of the average value Mₐᵥₑ (A) to “2” is similar to the reason for setting the threshold value of the average value Mₐᵥₑ (H) to “2”.

In the example of FIG. 65, A_{high}, Mₐᵥₑ (A_{high}), A_{low}, and Mₐᵥₑ (A_{low}) are as follows.
A_{high}=3.5, Mₐᵥₑ (A_{high})=1.9
A_{low}=3.4, Mₐᵥₑ (A_{low})=2.2

As shown in FIG. 66, using the four values described above, the angle A obtained when Mₐᵥₑ (A)=threshold value=2 is calculated and defined as the gradient range ΔA. It is noted that when calculating the angle A, a two-point linear approximation is used.

### (3) Manufacturing Method of Magnetic Tape

Next, a manufacturing method of the magnetic tape MT having the configuration described above will be described. First, non-magnetic powder, a binding agent, and the like are kneaded and/or dispersed in a solvent, to prepare a coating material for forming an underlayer. Next, non-magnetic powder, a binding agent, and the like are kneaded and/or dispersed in a solvent, to prepare a coating material for forming a magnetic layer. For example, the following solvents, dispersion devices, and kneading devices can be used to prepare the coating material for forming a magnetic layer and the coating material for forming an underlayer.

Examples of the solvent used for the coating material preparation described above include: ketone-based solvents such as acetone, methyl ethyl ketone, methyl isobutyl ketone, and cyclohexanone; alcohol-based solvents such as methanol, ethanol, and propanol; ester-based solvents such as methyl acetate, ethyl acetate, butyl acetate, propyl acetate, ethyl lactate, and ethylene glycol acetate; ether-based solvents such as diethylene glycol dimethyl ether, 2-ethoxyethanol, tetrahydrofuran, and dioxane; aromatic hydrocarbon-based solvents such as benzene, toluene, and xylene; halogenated hydrocarbon-based solvents such as methylene chloride, ethylene chloride, carbon tetrachloride, chloroform, and chlorobenzene; and the like. One of these may be used, or a mixture of two or more may be used.

As the kneading device used for the coating material preparation described above, for example, kneading devices such as a continuous twin screw kneader, a continuous twin screw kneader capable of diluting in multiple stages, a kneader, a pressure kneader, and a roll kneader can be used, though not limited to these devices in particular. Further, as the dispersion device used for the coating material preparation described above, for example, dispersion devices such as a roll mill, a ball mill, a horizontal sand mill, a vertical sand mill, a spike mill, a pin mill, a tower mill, a pearl mill (for example, “DCP mill” manufactured by Nippon Eirich Co., Ltd., or the like), a homogenizer, and an ultrasonic disperser can be used, though not limited to these devices in particular.

Next, the coating material for forming an underlayer is applied onto one of the main surfaces of the base layer 41 and dried so as to form a non-magnetic layer (hereinafter, will also be referred to as underlayer) 42. Subsequently, the coating material for forming a magnetic layer is applied onto this underlayer 42 and dried so that the magnetic layer 43 is formed on the underlayer 42. It is noted that when drying, a magnetic field of the magnetic powder is oriented in a thickness direction of the base layer 41 by a solenoid coil, for example. Alternatively, when drying, the magnetic field of the magnetic powder may be oriented in the longitudinal direction (running direction) of the base layer 41 by the solenoid coil, for example, and then oriented in the thickness direction of the base layer 41. After forming the magnetic layer 43, the back layer 44 is formed on the other one of the main surfaces of the base layer 41. Thus, the magnetic tape MT is obtained.

After that, the obtained magnetic tape MT is rewound on a large diameter core and subjected to curing processing. Finally, the magnetic tape MT is subjected to calender processing and is then cut to a predetermined width (for example, width of ½ inch). Thus, a desired elongated strip-like magnetic recording tape MT is obtained.

### (4) Descriptions on Data Band and Servo Band of Magnetic Tape

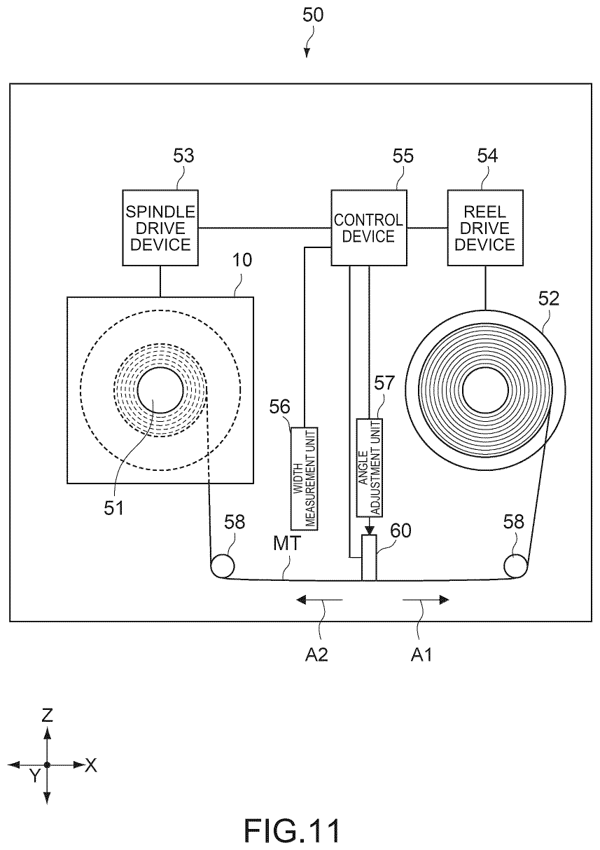

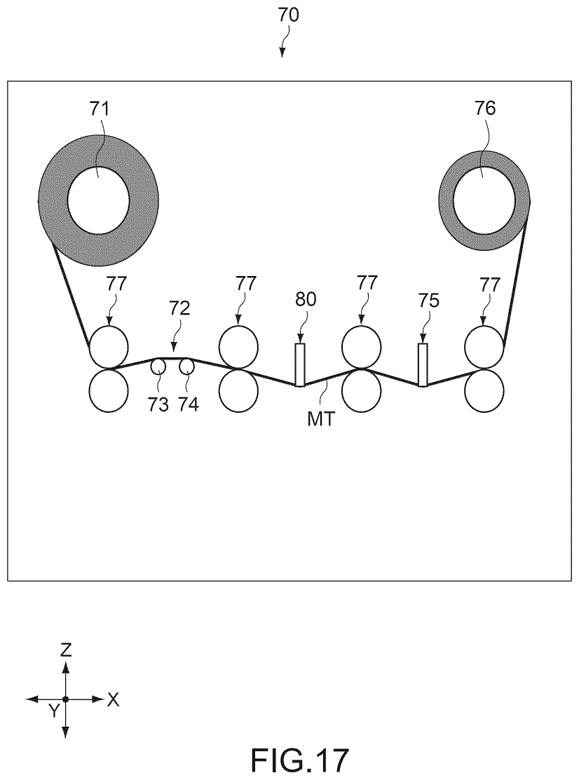

In the magnetic tape MT, a servo recording/reproducing device 70 (servo recording device) (see FIG. 17) is configured to write, in a servo band s of the magnetic tape MT (see FIG. 10), servo patterns 47 that can be accurately read by the data write head 60 of the data recording/reproducing device 50 (data recording device) (see FIG. 11).

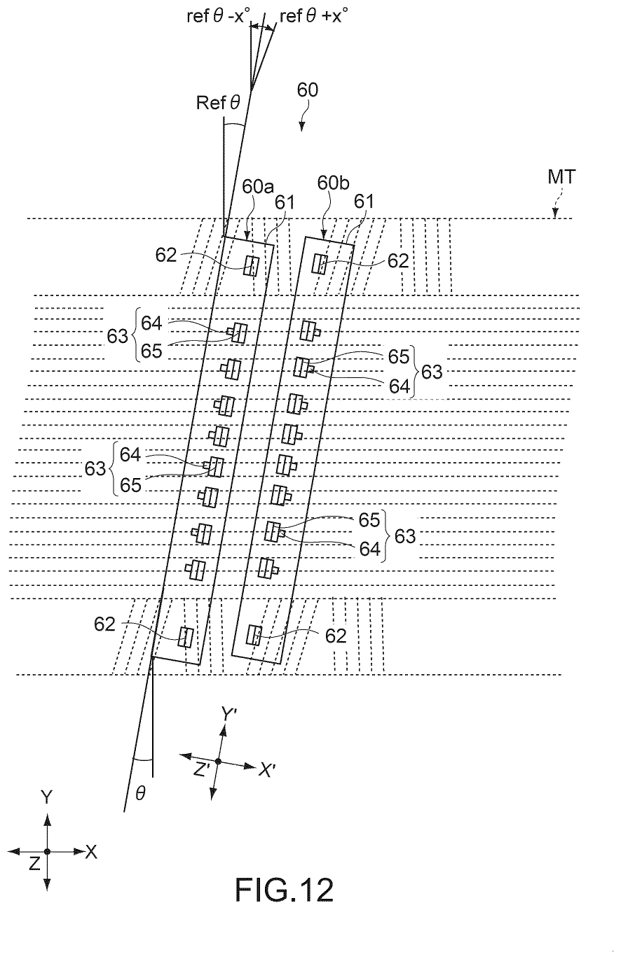

The data write head 60 of the data recording/reproducing device 50 is arranged to be tilted with respect to the width direction of the magnetic tape MT (see FIG. 12). Therefore, in the present embodiment, first servo patterns 47a (“/”) and second servo patterns 47b (“\”) that are asymmetric with respect to the width direction of the magnetic tape are written in the servo band s (see FIG. 10).

Hereinafter, a configuration of the data recording/reproducing device 50 and a configuration of the servo recording/reproducing device 70 will be described in the stated order.

### [General Outline of Data Band and Servo Band]

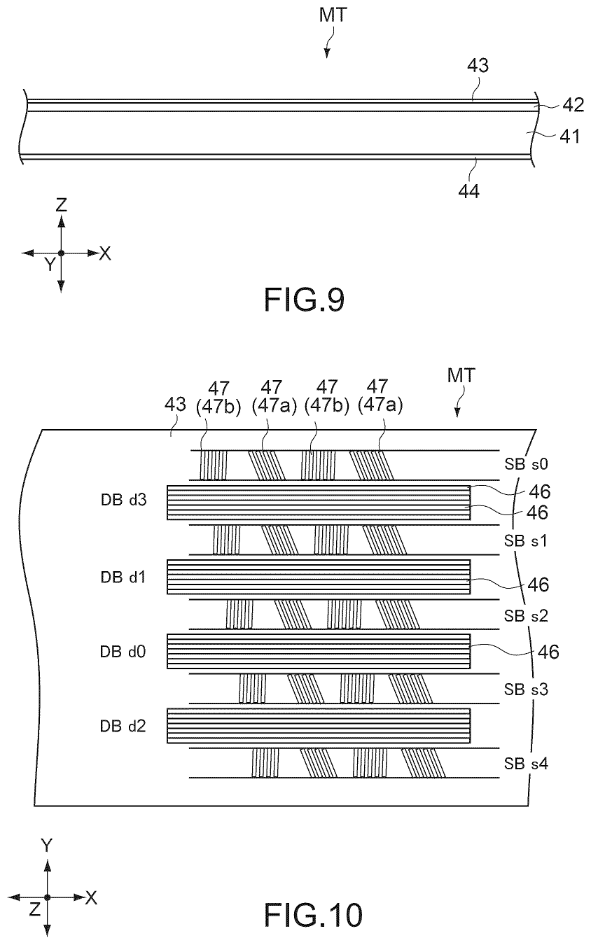

FIG. 9 is a schematic diagram in which the magnetic tape MT is seen from the side. FIG. 10 is a schematic diagram in which the magnetic tape MT is seen from above (magnetic layer 43 side). As shown in FIGS. 9 and 10, the magnetic tape MT is formed in a tape-like shape that is elongated in the longitudinal direction (X axis direction), is short in the width direction (Y axis direction), and is thin in the thickness direction (Z axis direction).

As shown in FIG. 10, the magnetic layer 43 includes a plurality of data bands d (data bands d0 to d3) in which data is written and a plurality of servo bands s (servo bands s0 to s4) in which the servo patterns 47 are written. Data bands d of the plurality of data bands d and servo bands s of the plurality of servo bands s each have a shape that is long in the longitudinal direction (X axis direction) and short in the width direction (Y axis direction). In the width direction (Y axis direction), the servo bands s are arranged at positions between which each data band d is situated.

FIG. 10 shows an example where the number of data bands d is four, and the number of servo bands s is five. It is noted that the number of data bands d and the number of servo bands s are 5+4n (provided that n is an integer of 0 or more) or more, favorably 5 or more, more favorably 9 or more. When the number of servo bands s is 5 or more, it is possible to suppress an effect of a dimensional change of the magnetic tape MT in the width direction on the servo signals, and secure stable recording/reproducing characteristics with less off-tracks. An upper limit value of the number of servo bands SB is not limited in particular and is, for example, 33 or less.

From the viewpoint of securing a high recording capacity, an upper limit value of an average value of a servo band width is favorably 98 μm or less, more favorably 60 μm or less, further more favorably 30 μm or less. A lower limit value of the average value of the servo band width WSB is favorably 10 μm or more. It is difficult to manufacture a head unit 56 capable of reading a servo signal with a servo band width smaller than 10 μm.

A ratio of an area of the servo bands s to a total surface area of the magnetic layer 43 is, for example, 4.0% or less. It is noted that the width of the servo band s is, for example, 96 μm or less for a tape width of ½ inch. The ratio of the area of the servo bands s to the total surface area of the magnetic layer 43 can be measured, for example, by developing the magnetic tape MT with developer such as ferricolloid developer, and then observing the developed magnetic tape MT using an optical microscope.

The data band d includes a plurality of recording tracks 46 elongated in the longitudinal direction and aligned in the width direction. The number of recording tracks 46 included in one data band d is, for example, about 1000 to 2500. Data is recorded in the recording tracks 46 along the recording tracks 46. A 1-bit length of data recorded in the data band d in the longitudinal direction is, for example, 48 nm or less.

A width of the recording track 46 (track pitch: Y axis direction) is, for example, 2.0 μm or less. It is noted that such a recording track width can be measured, for example, by developing the magnetic layer 43 of the magnetic tape MT with developer such as ferricolloid developer, and then observing the developed magnetic layer 43 of the magnetic tape MT using an optical microscope.

Alternatively, a method that uses the data write head 60 (see FIG. 12 to be described later) may be used as the measurement method of the recording track width. In this case, in order to ignore variations during the running of the magnetic tape MT, the recording track width can be measured from a change in output when the azimuth angle θ of the data write head 60 is changed in a state where the data write head 60 is set in the recording and reproducing state. (IEEE_Sept1996_Crosstrack Profiles of Thin Film MR Tape Heads Using the Azimuth Displacement Method)

The servo band s includes the servo patterns 47 of a predetermined shape that are recorded by the servo recording/reproducing device 70 (see FIG. 17) to be described later. The servo patterns 47 include the first servo patterns 47a (“/”) and the second servo patterns 47b (“\”).

It is noted that in the present specification, the symbols “/” and “\” in the first servo patterns 47a and the second servo patterns 47b are used as symbols that each indicate a tilt direction of the servo patterns when the magnetic tape MT is seen from below (back layer side). Therefore, the signs “/” and “\” in the first servo patterns 47a and the second servo patterns 47b are opposite to those when viewed from the magnetic layer side in FIG. 10. Meanwhile, FIGS. 18 to 26 and the like to be described later each show a state where a first servo element 82a (“/”) that writes the first servo pattern 47a (“/”), a second servo element 82b (“\”) that writes the second servo pattern 47b (“\”), and the servo patterns 47a and 47b recorded on the magnetic layer by the servo elements 82a and 82b are seen from the back layer side on a head sliding surface.

In the present embodiment, the first servo pattern 47a (“/”) and the second servo pattern 47b (“\”) are written in the servo band s so as to be asymmetric with respect to the width direction of the magnetic tape MT (Y axis direction). It is noted that in a case of a general servo pattern, the first servo pattern 47a (“/”) and the second servo pattern 47b (“\”) are written in the servo band s so as to be symmetric (line symmetric) with respect to the width direction of the magnetic tape MT.

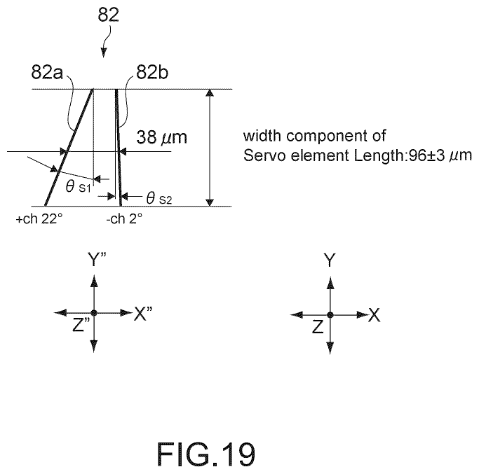

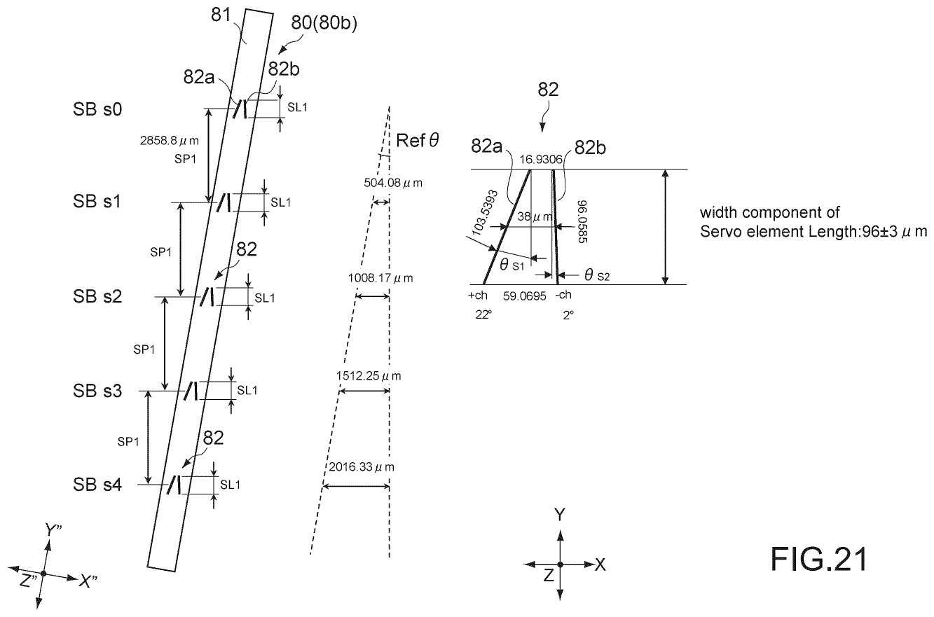

The first servo pattern 47a (“/”) is tilted at a first angle θs1 with respect to the width direction of the magnetic tape MT, and the second servo pattern 47b (“\”) is tilted at a second angle θs2 in an orientation opposite to the first angle θs1 with respect to the width direction of the magnetic tape MT, the second angle θs2 being different from the first angle θs1 (see FIGS. 19 and 21 to be described later).

A group of first servo patterns 47a (“/”) and a group of second servo patterns 47b (“\”) are alternately arranged in the longitudinal direction of the magnetic tape MT. The number of first servo patterns 47a (“/”) included in the group of first servo patterns 47a (“/”) is typically four or five, and similarly, the number of second servo patterns 47b (“\”) included in the group of second servo patterns 47b (“\”) is typically four or five.

The shape of the servo pattern 47 can be measured, for example, by developing the magnetic layer 43 of the magnetic tape MT using developer such as ferricolloid developer, and then observing the developed magnetic layer 43 of the magnetic tape MT with an optical microscope.

It is noted that details of the first servo pattern 47a (“/”) and the second servo pattern 47b (“\”) will be described in a section for explaining a servo write head 80 of the servo recording/reproducing device 70 that writes the servo pattern 47.

Herein, in the magnetic tape MT conforming to the LTO standard, the number of recording tracks 46 has increased with each generation, and the recording capacity has improved dramatically. For example, while the number of recording tracks 46 has been 384 in the first generation LTO-1, the numbers of recording tracks 46 are 512, 704, 896, 1280, 2176, 3584, 6656, and 8960, respectively, in LTO-2 to LTO-9. Similarly, while the data recording capacity has been 100 GB (gigabytes) in LTO-1, the recording capacities are 200 GB, 400 GB, 800 GB, 1.5 TB (terabytes), 2.5 TB, 6.0 TB, 12 TB, and 18 TB, respectively, in LTO-2 to LTO-9.

In the present embodiment, the number of recording tracks 46 and the recording capacity are not limited in particular and can be changed as appropriate. It is noted that, for example, it is advantageous to apply the present technology to a magnetic tape MT that has a large number of recording tracks 46 and a large recording capacity (for example, 6656 tracks or more, 12 TB or more: LTO8 and subsequent generations) and is susceptible to the effect of variations in the width of the magnetic tape MT.

### [Data Recording/Reproducing Device]

FIG. 11 is a diagram showing the data recording/reproducing device 50. The data recording/reproducing device 50 is capable of recording data on the magnetic tape MT, and is also capable of reproducing data recorded on the magnetic tape MT.

The data recording/reproducing device 50 is configured to be capable of loading the magnetic recording cartridge 10 therein. The magnetic recording cartridge 10 is configured to be capable of rotatably accommodating a wound magnetic tape MT therein. The data recording/reproducing device 50 may be configured to be capable of loading one magnetic recording cartridge 10, or may be configured to be capable of loading a plurality of magnetic recording cartridges 10 at the same time.

The data recording/reproducing device 50 includes a spindle 51, a take-up reel 52, a spindle drive device 53, a reel drive device 54, the data write head 60, a control device 55, a width measurement unit 56, an angle adjustment unit 57, and a plurality of guide rollers 58.

The spindle 51 is configured to be capable of causing the magnetic tape MT accommodated inside the magnetic recording cartridge 10 to rotate by its rotation. The spindle drive device 53 causes the spindle 51 to rotate in response to a command from the control device 55.

The take-up reel 52 is configured to be capable of fixing a tip end of the magnetic tape MT drawn out from the magnetic recording cartridge 10 via a tape loading mechanism (not shown). The reel drive device 54 causes the take-up reel 52 to rotate in response to a command from the control device 55.

The plurality of guide rollers 58 guides the running of the magnetic tape MT so that a conveying path formed between the magnetic recording cartridge 10 and the take-up reel 52 has a predetermined relative positional relationship with the data write head 60.

The data write head 60 is configured to be capable of recording data onto the data band d (recording tracks 46) of the magnetic tape MT in response to a command from the control device 55 when the magnetic tape MT passes below the data write head 60, and is also configured to be capable of reproducing the recorded data.

When data is recorded/reproduced onto/from the magnetic tape MT by the data write head 60, the spindle 51 and the take-up reel 52 are rotated by the spindle drive device 53 and the reel drive device 54, and thus the magnetic tape MT runs. Regarding the running direction of the magnetic tape MT, the magnetic tape MT is capable of reciprocating in a forward direction indicated by the arrow A1 in FIG. 11 (a winding direction from the spindle 51 side to the take-up reel 52 side) and a reverse direction indicated by the arrow A2 (a rewinding direction from the take-up reel 52 side to the spindle 51 side).

The data write head 60 is capable of recording/reproducing data in both directions of running of the magnetic tape MT in the forward direction and running in the reverse direction.

Particularly in the present embodiment, the data write head 60 is arranged such that the longitudinal direction of the data write head 60 (Y′ axis direction) is tilted at a predetermined angle θ (first head azimuth angle θ) with respect to the width direction of the magnetic tape MT (Y axis direction) (see FIG. 12 to be described later).

In the description of the present embodiment, the angle at which the longitudinal direction of the data write head 60 (Y′ axis direction) is tilted with respect to the width direction of the magnetic tape MT (Y axis direction) is referred to as the azimuth angle θ of the data write head 60. It is noted that details of the configuration of the data write head 60 will be described later with reference to FIG. 12 and the like.

The width measurement unit 56 is configured to be capable of measuring the width of the magnetic tape MT when the magnetic tape MT passes below the width measurement unit 56. In other words, the width measurement unit 56 is configured to be capable of measuring the width of the magnetic tape MT when the data write head 60 records/reproduces data onto/from the magnetic tape MT. The width measurement unit 56 measures the width of the magnetic tape MT and transmits it to the control device 55.

The width measurement unit 56 is constituted of various sensors such as an optical sensor, for example. Any sensor may be used for the width measurement unit 56 as long as it is capable of measuring the width of the magnetic tape MT. It is noted that it is also possible to predict the width of the magnetic tape MT by reading adjacent servo patterns 47 and obtaining a difference between position signals. In this case, the width measurement unit 56 can be omitted.

The angle adjustment unit 57 is configured to be capable of retaining the data write head 60 such that the data write head 60 is capable of rotating about an axis in the vertical direction (Z axis). The angle adjustment unit 57 is configured to be capable of adjusting the azimuth angle θ of the data write head 60 in response to a command from the control device 55.

The control device 55 includes, for example, a control unit, a storage unit, a communication unit, and the like. The control unit is constituted of, for example, a CPU (Central Processing Unit) and the like, and collectively controls the respective units of the data recording/reproducing device 50 in accordance with programs stored in the storage unit.

The storage unit includes a nonvolatile memory in which various types of data and various programs are recorded and a volatile memory used as a working area of the control unit. The various programs may be read from a portable recording medium such as an optical disk and a semiconductor memory, or may be downloaded from a server device on a network. The communication unit is configured to be capable of communicating with other devices such as a PC (Personal Computer) and a server device.

In particular, in the present embodiment, the control device 55 (control unit) acquires information on the width of the magnetic tape MT from the width measurement unit 56 (or predicts the width of the magnetic tape from the servo signal), and adjusts the azimuth angle θ of the data write head 60 (see FIG. 12) by the angle adjustment unit 57 based on the information on the width of the magnetic tape MT.

In the present embodiment, the azimuth angle θ of the data write head 60 is adjusted to cope with the variation in the width of the magnetic tape MT. Typically, the azimuth angle θ of the data write head 60 is set to be small when the width of the magnetic tape MT becomes relatively wide, and conversely, the azimuth angle θ of the data write head 60 is set to be large when the width of the magnetic tape MT becomes relatively narrow.

The width of the magnetic tape MT may vary due to various reasons such as a temperature, a humidity, and a tension applied to the magnetic tape MT in the longitudinal direction.

### [Data Write Head]

Next, the configuration of the data write head 60 will be described in detail. FIG. 12 is a schematic diagram in which the data write head 60 as seen from below (back layer side).

In the description on the data write head 60, the longitudinal direction of the data write head 60 is defined as the Y′ axis direction, the width direction of the data write head 60 is defined as the X′ axis direction, and the up-down direction of the data write head 60 is defined as the Z′ axis direction. The longitudinal direction (running direction) of the magnetic tape MT is defined as the X axis direction, the width direction of the magnetic tape MT is defined as the Y axis direction, and the thickness direction of the magnetic tape MT is defined as the Z axis direction. It is noted that the direction of the magnetic tape MT uses the direction of the magnetic tape MT when it passes below the data write head 60 as a reference.

As shown in FIG. 12, the data write head 60 includes a first data write head 60a and a second data write head 60b. It is noted that in the descriptions in the present specification, when the two data write heads 60 are not to be distinguished from each other in particular, these are collectively and simply referred to as the data write head 60, and when the two data write heads 60 are to be distinguished from each other in particular, these are referred to as the first data write head 60a and the second data write head 60b.

The first data write head 60a and the second data write head 60b basically have similar configurations, though are symmetric in the width direction of the data write head 60 (Y′ axis direction). The first data write head 60a and the second data write head 60b are integrally movable in the width direction of the magnetic tape MT (Y axis direction), and thus can write data to any data band d out of all the data bands d0 to d3.

The first data write head 60a is a head used when the magnetic tape MT runs in the forward direction (direction A1 in FIG. 11). On the other hand, the second data write head 60b is a head used when the magnetic tape MT runs in the reverse direction (direction A2 in FIG. 11).

The data write head 60 includes an opposing surface 61 opposing the magnetic tape MT. The opposing surface 61 has a shape that is elongated in the longitudinal direction of the data write head 60 (Y′ axis direction) and is short in the width direction of the data write head 60 (X′ axis direction). The opposing surface 61 is provided with two servo read portions 62 and a plurality of data write/read portions 63.

The servo read portions 62 are provided one each on both end sides of the data write head 60 in the longitudinal direction (Y′ axis direction). The servo read portions 62 are configured to be capable of reproducing servo signals by reading magnetic fields generated by the servo patterns 47 recorded on the servo bands s of the magnetic tape MT using an MR element (MR: Magneto Resistive effect) and/or the like.

As the MR element, for example, an anisotropic magneto resistive effect element (AMR: Anisotropic Magneto Resistive effect), a giant magneto resistive effect element (GMR: Giant Magneto Resistive effect), a tunnel magneto resistive effect element (TMR: Tunnel Magneto Resistive effect), or the like is used.

The data write/read portions 63 are arranged at regular intervals along the longitudinal direction of the data write head 60 (Y′ axis direction). Further, the data write/read portions 63 are arranged at positions situated between the two servo read portions 62. The number of data write/read portions 63 is, for example, about 20 to 40, but this number is not limited in particular.

Each of the data write/read portions 63 includes a data write portion 64 and a data read portion 65. The data write portion 64 is configured to be capable of recording data onto the data band d of the magnetic tape MT by a magnetic field generated from a magnetic gap.

The data read portion 65 is configured to be capable of reproducing data signals by reading the magnetic field generated by the data recorded on the data band d of the magnetic tape MT using the MR element or the like. As the MR element, for example, an anisotropic magneto resistive effect element (AMR), a giant magneto resistive effect element (GMR), a tunnel magneto resistive effect element (TMR), or the like is used.

In the first data write head 60a, the data write portion 64 is arranged on the left side of the data read portion 65 (an upstream side when the magnetic tape MT runs in the forward direction). On the other hand, in the second data write head 60b, the data write portion 64 is arranged on the right side of the data read portion 65 (an upstream side when the magnetic tape MT runs in the reverse direction).

The data read portion 65 is capable of reproducing, immediately after the data write portion 64 paired with that data read portion 65 writes data onto the magnetic tape MT, data signals of the data. It is noted that alternatively, data written by the data write portion 64 of one of the first data write head 60a and the second data write head 60b may be reproduced by the data read portion 65 of the other one of the first data write head 60a and the second data write head 60b.

As the magnetic tape MT reciprocates many times by the running direction being changed between the forward direction and the reverse direction, data is recorded on the recording tracks 46 by the first data write head 60a and the second data write head 60b.

The angle adjustment unit 57 (see FIG. 11) is capable of retaining the first data write head 60a and the second data write head 60b rotatably about an axis in the up-down direction (Z′ axis). The angle adjustment unit 57 is also capable of causing the first data write head 60a and the second data write head 60b to rotate individually about the axis in the up-down direction.

The angle adjustment unit 57 adjusts the angles of the first data write head 60a and the second data write head 60b so that the longitudinal directions of the first data write head 60a and the second data write head 60b are tilted at the azimuth angle θ with respect to the width direction of the magnetic tape MT.

Herein, the positions of the servo read portions 62 and the data write/read portions 63 of the first data write head 60a in the Y axis direction (the width direction of the magnetic tape MT) and the positions of the servo read portions 62 and the data write/read portions 63 of the second data write head 60b in the Y axis direction are the same. Their positional relationship does not change even when the first data write head 60a and the second data write head 60b rotate about the Z axis.

In other words, the angle adjustment unit 57 is capable of causing the first data write head 60a and the second data write head 60b to rotate individually so that the positions of the servo read portions 62 and the data write/read portions 63 of the first data write head 60a in the Y axis direction (the width direction of the magnetic tape MT) and the positions of the servo read portions 62 and the data write/read portions 63 of the second data write head 60b in the Y axis direction become the same.

In the present embodiment, a reference angle Refθ that is used as a reference is set for the azimuth angle θ of the data write head 60, and the azimuth angle θ of the data write head 60 is set within an angle range expressed by reference angle Refθ±x°.

FIG. 12 shows an example where the reference angle Refθ is set in a clockwise (lower side: seen from the magnetic tape MT side) direction with respect to the width direction of the magnetic tape MT. Alternatively, the reference angle Refθ may be set in a counterclockwise (lower side: seen from the magnetic tape MT side) direction with respect to the width direction of the magnetic tape MT.

### [Reference Angle Refθ, Angle Range Refθ±x°, Etc.]

Next, the reference angle Refθ at the azimuth angle θ of the data write head 60 and the angle range Refθ±x° at the azimuth angle θ of the data write head 60 will be described.

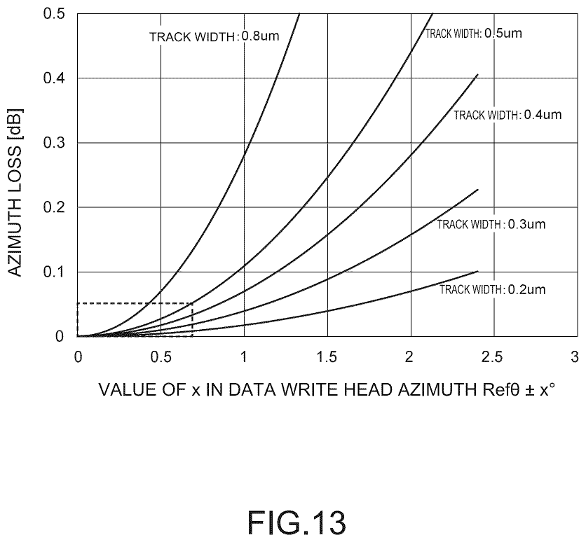

FIG. 13 is a diagram showing a relationship between the angle range Refθ±x° of the azimuth angle θ of the data write head 60 and an azimuth loss Le (recording wavelength: 0.1 μm). In FIG. 13, the abscissa axis represents a value of x in the angle range Refθ±x° of the azimuth angle θ of the data write head 60, and the ordinate axis represents the azimuth loss L_{θ}.

The azimuth loss Le [dB] is expressed by the following equation.

L_{θ}=−20 Log₁₀[sin{(rW/λ)tan θ}/(rW/λ)tan θ]

In the equation, W is a reproduction track width, λ is a data recording wavelength, and θ is an azimuth angle of the data write head 60.

FIG. 13 shows five graphs in which the reproduction track widths W are set to 0.8 μm, 0.5 μm, 0.4 μm, 0.3 μm, and 0.2 μm, respectively. In FIG. 13, the recording wavelength λ is set to 0.1 μm. Herein, the graph in which the reproduction track width W is 0.8 μm corresponds to LTO-9, and the graphs in which the reproduction track widths W are 0.5 μm, 0.4 μm, 0.3 μm, and 0.2 μm, respectively, correspond to LTO-10 and subsequent generations (estimated values).

As can be understood from FIG. 13, it can be seen that when the angle ranges Refθ±x° of the azimuth angle θ of the data write head 60 are the same, the azimuth loss Le becomes smaller as the reproduction track width W becomes narrower.

That is, this means that in the case where the azimuth angle θ of the data write head 60 is adjusted to thus cope with the variations in the width of the magnetic tape MT as in the present embodiment, the magnetic tape MT having a larger number of recording tracks 46 and narrower reproduction track width W (for example, LTO-10 and subsequent generations) is more advantageous from the viewpoint of the azimuth loss L_{θ}.

Herein, it is assumed that a value with which the azimuth loss Le can be tolerated is 0.05 [dB] or less. Further, it is assumed that the reproduction track width W of the magnetic tape MT is 0.5 μm or less (LTO-10 and subsequent generations (estimated values)).

In this case, as indicated by the dotted line in FIG. 13, the angle range at the azimuth angle θ of the data write head 60 is Refθ±0.7° at maximum. Therefore, in the present embodiment, the value of x in Refθ±x° in the angle range at the azimuth angle θ of the data write head 60 is typically 0.7° or less.

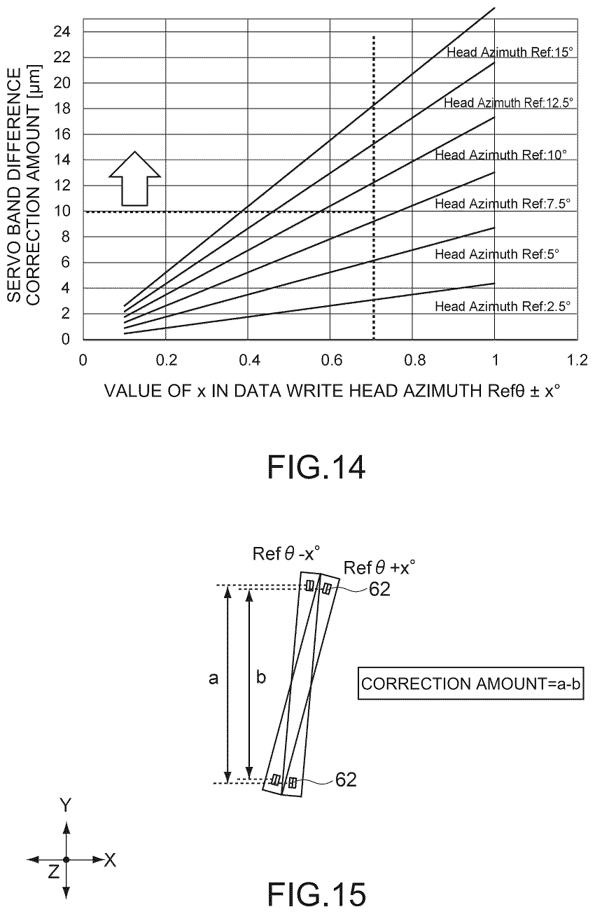

FIG. 14 is a diagram showing a relationship between the angle range Refθ±x° at the azimuth angle θ of the data write head 60 and a correction amount with respect to a servo band pitch difference that is based on a width variation of the magnetic tape MT.

In FIG. 14, the abscissa axis represents the value of x in the angle range Refθ±x° of the azimuth angle θ of the data write head 60, and the ordinate axis represents the correction amount with respect to the servo band pitch difference that is based on the width variation of the magnetic tape MT.

FIG. 15 is a diagram showing the correction amount with respect to the servo band pitch difference that is based on the width variation of the magnetic tape MT. As shown in FIG. 15, this correction amount is expressed as a-b.

Herein, the value of a is a distance between the two servo read portions 62 in the width direction of the magnetic tape MT (Y axis direction) when the azimuth angle θ of the data write head 60 is Refθ−x°. On the other hand, the value of b is a distance between the two servo read portions 62 in the width direction of the magnetic tape MT (Y axis direction) when the azimuth angle θ of the data write head 60 is Refθ+x°.

Referring back to FIG. 14, FIG. 14 shows six graphs in which the reference angles Ref θ at the azimuth angle θ of the data write head 60 are changed to 2.5°, 5°, 7.5°, 10°, 12.5°, and 15°, respectively.

It can be seen from FIG. 14 that when the angle ranges Refθ±x° are the same, the correction amount increases as the reference angle Refθ increases.

Herein, as described above, when the azimuth loss Le is 0.05 [dB] or less and the reproduction track width W is 0.5 μm or less, the angle range at the azimuth angle θ of the data write head 60 is Refθ±0.7° at maximum (see the vertical broken line in FIG. 14). In addition to this condition, it is further assumed that the correction amount is 10 μm or more (see the horizontal broken line in FIG. 14).

As can be understood from FIG. 14, it can be seen that the reference angle Refθ of the data write head 60 of 7.5° is slightly insufficient and that the reference angle Refθ of 10° is sufficient for satisfying these conditions. In other words, for satisfying the conditions described above, the reference angle Refθ is set to 8° or more.

It is noted that the descriptions herein do not mean that the reference angle Refθ must be set to 8° or more in the present embodiment. In other words, in the present embodiment, the reference angle Refθ can be set as appropriate to 2.5° or more, 5° or more, 7.5° or more, 8° or more, 10° or more, 12.5° or more, 15° or more, or the like.

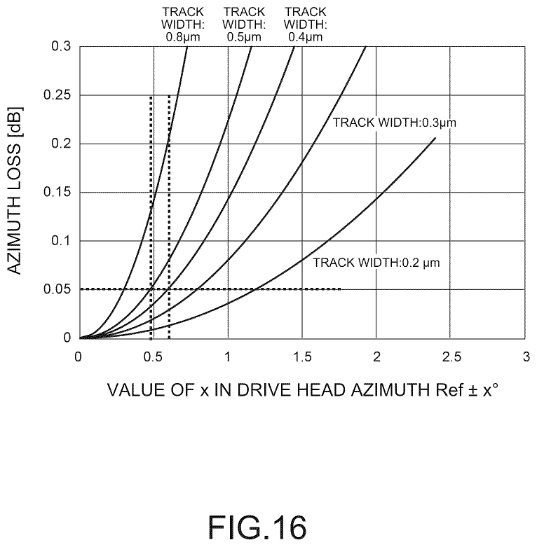

FIG. 16 is a diagram showing a relationship between the angle range Refθ±x° of the azimuth angle θ of the data write head 60 and the azimuth loss Le (recording wavelength: 0.07 μm). In FIG. 16, the abscissa axis represents the value of x in the angle range Refθ±x° of the azimuth angle θ of the data write head 60, and the ordinate axis represents the azimuth loss L_{θ}. In FIG. 16, the data recording wavelength λ is set to 0.07 μm.

A difference between FIG. 13 and FIG. 16 is that, while the data recording wavelength λ is 0.1 μm in FIG. 13, the data recording wavelength λ is 0.07 μm in FIG. 16. It is noted that in LTO-10 and subsequent generations, the data recording wavelength λ is estimated to be 0.1 μm or less, 0.07 μm or less, or the like.

As can be understood from the comparison between FIG. 13 and FIG. 16, it can be seen that the azimuth loss increases as the data recording wavelength λ decreases.

In FIG. 16, the graph in which the reproduction track width W is 0.5 μm will be focused. When the data recording wavelength λ is 0.07 μm and the reproduction track width W is 0.5 μm, the value of x in the angle range Refθ±x° of the azimuth angle θ of the data write head 60 only needs to be set to 0.48° or less for setting the azimuth loss to be 0.05 [dB] or less.

In FIG. 14, a point where the value of x in the angle range Refθ±x° of the azimuth angle θ of the data write head 60 is 0.48° (see the abscissa axis in FIG. 14) will be focused. When the angle range of the azimuth angle θ of the data write head 60 is Refθ±0.48°, it can be seen that the reference angle Refθ only needs to be set to 12.5° or more for setting the correction amount to be 10 μm or more.

Further, in FIG. 16, the graph in which the reproduction track width W is 0.4 μm will be focused. When the data recording wavelength λ is 0.07 μm and the reproduction track width W is 0.4 μm, the value of x in the angle range Refθ±x° of the azimuth angle θ of the data write head 60 only needs to be set to 0.6° or less for setting the azimuth loss to be 0.05 [dB] or less.

In FIG. 14, the point where the value of x in the angle range Refθ±x° of the azimuth angle θ of the data write head 60 is 0.6° (see the abscissa axis in FIG. 14) will be focused. It can be seen that when the angle range of the azimuth angle θ of the data write head 60 is Refθ±0.6°, the reference angle Refθ only needs to be set to 10° or more for setting the correction amount to be 10 μm or more.

It is noted that as can be understood from the descriptions herein, the angle range Refθ±x° of the azimuth angle θ of the data write head 60 becomes smaller as the data recording wavelength λ becomes smaller. Also, the angle range Refθ±x° of the azimuth angle θ of the data write head 60 becomes larger as the reproduction track width W becomes smaller (see FIGS. 13 and 16).

The reference angle Refθ at the azimuth angle θ of the data write head 60 becomes larger as the data recording wavelength λ becomes smaller. In addition, the reference angle Refθ at the azimuth angle θ of the data write head 60 becomes smaller as the reproduction track width W becomes smaller (see FIG. 14).

Herein, as the generation of the LTO standard progresses from LTO-9 to LTO-10, LTO-11, . . . , it is predicted that the data recording wavelength λ will sequentially become smaller, and the reproduction track width W will also sequentially become smaller. In accordance with this, it is only necessary to set the value of x in the angle range Refθ±x° of the azimuth angle θ of the data write head 60 to an appropriate value (for example, 0.7° or less, 0.6° or less, 0.5° or less, 0.4° or less, or the like) and also set the reference angle Refθ of the azimuth angle θ of the data write head 60 to an appropriate value (for example, 2.5° or more, 5° or more, 7.5° or more, 8° or more, 10° or more, 12.5° or more, 150 or more, or the like).

### [Servo Recording/Reproducing Device]

Next, the servo recording/reproducing device 70 will be described. FIG. 17 is a diagram showing the servo recording/reproducing device 70.

As shown in FIG. 17, the servo recording/reproducing device 70 includes a feed roller 71, a demagnetization portion 72, a servo write head 80, a servo read head 75, a take-up roller 76, and four pairs of capstan rollers 77.

The feed roller 71 is capable of rotatably supporting the magnetic tape MT in a roll. The feed roller 71 is rotated by drive of a motor or the like and feeds the magnetic tape MT toward the downstream side in accordance with the rotation.

The take-up roller 76 is capable of rotatably supporting the magnetic tape MT in a roll. The take-up roller 76 rotates by drive of a motor or the like and reels in the magnetic tape MT in accordance with the rotation.

The four pairs of capstan rollers 77 are each capable of nipping the magnetic tape MT from both sides in the up-down direction. The four pairs of capstan rollers 77 rotate by drive of a motor or the like and convey the magnetic tape MT along the conveying path in accordance with the rotation.

The feed roller 71, the take-up roller 76, and the four pairs of capstan rollers 77 are capable of conveying the magnetic tape MT at a constant speed in the conveying path.

The servo write head 80 is arranged above the magnetic tape MT (magnetic layer 43 side), for example. The servo write head 80 applies a magnetic field to the servo band s at a predetermined timing in accordance with a square wave pulse signal, and records the servo pattern 47 on the servo band s.

The servo write head 80 is capable of recording the servo patterns 47 on all the servo bands s (s0 to s4) when the magnetic tape MT passes below the servo write head 80. It is noted that details of the configuration of the servo write head 80 will be described later with reference to FIGS. 18 to 23.

The demagnetization portion 72 is arranged below the magnetic tape MT (base layer 41 side) at a position more on the upstream side than the servo write head 80, for example. The demagnetization portion 72 is constituted of, for example, two permanent magnets 73 and 74. Before the servo patterns 47 are recorded by the servo write head 80, the permanent magnets 73 and 74 apply a magnetic field to the entire magnetic layer 43 by a DC magnetic field, to thus demagnetize the entire magnetic layer 43.

The servo read head 75 is arranged above the magnetic tape MT (magnetic layer 43 side) at a position more on the downstream side than the servo write head 80. The servo read head 75 is configured to be capable of reproducing information regarding the servo patterns 47 by reading the magnetic field generated from the servo patterns 47 recorded on the magnetic tape MT.

The servo read head 75 is capable of reading the servo patterns 47 from all the servo bands s (s0 to s4) when the magnetic tape MT passes below the servo read head 75. The information regarding the servo patterns 47 read by the servo read head 75 is used to confirm whether the servo patterns 47 have been recorded correctly.

The type of the servo read head 75 may be, for example, an inductive type, an MR type (Magneto Resistive), a GMR type (Giant Magneto Resistive), a TMR type (Tunnel Magneto Resistive), or the like.

Although an illustration is omitted, the servo recording/reproducing device 70 includes a control device which collectively controls respective units of the servo recording/reproducing device 70.

The control device includes, for example, a control unit, a storage unit, a communication unit, and the like. The control unit is constituted of, for example, a CPU (Central Processing Unit) and the like, and collectively controls the respective units of the servo recording/reproducing device 70 in accordance with programs stored in the storage unit.

The storage unit includes a nonvolatile memory in which various types of data and various programs are recorded and a volatile memory used as a working area of the control unit. The various programs may be read from a portable recording medium such as an optical disk and a semiconductor memory, or may be downloaded from a server device on a network. The communication unit is configured to be capable of communicating with other devices such as a PC and a server device, for example.

### [Servo Write Head]

Next, the configuration of the servo write head 80 will be described in detail. As described above, the data write head 60 in the data recording/reproducing device 50 is arranged to be tilted with respect to the width direction of the magnetic tape MT. Accordingly, the first servo pattern 47a (“/”) and the second servo pattern 47b (“\”) are written to be asymmetric with respect to the width direction of the magnetic tape MT so that the data write head 60 can accurately read the servo patterns 47. The writing of the asymmetric servo patterns 47 is executed by the servo write head 80.

As the configuration of the servo write head 80, there are two types, that is, Embodiment A and Embodiment B. In Embodiment A, a longitudinal direction of a servo write head 80a (Y″ axis direction) is arranged parallel to the width direction of the magnetic tape MT (Y axis direction) (see FIGS. 18 to 20 to be described later). On the other hand, in Embodiment B, a longitudinal direction of a servo write head 80b (Y″ axis direction) is arranged to be tilted at a predetermined angle with respect to the width direction of the magnetic tape MT (Y axis direction) (see FIGS. 21 to 23 to be described later).

### Embodiment A

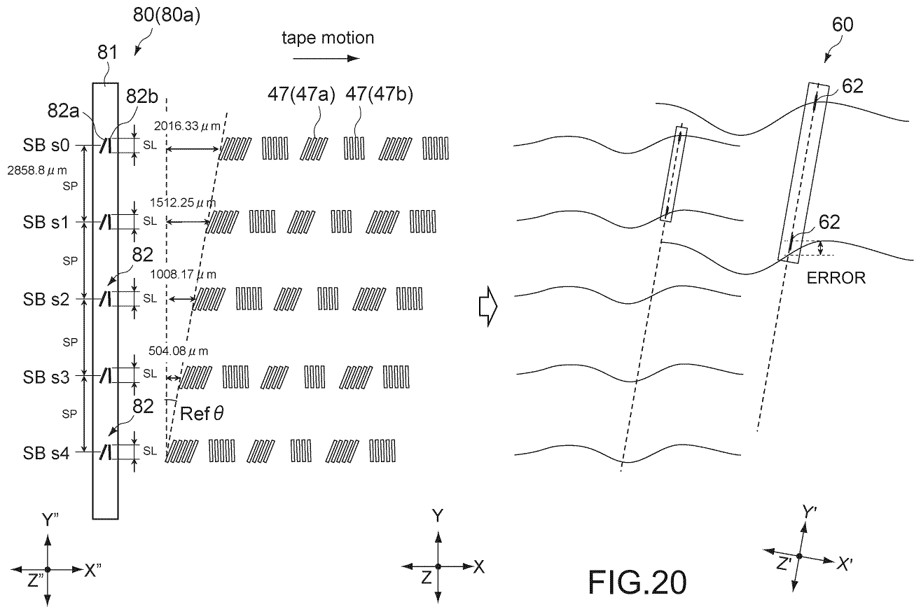

First, Embodiment A of the servo write head 80 will be described. FIG. 18 is a diagram showing the servo write head 80a and pulse signals input to the servo write head 80a. FIG. 19 is an enlarged view of a servo element 82 included in the servo write head 80a. FIG. 20 is a diagram showing a state where the servo write head 80a writes the servo patterns 47 onto the magnetic tape MT. It is noted that FIGS. 18 to 20 each show the surface of the servo write head 80a that opposes the magnetic tape MT.

As shown in these figures, the servo write head 80a has a shape that is long in the longitudinal direction (Y″ axis direction) and short in the width direction (X″ axis direction). It is noted that in FIGS. 18 to 20, the longitudinal direction of the servo write head 80a is defined as the Y″ axis direction, the width direction of the servo write head 80a is defined as the X″ axis direction, and the up-down direction of the servo write head 80a is defined as the Z″ axis direction. In addition, the longitudinal direction of the magnetic tape MT (conveying direction) is defined as the X axis direction, the width direction of the magnetic tape MT is defined as the Y axis direction, and the thickness direction of the magnetic tape MT is defined as the Z axis direction. It is noted that the same holds true for FIGS. 21 to 23.

In Embodiment A, the longitudinal direction of the servo write head 80a (Y″ axis direction) coincides with the direction of the magnetic tape MT (Y axis direction), and the width direction of the servo write head 80a (X″ axis direction) coincides with the longitudinal direction of the magnetic tape MT (X axis direction).

The servo write head 80a includes an opposing surface 81 that opposes the magnetic tape MT. The opposing surface 81 has a shape that is long in the longitudinal direction (Y″ axis direction) and short in the width direction (X″ axis direction).

The servo write head 80a includes five pairs of servo elements 82 (magnetic gaps) on the opposing surface 81. The five pairs of servo elements 82 are arranged at predetermined intervals (servo element pitch: SP) in the longitudinal direction of the servo write head 80a (Y″ axis direction).

In the longitudinal direction of the servo write head 80a (Y″ axis direction) (the width direction of the magnetic tape MT: Y axis direction), an interval between two adjacent pairs of servo elements 82 (servo element pitch) is, for example, 2858.8±4.6 μm. It is noted that in the magnetic tape MT, this value corresponds to an interval between two adjacent servo bands s (servo band pitch: SP) in the width direction of the magnetic tape MT (Y axis direction).

The pair of servo elements 82 includes a first servo element 82a (“/”) and a second servo element 82b (“\”) that are configured to be asymmetric with respect to the longitudinal direction of the servo write head 80a (Y″ axis direction) (the width direction of the magnetic tape MT: Y axis direction) (see FIG. 19 in particular).

The first servo element 82a (“/”) is tilted at a first angle θs1 with respect to the longitudinal direction of the servo write head 80a (Y″ axis direction) (the width direction of the magnetic tape MT: Y axis direction). The second servo element 82b (“\”) is tilted at a second angle θs2 in an orientation opposite to the first angle θs1 with respect to the longitudinal direction of the servo write head 80a (Y″ axis direction) (the width direction of the magnetic tape MT: Y axis direction).

The first angle θs1 and the second angle θs2 are related to the reference angle Refθ of the data write head 60 and are respectively expressed by the following equations.

θs1=Refθ+θa

θs2=Refθ−θa

Herein, Refθ is the reference angle Refθ of the data write head 60, and θa is a servo azimuth angle.

If the reference angle Refθ of the data write head 60 is set to 10° and the servo azimuth angle θa is set to 12°, the first angle θs1 of the first servo element 82a (“/”) is set to 22°, and the second angle θs2 of the second servo element 82b (“\”) is set to 2°.

In the width direction of the servo write head 80a (X″ axis direction) (the longitudinal direction of the magnetic tape MT: X axis direction), the interval between the first servo element 82a (“/”) and the second servo element 82b (“\”) is, for example, 38 μm at a position that is ½ of a width component SL of the length of the servo element.

Herein, in the first servo element 82a (“/”), a direction along the first angle θs1 (a direction of 22θ with respect to the width direction of the magnetic tape MT) is defined as the longitudinal direction of the first servo element 82a (“/”). In addition, in the second servo element 82b (“\”), a direction along the second angle θs2 (a direction of −2° with respect to the width direction of the magnetic tape MT) is defined as the longitudinal direction of the second servo element 82b (“\”).

The length of the first servo element 82a (“/”) in the longitudinal direction is different from the length of the second servo element 82b (“\”) in the longitudinal direction, and in this example, the length of the first servo element 82a (“/”) in the longitudinal direction is longer than the length of the second servo element 82b (“\”) in the longitudinal direction.

On the other hand, the component SL in the width direction of the magnetic tape MT (Y axis direction) in the length of the first servo element 82a (“/”) in the longitudinal direction is the same as the component SL in the width direction of the magnetic tape MT (Y axis direction) in the length of the second servo element 82b (“∛”) in the longitudinal direction. The width component SL of the length of the servo element 82 is, for example, 96±3 μm.

FIG. 18 shows the pulse signals respectively input to the five pairs of servo elements 82. Further, FIG. 20 shows the servo patterns 47 written in the servo bands s of the magnetic tape MT by inputting the pulse signals to the five pairs of servo elements 82.

Herein, as described above, the data write head 60 is arranged to be tilted at the azimuth angle θ with respect to the width direction of the magnetic tape MT. In this case, a case where pulse signals of the same phase are input at the same clock time to the five pairs of servo elements 82 and the servo patterns 47 of the same phase are written at positions parallel to the width direction of the magnetic tape MT will be assumed. In this case, the phases of the servo patterns 47 read at the same clock time by the two servo read portions 62 of the data write head 60 arranged to be tilted differ.

In this regard, in Embodiment A, the phases of the pulse signals input to the five pairs of servo elements 82 at the same clock time are differentiated, so that the servo patterns 47 of the same phase are written non-parallel to the width direction of the magnetic tape MT.

The phase difference between the pulse signals input to the two pairs of servo elements 82 adjacent to each other in the longitudinal direction of the servo write head 80a (Y″ axis direction: the width direction of the magnetic tape MT) corresponds to SP×tan (Refθ). Herein, SP (servo band pitch=servo element pitch) is the interval between two adjacent servo bands s in the width direction of the magnetic tape MT or the interval between two adjacent pairs of servo elements 82 in the width direction of the magnetic tape MT. In addition, Refθ is a reference angle in the data write head 60.

Suppose that the value of SP is 2858.8 μm and the reference angle Refθ in the data write head 60 is 10°. In this case, the phase difference between the pulse signals input to the two adjacent pairs of servo elements 82 corresponds to 2858.8 μm×tan 10°=504.08 μm.

Herein, the phase differences of the input pulses of the servo elements 82 of the servo band s3, the servo band s2, the servo band s1, and the servo band s0, that use the input pulse of the servo element 82 of the servo band s4 as a reference, are phases corresponding to 504.08 μm, 1008.17 μm, 1512.25 μm, and 2016.33 μm in the stated order.

Regarding the five pairs of servo elements 82 corresponding to the five servo bands s, the servo element 82 to which an input pulse with the most advanced phase out of the phases of the pulse signals input at the same clock time is input is the servo element 82 of the servo band s0. The order of the input pulse phases after that is in the stated order of the servo element 82 of the servo band s1, the servo element 82 of the servo band s2, the servo element 82 of the servo band s3, and the servo element 82 of the servo band s4.

For example, taking the servo element 82 of the servo band s0 and the servo element 82 of the servo band s1 as an example, at the same clock time, a pulse signal having a phase that is ahead of the servo element 82 of the servo band s1 by a phase corresponding to 504.08 μm is input to the servo element 82 of the servo band s0.

Similarly, the phase difference between the servo patterns 47 written in the two servo bands s adjacent to each other in the width direction of the magnetic tape MT, in the width direction of the magnetic tape MT (Y axis direction), is expressed by SP×tan (Refθ).

Suppose that the value of SP is 2858.8 μm and the reference angle Refθ in the data write head 60 is 10°. In this case, the phase difference between the servo patterns 47 written in the two adjacent servo bands s in the width direction of the magnetic tape MT (Y axis direction) corresponds to 2858.8 μm x tan 10°=504.08 μm.

The phase differences of the servo patterns 47 of the servo band s3, the servo band s2, the servo band s1, and the servo band s2, that use the servo pattern 47 of the servo band s4 as a reference, are phases corresponding to 504.08 μm, 1008.17 μm, 1512.25 μm, and 2016.33 μm in the stated order.

Regarding the servo patterns 47 written in the five servo bands s, the servo pattern 47 having the most advanced phase in the width direction of the magnetic tape MT (Y axis direction) is the servo pattern 47 of the servo band s0. The order of the phases after that is in the stated order of the servo pattern 47 of the servo band s1, the servo pattern 47 of the servo band s2, the servo pattern 47 of the servo band s3, and the servo pattern 47 of the servo band s4.

For example, taking the servo pattern 47 of the servo band s0 and the servo pattern 47 of the servo band s1 as an example, the phase of the servo pattern 47 of the servo band s0 is a phase that is ahead of the servo pattern 47 of the servo band s1 by a phase corresponding to 504.08 μm in the width direction of the magnetic tape MT.

In the magnetic tape MT, in the direction of the reference angle Refθ (10°) of the data write head 60 with respect to the width direction of the magnetic tape MT (Y axis direction), the phases of the servo patterns 47 written in the five servo bands s are of the same phase.

### Embodiment B

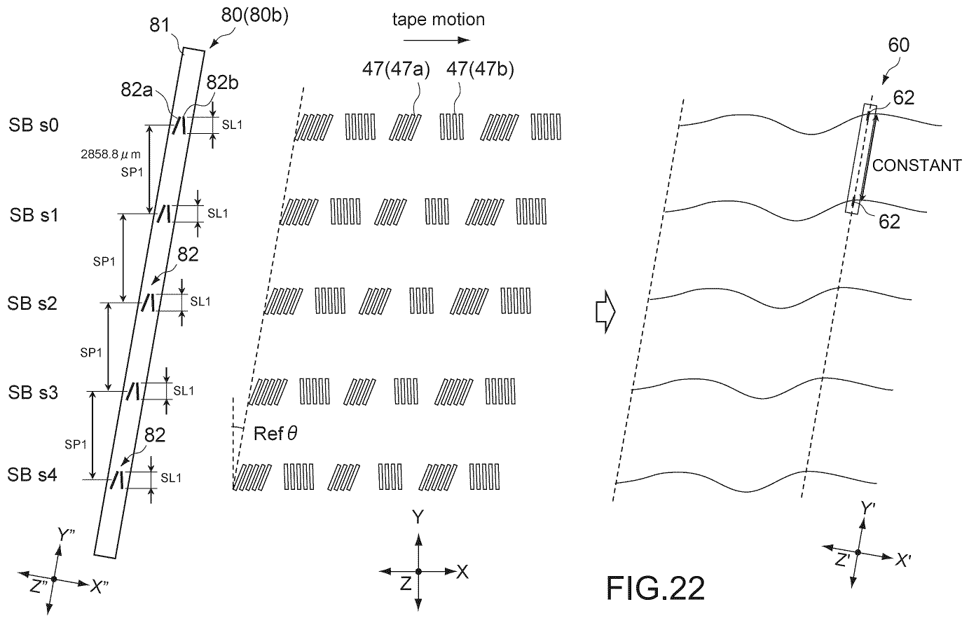

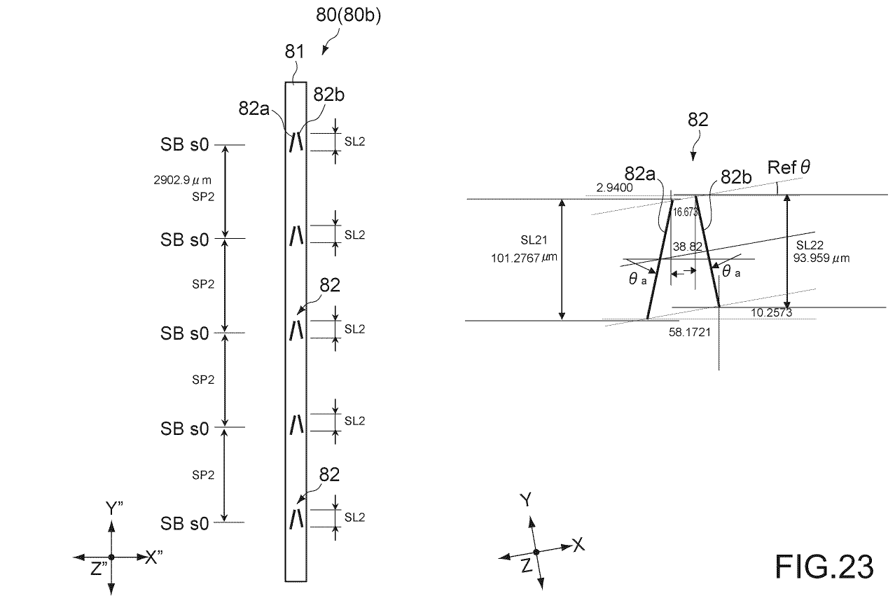

Next, Embodiment B of the servo write head 80 will be described. FIG. 21 is an enlarged view of the servo write head 80b and the servo elements 82 included in the servo write head 80b according to Embodiment B. FIG. 22 is a diagram showing a state where the servo write head 80b according to Embodiment B writes the servo patterns 47 on the magnetic tape MT. FIGS. 21 and 22 each show the surface of the servo write head 80b that opposes the magnetic tape MT. It is noted that FIGS. 23 to 26 to be described later similarly show the surface of the servo write head 80 that opposes the magnetic tape MT.

As shown in these figures, the servo write head 80b has a shape that is long in the longitudinal direction (Y″ axis direction) and short in the width direction (X″ axis direction).

In Embodiment B, the longitudinal direction of the servo write head 80b (Y″ axis direction) is arranged to be tilted at a predetermined angle (second head azimuth angle) with respect to the width direction of the magnetic tape MT. The angle at which the longitudinal direction of the servo write head 80b (Y″ axis direction) is tilted with respect to the width direction of the magnetic tape MT (Y axis direction) is related to the reference angle Refθ of the data write head 60 and coincides with the reference angle Refθ of the data write head 60 (for example, 10°).

The servo write head 80b includes the opposing surface 81 that opposes the magnetic tape MT. The opposing surface 81 has a shape that is long in the longitudinal direction (Y″ axis direction) and short in the width direction (X″ axis direction).

The servo write head 80b includes five pairs of servo elements 82 (magnetic gaps) on the opposing surface 81. The five pairs of servo elements 82 are arranged at predetermined intervals (servo element pitch: SP1) in the width direction of the magnetic tape MT (Y axis direction).

An interval between two adjacent pairs of servo elements 82 (servo element pitch: SP1) in the width direction of the magnetic tape MT (Y axis direction) is, for example, 2858.8±4.6 μm. It is noted that in the magnetic tape MT, this value corresponds to an interval between two servo bands s (servo band pitch: SP1) adjacent to each other in the width direction of the magnetic tape MT (Y axis direction).

Further, a positional difference between the two adjacent pairs of servo elements 82 in the longitudinal direction of the magnetic tape MT (X axis direction) is expressed by SP1×tan (Refθ). Herein, SP1 (servo band pitch=servo element pitch) is an interval between two adjacent servo bands s in the width direction of the magnetic tape MT or an interval between two adjacent pairs of servo elements 82 in the width direction of the magnetic tape MT. Furthermore, Refθ is a reference angle in the data write head 60.

Suppose that the value of SP1 is 2858.8 μm and the reference angle Refθ in the data write head 60 is 10°. In this case, the positional difference between the two adjacent pairs of servo elements 82 in the longitudinal direction of the magnetic tape (X axis direction) is 2858.8 μm×tan 10°=504.08 μm.

The pair of servo elements 82 includes the first servo element 82a (“/”) and the second servo element 82b (“\”) configured to be asymmetric with respect to the width direction of the magnetic tape MT (Y axis direction) (see the right side of FIG. 21 in particular).

The first servo element 82a (“/”) is tilted at the first angle θs1 with respect to the width direction of the magnetic tape MT (Y axis direction). The second servo element 82b (“\”) is tilted at the second angle θs2 in the orientation opposite to the first angle θs1 with respect to the width direction of the magnetic tape MT (Y axis direction).

The first angle θs1 and the second angle θs2 are related to the reference angle Refθ of the data write head 60 and are respectively expressed by the following equations.

θs1=Refθ+θa

θs2=Refθ−θa

Herein, Refθ is the reference angle Refθ of the data write head 60, and θa is the servo azimuth angle.

If the reference angle Refθ of the data write head 60 is set to 10° and the servo azimuth angle θa is set to 12°, the first angle θs1 of the first servo element 82a (“/”) is set to 22°, and the second angle θs2 of the second servo element 82b (“\”) is set to 2°.

In the width direction of the magnetic tape MT (X axis direction), the interval between the first servo element 82a (“/”) and the second servo element 82b (“\”) is, for example, 38 μm at a position that is ½ of a width component SL of the length of the servo element 82.

Herein, in the first servo element 82a (“/”), the direction along the first angle θs1 (the direction of 22° with respect to the width direction of the magnetic tape MT) is defined as the longitudinal direction of the first servo element 82a (“/”). In addition, in the second servo element 82b (“\”) the direction along the second angle θs2 (the direction of −2° with respect to the width direction of the magnetic tape MT) is defined as the longitudinal direction of the second servo element 82b (“\”).

The length of the first servo element 82a (“/”) in the longitudinal direction is different from the length of the second servo element 82b (“\”) in the longitudinal direction, and in this example, the length of the first servo element 82a (“/”) in the longitudinal direction is longer than the length of the second servo element 82b (“\”) in the longitudinal direction.

On the other hand, the component (Y axis direction) SL1 in the width direction of the magnetic tape MT in the length of the first servo element 82a (“/”) in the longitudinal direction is the same as the component (Y axis direction) SL1 in the width direction of the magnetic tape MT in the length of the second servo element 82b (“\”) in the longitudinal direction. The width component SL of the length of the servo element 82 is, for example, 96±3 μm.

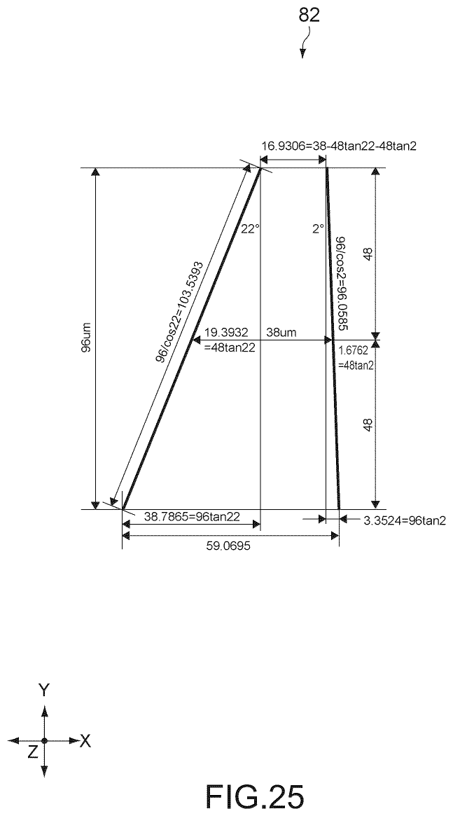

FIG. 25 is an enlarged view of the diagram on the right side of FIG. 21, and is a diagram showing an example of specific dimensions of the first servo element 82a (“/”) and the second servo element 82b (“\”) (based on XYZ coordinate system).

As shown in FIG. 25, the length of the first servo element 82a (“/”) in the longitudinal direction is 103.5393 μm (=96 μm/cos 22°). Further, the length of the second servo element 82b (“\”) in the longitudinal direction is 96.0585 μm (=96 μm/cos 2°).

Further, an interval between an upper end portion of the first servo element 82a and an upper end of the second servo element 82b (X axis direction) is 16.9306 μm (=38 μm−48 μm×tan 22°−48 μm×tan 2°=38 μm−19.3932 μm−1.6762 μm).

Furthermore, an interval between a lower end portion of the first servo element 82a and a lower end portion of the second servo element 82b (X axis direction) is 59.0695 μm (=96 μm x tan 22°+16.9306 μm+96 μm×tan 2°=38.7865 μm+16.9306 μm+3.3524 μm).

Herein, in Embodiment A described above, the phase difference has been set for the pulse signals respectively input to the five pairs of servo elements 82. Meanwhile, in Embodiment B, since the servo write head 80b is arranged to be tilted, there is no need to set a phase difference for the pulse signals. In other words, pulse signals corresponding to the same phase are input to the five pairs of servo elements 82 at the same clock time.

FIG. 22 shows the servo patterns 47 respectively written in the five servo bands s by the five pairs of servo elements 82.

The phase difference between the servo patterns 47 written in two servo bands s adjacent to each other in the width direction of the magnetic tape MT (Y axis direction), in the width direction of the magnetic tape MT, is expressed by SP1×tan (Refθ).

Suppose that the value of SP1 is 2858.8 μm and the reference angle Refθ in the data write head 60 is 10°. In this case, the phase difference between the servo patterns 47 written in the two adjacent servo bands s is 2858.8 μm×x tan 10°=504.08 μm.

It is noted that the phase differences of the servo patterns 47 of the servo band s3, the servo band s2, the servo band s1, and the servo band s1, that use the servo pattern 47 of the servo band s4 as a reference, are phases corresponding to 504.08 μm, 1008.17 μm, 1512.25 μm, and 2016.33 μm in the stated order.

Regarding the servo patterns 47 written in the five servo bands s, the servo pattern 47 having the most advanced phase in the width direction of the magnetic tape MT (Y axis direction) is the servo pattern 47 of the servo band s0. The order of the phases after that is in the stated order of the servo pattern 47 of the servo band s1, the servo pattern 47 of the servo band s2, the servo pattern 47 of the servo band s3, and the servo pattern 47 of the servo band s4.

For example, taking the servo pattern 47 of the servo band s0 and the servo pattern 47 of the servo band s1 as an example, the phase of the servo pattern 47 of the servo band s0 is a phase that is ahead of the servo pattern 47 of the servo band s1 by a phase corresponding to 504.08 μm in the width direction of the magnetic tape MT.

In the magnetic tape MT, in the direction of the reference angle Refθ (10°) of the data write head 60 with respect to the width direction of the magnetic tape MT (Y axis direction), the phases of the servo patterns 47 written in the five servo bands s are of the same phase.

In the descriptions above, the configuration of the servo write head 80b that uses the coordinate system of the magnetic tape MT (XYZ coordinate system) as a reference has been described. Hereinafter, the configuration of the servo write head 80b that uses the coordinate system of the servo write head 80b (X″Y″Z″ coordinate system) as a reference will be described.

FIG. 23 is a diagram showing the servo write head 80b using the coordinate system of the servo write head 80b as a reference in Embodiment B.

As shown in FIG. 23, the five pairs of servo elements 82 are arranged at predetermined intervals (servo element pitch: SP2) in the longitudinal direction of the servo write head 80b (Y″ axis direction). In the longitudinal direction of the servo write head 80b (Y″ axis direction), the interval between two adjacent pairs of −1 servo elements 82 (servo element pitch: SP2) is expressed by SP1×cos (Refθ).

For example, suppose that the interval between two adjacent pairs of servo elements 82 (servo element pitch: SP1) in the width direction of the magnetic tape MT (Y axis direction) is 2858.8 μm, and the reference angle Refθ of the data write head 60 is 10°. In this case, the interval between the two adjacent pairs of servo elements 82 (servo element pitch: SP2) in the longitudinal direction of the servo write head 80b (Y″ axis direction) is 2902.9 μm.

Herein, in Embodiment A described above, a symmetry axis of the first servo element 82a (“/”) and the second servo element 82b (“\”) is non-parallel to the width direction of the magnetic tape MT (Y axis direction) and is also non-parallel to the longitudinal direction of the servo write head 80b (Y″ axis direction). On the other hand, in Embodiment B, the symmetry axis of the first servo element 82a (“/”) and the second servo element 82b (“\”) is non-parallel to the width direction of the magnetic tape MT (Y axis direction) but is parallel to the longitudinal direction of the servo write head 80b (Y″ axis direction).

The first servo element 82a (“/”) is tilted at the servo azimuth angle θa with respect to the longitudinal direction of the servo write head 80b (Y″ axis direction). On the other hand, the second servo element 82b (“\”) is tilted in the opposite direction from the first servo element 82a (“/”) at the same servo azimuth angle θa as the first servo element 82a (“/”) with respect to the longitudinal direction of the servo write head 80b (Y″ axis direction).

Herein, in the first servo element 82a (“/”), a direction along the servo azimuth angle θa (a direction of +12° with respect to the longitudinal direction of the servo write head 80b) is defined as the longitudinal direction of the first servo element 82a (“/”). Further, in the second servo element 82b (“\”), a direction along the servo azimuth angle θa (a direction of −12° with respect to the longitudinal direction of the servo write head 80b) is defined as the longitudinal direction of the second servo element 82b (“\”).

The length of the first servo element 82a (“/”) in the longitudinal direction is different from the length of the second servo element 82b (“\”) in the longitudinal direction, and in this example, the length of the first servo element 82a (“/”) in the longitudinal direction is longer than the length of the second servo element 82b (“\”) in the longitudinal direction.

Further, a longitudinal component SL21 (Y″ axis direction) of the servo write head 80b in the length of the first servo element 82a (“/”) in the longitudinal direction and a longitudinal component SL22 (Y″ axis direction) of the servo write head 80b in the length of the second servo element 82b (“\”) in the longitudinal direction are also different.

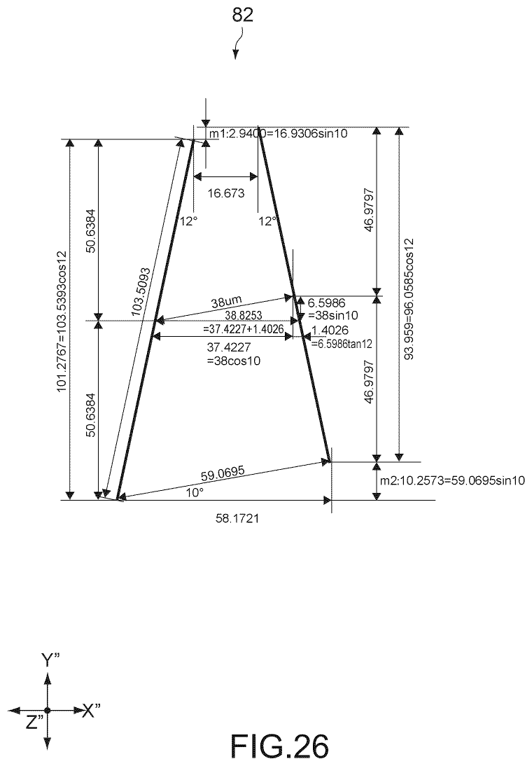

FIG. 26 is an enlarged view of the diagram on the right side of FIG. 23, and is a diagram showing an example of the specific dimensions of the first servo element 82a (“/”) and the second servo element 82b (“\”) (based on the X″Y″Z″ coordinate system).

Suppose that the width component SL1 (Y axis direction) of the magnetic tape MT in the length of the servo element 82 is 96 μm, the reference angle Refθ of the data write head 60 is 10°, and the servo azimuth angle θa is 12°. In this case, the longitudinal component SL21 (Y″ axis direction) of the servo write head 80b in the length of the first servo element 82a (“/”) is 101.2767 μm (=103.5093 μm×cos 12°). Also in this case, the longitudinal component SL22 (Y″ axis direction) of the servo write head 80b in the length of the second servo element 82b (“\”) is 93.959 μm (=96.0585 μm×cos 12°).

Further, in the width direction of the servo write head 80b (X″ axis direction), an interval between the upper end portion of the first servo element 82a and the upper end portion of the second servo element 82b is 16.673 μm (=16.9306 μm×cos 10°). Furthermore, in the longitudinal direction of the servo write head 80b (Y″ axis direction), a difference between the position of the upper end portion of the first servo element 82a (“/”) and the position of the upper end portion of the second servo element 82b (“\”) is 2.94 μm (=16.9306 μm×sin 10°).

Further, in the width direction of the servo write head 80b (X″ axis direction), an interval between the lower end portion of the first servo element 82a and the lower end portion of the second servo element 82b is 58.1721 μm (=59.0695 μm×cos 10\). Furthermore, in the longitudinal direction of the servo write head 80b (Y″ axis direction), a difference between the position of the lower end portion of the first servo element 82a (“/”) and the position of the lower end portion of the second servo element 82b (“\”) is 10.2573 μm (=59.0695 μm×sin 10°).

Further, in the width direction of the servo write head 80b (X″ axis direction), an interval (center) between the first servo element 82a (“/”) and the second servo element 82b (“\”) is, for example, 38.58628253 μm (38 μm×cos 10°+(38 μm×sin 10°)×tan 102°=37.4227 μm+6.5986 μm×tan 102°=37.4227 μm+1.16354026 μm).

### (Comparison Between Embodiment a and Embodiment B)

Next, a comparison between Embodiment A and Embodiment B will be described.

The right side of FIG. 20 shows a state where the servo patterns 47 written by the servo write head 80a according to Embodiment A are read by the two servo read portions 62 of the data write head 60.

As described above, the servo write head 80a according to Embodiment A uses the method in which the servo patterns 47 are written by arranging the servo write head 80a without tilting it with respect to the width direction of the magnetic tape MT and adjusting phases of the pulse signals input to the servo elements 82.

Herein, when the servo write head 80a writes the servo patterns 47 onto the magnetic tape MT, the magnetic tape MT may slightly move in the width direction (Y axis direction).

Suppose that, in the servo write head 80a according to Embodiment A, the servo element 82 of the servo band s0 has written a servo pattern 47 of a certain phase ph1 in the servo band s0 at a certain clock time t1, and at a later clock time t2 (a clock time at which the magnetic tape MT is conveyed 504.08 μm in the conveying direction), the servo element 82 of the servo band s1 has written the servo pattern 47 of the phase ph1 in the servo band s1.

In this case, a case where the magnetic tape MT has slightly moved in the width direction between the clock time t1 and the clock time t2 will be assumed. In this case, an interval (the direction of the reference angle Refθ (10°)) between the position of the servo pattern 47 of the phase ph1 in the servo band s0 and the position of the servo pattern 47 of the phase ph1 in the servo band s1 differs from a specified value (the interval between the two servo read portions 62: the direction of the reference angle Refθ (10°)).

This may cause an error, and thus the data write head 60 may not be able to accurately perform servo trace of the servo pattern 47.

Meanwhile, the right side of FIG. 22 shows a state where the servo patterns 47 written by the servo write head 80b according to Embodiment B are read by the two servo read portions 62 of the data write head 60.

The servo write head 80b according to Embodiment B uses a method in which the servo write head 80b is arranged to be ·BR>X with respect to the width direction of the magnetic tape MT, and the servo patterns 47 are written, with the phases of the pulse signals input to the servo elements 82 being the same phase.

It is assumed that in the servo write head 80b according to Embodiment B, the servo element 82 of the servo band s0 and the servo element 82 of the servo band s1 have written the servo patterns 47 of the same phase ph1 to the servo band s0 and the servo band s1 at the same clock time t1.

After that, it is assumed that the servo element 82 of the servo band s0 and the servo element 82 of the servo band s1 have written the servo patterns 47 of the same phase ph2 to the servo band s0 and the servo band s1 at the same clock time t2.

In this case, it is assumed that the magnetic tape MT has moved slightly in the width direction between the clock time t1 and the clock time t2. In this case, the interval (the direction of the reference angle Refθ (10°)) between the position of the servo pattern 47 of the phase ph1 in the servo band s0 and the position of the servo pattern 47 of the phase ph1 in the servo band s1 is the same as the interval between the position of the servo pattern 47 of the phase ph2 in the servo band s0 and the position of the servo pattern 47 of the phase ph2 in the servo band s1. These intervals are the same as the specified value (the interval between the two servo read portions 62: the direction of the reference angle Refθ (10°)) and are constant.

That is, in Embodiment B, the interval (the direction of the reference angle Refθ) between the servo patterns 47 of the same phase in the adjacent servo bands s can be made constant regardless of the slight movement of the magnetic tape MT in the width direction when writing the servo patterns 47. Thus, the data write head 60 can accurately perform the servo trace of the servo patterns 47.

As can be understood from the descriptions herein, Embodiment B is more advantageous than Embodiment A from the viewpoint of the slight movement of the magnetic tape MT in the width direction when writing the servo patterns 47. It is noted that this is not intended to mean that the method according to Embodiment A cannot be adopted, and Embodiment A is also included as an example of the present technology. For example, if the slight movement of the magnetic tape MT in the width direction when writing the servo patterns 47 is of a negligible level, or if the slight movement of the magnetic tape MT in the width direction when writing the servo patterns 47 can be suppressed to a negligible level, the method according to Embodiment A may be adopted.

### [Operations]

As described above, in the present embodiment, the first servo pattern 47a (“/”) and the second servo pattern 47b (“\”) that are asymmetric with respect to the width direction of the magnetic tape MT can be written in each of the servo bands s0 to s4 by the servo write head 80. Thus, when the data write head 60 is arranged to be tilted with respect to the width direction of the magnetic tape MT, the servo patterns 47 can be accurately read by the data write head 60.

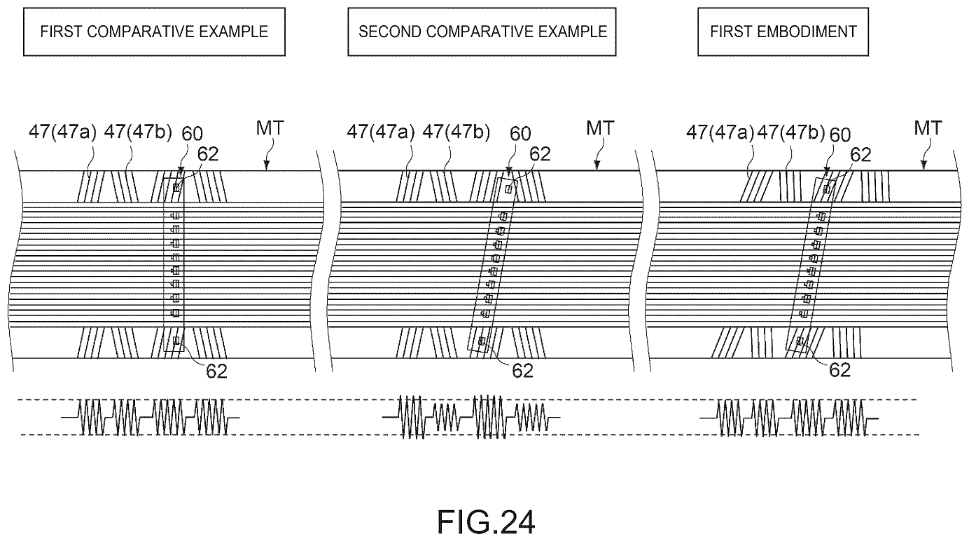

FIG. 24 is a diagram showing a state where the servo patterns 47 are read by the servo read portions 62 of the data write head 60 in a first comparative example, a second comparative example, and a first embodiment.

Referring to the left side of FIG. 24, in the magnetic tape MT according to the first comparative example, the first servo pattern 47a (“/”) and the second servo pattern 47b (“\”) are symmetric with respect to the width direction of the magnetic tape MT. In addition, the longitudinal direction of the data write head 60 is parallel to the width direction of the magnetic tape MT.

In the first comparative example, the azimuth loss of the servo patterns 47 with respect to the servo read portions 62 of the data write head 60 is the same for each group of the servo patterns 47. Accordingly, when the servo patterns 47 are read by the servo read portions 62 of the servo write head 80, the output of the servo signals becomes the same for each servo burst corresponding to the group of servo patterns 47.

Referring to the center of FIG. 24, in the magnetic tape MT according to the second comparative example, the first servo pattern 47a (“/”) and the second servo pattern 47b (“\”) are symmetric with respect to the width direction of the magnetic tape MT. Meanwhile, the longitudinal direction of the data write head 60 is tilted with respect to the width direction of the magnetic tape MT.

In the second comparative example, the azimuth loss of the servo patterns 47 with respect to the servo read portions 62 of the data write head 60 differs for each group of servo patterns 47. Accordingly, when the servo patterns 47 are read by the servo read portions 62 of the servo write head 80, the output of the servo burst corresponding to the group of servo patterns 47 with a small azimuth loss becomes large in the servo signals, whereas the output of the servo burst corresponding to the group of servo patterns 47 with a large azimuth loss becomes small. Therefore, an error may be caused in the tracking reference position.

Referring to the right side of FIG. 24, in the magnetic tape MT according to the present embodiment, the first servo pattern 47a (“/”) and the second servo pattern 47b (“\”) are asymmetric with respect to the width direction of the magnetic tape MT. In addition, the longitudinal direction of the data write head 60 is non-parallel to the width direction of the magnetic tape MT.

In the first embodiment, the azimuth loss of the servo patterns 47 with respect to the servo read portions 62 of the data write head 60 is the same for each group of servo patterns 47. Accordingly, when the servo patterns 47 are read by the servo read portions 62 of the servo write head 80, the output of the servo signals becomes the same for each servo burst corresponding to the group of servo patterns 47.

In this manner, in the first embodiment, since the first servo pattern 47a (“/”) and the second servo pattern 47b (“\”) are asymmetric with respect to the width direction of the magnetic tape MT, the data write head 60 can accurately read the servo patterns 47 when the data write head 60 is arranged to be tilted with respect to the width direction of the magnetic tape MT.

Further, in the first embodiment, the longitudinal direction of the data write head 60 in the data recording/reproducing device 50 is tilted at the azimuth angle θ with respect to the width direction of the magnetic tape MT, and the azimuth angle θ is adjusted. Thus, it is possible to cope with variations in the width of the magnetic tape MT.

Also in the first embodiment, in the data write head 60 in the data recording/reproducing device 50, the azimuth angle θ of the data write head 60 is adjusted within the range of reference angle Refθ±x°.

Here, the setting of the value of x to 0.7° or less makes it possible to reduce the azimuth loss Lθ while supporting the magnetic tape MT having a small reproduction track width W (for example, 0.5 μm or less). Further, here, the setting of the reference angle Refθ to 8° or more makes it possible to increase the correction amount (for example, 10 μm or more).

Further, in the servo recording/reproducing device 70 according to the first embodiment, the first servo element 82a (“/”) and the second servo element 82b (“\”) are provided in the servo write head 80 so as to be asymmetric with respect to the width direction of the magnetic tape MT. Thus, the servo patterns 47 that are asymmetric with respect to the width direction of the magnetic tape MT can be appropriately written by the first servo element 82a (“/”) and the second servo element 82b (“\”).

Furthermore, in the first embodiment, the first servo element 82a (“/”) is tilted at the first angle θs1 with respect to the width direction of the magnetic tape MT, and the second servo element 82b (“\”) is tilted at the second angle θs2 in the orientation opposite to the first angle θs1 with respect to the width direction of the magnetic tape MT, the second angle θs2 being different from the first angle θs1.

In addition, in the first embodiment, the first angle θs1 and the second angle θs2 are related to the reference angle Refθ of the data write head 60. Thus, the first servo element 82a (“/”) and the second servo element 82b (“\”) can appropriately write asymmetric servo patterns 47 that can be accurately read by the data write head 60.

Moreover, in the first embodiment, the length of the first servo element 82a (“/”) in the longitudinal direction is different from the length of the first servo element 82a (“/”) in the longitudinal direction, but the component in the width direction of the magnetic tape MT in the length of the first servo element 82a (“/”) is the same as the component in the width direction of the magnetic tape MT in the length of the second servo element 82b (“\”). Thus, it is possible to align the lengths of the first servo pattern 47a (“/”) and the second servo pattern 47b (“\”) written by the first servo element 82a (“/”) and the second servo element 82b (“\”) in the width direction of the magnetic tape MT.

Further, in the first embodiment, the longitudinal direction of the servo write head 80 may be arranged to be tilted at a predetermined angle with respect to the width direction of the magnetic tape MT (see Embodiment B). In this case, it is possible to appropriately cope with the slight movement of the magnetic tape MT in the width direction when writing the servo patterns 47.

Furthermore, in the first embodiment, the angle at which the longitudinal direction of the servo write head 80 is tilted with respect to the width direction of the magnetic tape MT may be related to the reference angle Refθ of the data write head 60, and this angle may coincide with the reference angle Refθ of the data write head 60. Thus, it is possible to appropriately write asymmetric servo patterns 47 that can be accurately read by the data write head 60 that is arranged to be tilted.

Further, in the magnetic tape MT according to the first embodiment, the phase difference between the servo patterns 47 in the adjacent servo bands s in the width direction of the magnetic tape MT is related to the reference angle Refθ of the servo write head 80 and is expressed by SP×tan (Refθ). Thus, the servo patterns 47 can be read accurately by the data write head 60 that is arranged to be tilted.

### [Method of Confirming Whether Magnetic Tape is Magnetic Tape to be Used in Data-Write-Head-Tilted-Type Data Recording/Reproducing Device]

Next, descriptions will be given on a method of confirming whether the magnetic tape MT is a magnetic tape MT to be used in the data recording/reproducing device 50 of a type in which the data write head 60 is arranged to be tilted with respect to the width direction of the magnetic tape MT (Y axis direction).

### [Confirmation Method: First Example]

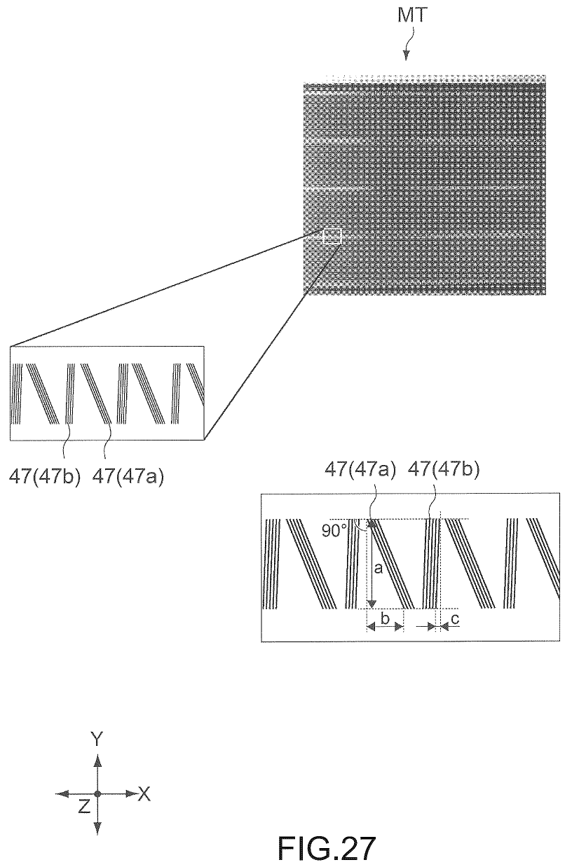

FIG. 27 is a diagram showing a first example of the method of confirming whether the magnetic tape MT is a magnetic tape MT used in the data-write-head-tilted-type data recording/reproducing device 50. In the first example, the following confirmation is performed based on the angle at which the first servo pattern 47a (“/”) is tilted with respect to the width direction of the magnetic tape MT (Y axis direction) (first angle θs1), the angle at which the second servo pattern 47b (“\”) is tilted with respect to the width direction of the magnetic tape (second angle θs2), and the like.

It is noted that FIG. 27 shows a state where the magnetic tape MT is seen from above (magnetic layer side) (accordingly, in the first servo pattern 47a (“/”) and the second servo pattern 47b (“\”), the symbols “/” and “\” become reverse from those that can be seen).

As shown in FIG. 27, first, developer such as ferricolloid developer (for example, SigMarker Q® manufactured by Sigma Hi-Chemical Inc.) is applied onto the magnetic layer 43 of the magnetic tape MT, to perform development. After that, the developed magnetic layer 43 of the magnetic tape MT is observed with an optical microscope to check the shape of the servo patterns 47.

At this time, first, the upper end portion and lower end portion of the first servo pattern 47a (“/”) and the upper end portion and lower end portion of the second servo pattern 47b (“\”) are measured as measurement points. Then, a distance a (corresponding to a servo band width) between the upper end portion and the lower end portion of the servo pattern 47 is measured in the width direction of the magnetic tape MT (Y axis direction).

Further, a distance b between the upper end portion and the lower end portion of the first servo pattern 47a (“/”) is measured in the longitudinal direction of the magnetic tape MT (X axis direction). In addition, a distance c between the upper end portion and the lower end portion of the second servo pattern 47b (“\”) is measured in the longitudinal direction of the magnetic tape MT (X axis direction).

In this case, the angle at which the first servo pattern 47a (“/”) is tilted with respect to the width direction of the magnetic tape MT (Y axis direction) (first angle θs1) is obtained by tan⁻¹(b/a). In addition, the angle at which the second servo pattern 47b (“\”) is tilted with respect to the width direction of the magnetic tape MT (Y axis direction) (second angle θs2) is obtained by tan⁻¹(c/a).

For example, suppose that the value of a is 96 μm, the value of b is 39 μm, and the value of c is 3 μm. In this case, the angle at which the first servo pattern 47a (“/”) is tilted with respect to the width direction of the magnetic tape MT (Y axis direction) (first angle θs1) is tan⁻¹(39/96)=21.59°, which is about 22°. In addition, the angle at which the second servo pattern 47b (“\”) is tilted with respect to the width direction of the magnetic tape MT (Y axis direction) (second angle θs2) is tan⁻¹(3/96)=1.79°, which is about 2°.

Next, a predetermined angle is obtained by (tilt angle of first servo pattern 47a (“/”) (first angle θs1)−tilt angle of second servo pattern 47b (“\”) (second angle θs2))/2 ((22−2)/2=10°). The angle obtained at this time corresponds to the angle at which the symmetry axes of the first servo pattern 47a and the second servo pattern 47b are tilted with respect to the width direction of the magnetic tape MT (Y axis direction).

Suppose that the angle obtained by (first angle θs1−second angle θs2)/2 coincides with the angle at which the data write head 60 is tilted with respect to the width direction of the magnetic tape MT (Y axis direction) (reference angle) (θs1−θs2)/2=refθ) (may include a certain amount of error).

In this case, as already described with reference to the right side of FIG. 24, the azimuth loss of the servo patterns 47 with respect to the servo read portions 62 of the data write head 60 is the same for each group of servo patterns 47. Thus, when the servo patterns 47 are read by the servo read portions 62 of the servo write head 80, the output of the servo signals becomes the same for each servo burst corresponding to the group of servo patterns 47.

Accordingly, when the angle obtained by (θs1−θs2)/2 coincides with the angle at which the data write head 60 is tilted with respect to the width direction of the magnetic tape MT (Y axis direction) (reference angle), this magnetic tape MT can be regarded as the magnetic tape MT to be used in the data recording/reproducing device 50 of the type in which the data write head 60 is arranged to be tilted with respect to the width direction of the magnetic tape MT (Y axis direction).

### [Confirmation Method: Second Example]

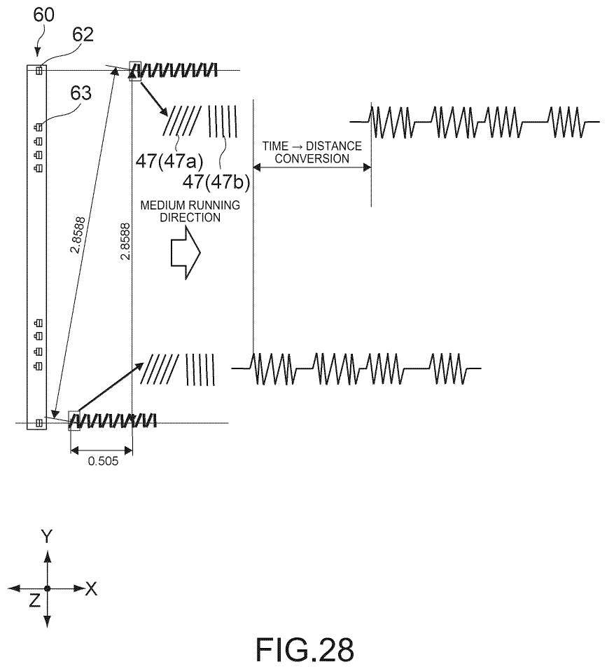

FIG. 28 is a diagram showing a second example of the method of confirming whether the magnetic tape MT is a magnetic tape MT to be used in the data-write-head-tilted-type data recording/reproducing device 50. In the second example, the confirmation described above is performed based on the positional difference between the servo patterns 47 in the adjacent servo bands.

The data recording/reproducing device is used in this second example, but in this data recording/reproducing device, the data write head 60 is arranged parallel to the width direction of the magnetic tape MT (Y axis direction).

First, the two servo read portions 62 of the data write head 60 read the servo patterns 47 in the adjacent servo bands, and the servo signals are reproduced.

The phase of the servo signal reproduced by the servo read portion 62 on the lower side is ahead of the phase of the servo signal reproduced by the servo read portion 62 on the upper side, resulting in a phase difference. At this time, a difference in clock time at which the same LPOS (Longitudinal Position) information has been read is obtained between the servo signal reproduced by the servo read portion 62 on the lower side and the servo signal reproduced by the servo read portion 62 on the upper side. Then, this difference in clock time is converted into a distance to obtain a phase difference d in the length direction of the magnetic tape (for example, 0.505 μm).

Next, based on the obtained phase difference d (for example, 0.505 μm) and the servo band pitch SP (known) (for example, 2.8588 μm), the predetermined angle is obtained by tan⁻¹(d/SP) (tan⁻¹(0.505/2.8588)=10.017°).

The angle obtained at this time corresponds to an angle formed between a straight line that connects positions where information regarding the same phase is written in the servo pattern 47 of one of the servo bands and the servo pattern 47 of the other one of the servo bands and the width direction of the magnetic tape.

Suppose that the angle obtained by tan⁻¹(d/SP) coincides with the angle at which the data write head 60 is tilted with respect to the width direction of the magnetic tape MT (Y axis direction) (reference angle) (tan⁻¹(d/SP)=refθ) (may include certain amount of error). In this case, the magnetic tape MT can be regarded as the magnetic tape MT to be used in the data recording/reproducing device 50 of the type in which the data write head 60 is arranged to be tilted with respect to the width direction of the magnetic tape MT (Y axis direction).

### (5) Operation and Effect

As explained in (2) of 2. above, in the magnetic tape MT according to the first embodiment, when the width change amount Δ of the magnetic tape MT is measured across the entire length of the magnetic tape MT after being stored at 65° C. for 360 hours, a sign of the width change amount Δout on the outer winding side of the magnetic tape MT and a sign of the width change amount Δin on the inner winding side of the magnetic tape MT differ. By the sign of the width change amount Δout on the outer winding side of the magnetic tape MT and the sign of the width change amount Δin on the inner winding side of the magnetic tape MT being different from each other, excellent running stability can be obtained even when stored under a high-temperature environment. In addition, the width change amount Δ is 0 ppm at the position of one of the two regions between which the center line of the entire length of the magnetic tape MT is situated, the two regions being from among four regions into which the entire length of the magnetic tape MT is quadrisected. Thus, excellent running stability can be obtained even when stored under a high-temperature environment. Furthermore, the width change amount Δ may be 300 ppm or less in any of the four regions in the longitudinal direction of the magnetic tape. Thus, even when the width of the magnetic tape MT changes under the high-temperature environment, it is possible to cope with shape changes due to changes in the temperature and humidity by adjusting the azimuth angle θ of the data write head.

As described in (4) of 2. above, the magnetic tape MT according to the first embodiment may include the plurality of servo bands s in each of which the servo patterns 47 including the first servo patterns 47a and the second servo patterns 47b that are asymmetric with respect to the width direction of the magnetic tape MT are written, and the servo patterns 47 in the adjacent servo bands s may have a phase difference. Therefore, the magnetic tape MT according to the first embodiment can be used in the data recording/reproducing device 50 that can cope with the width change of the magnetic tape MT by adjusting the azimuth angle θ of the data write head 60. Typically in the data recording/reproducing device 50, the azimuth angle θ of the data write head 60 becomes small when the width of the magnetic tape MT becomes relatively wide, and conversely, the azimuth angle θ of the data write head 60 becomes large when the width of the magnetic tape MT becomes relatively narrow. Thus, the servo patterns 47 of the magnetic tape MT can be accurately read even when the width of the magnetic tape MT changes.

Accordingly, even when the width of the magnetic tape MT changes under a high-temperature environment, it is possible to cope with the width change by adjusting the azimuth angle θ of the data write head 60.

As described above, according to the magnetic tape MT according to the first embodiment, it is possible to cope with the width change that may occur under a high-temperature environment. Accordingly, the magnetic tape MT according to the first embodiment is suited for the storage and running under a high-temperature environment.

### 3. SECOND EMBODIMENT (EXAMPLE OF MAGNETIC RECORDING CARTRIDGE INCLUDING VACUUM-THIN-FILM-TYPE MAGNETIC TAPE)

### (1) Configuration of Magnetic Recording Cartridge

The magnetic recording cartridge according to the present embodiment is the same as the magnetic recording cartridge 10 described in “(1) Configuration of magnetic cartridge” of 2. above except that it includes a vacuum thin-film type magnetic tape MT1 in place of the coating-type magnetic tape MT. Hereinafter, the vacuum thin-film-type magnetic tape MT1 will be described.

### (2) Configuration of Magnetic Tape

The first embodiment above has described the case where the magnetic tape MT is a coating-type magnetic tape in which the underlayer, the magnetic layer, and the like are produced by the coating process (wet process). However, the magnetic tape MT may alternatively be a vacuum thin-film-type magnetic tape in which the underlayer, the magnetic layer, and the like are produced by a vacuum thin film production technology (dry process) such as sputtering.

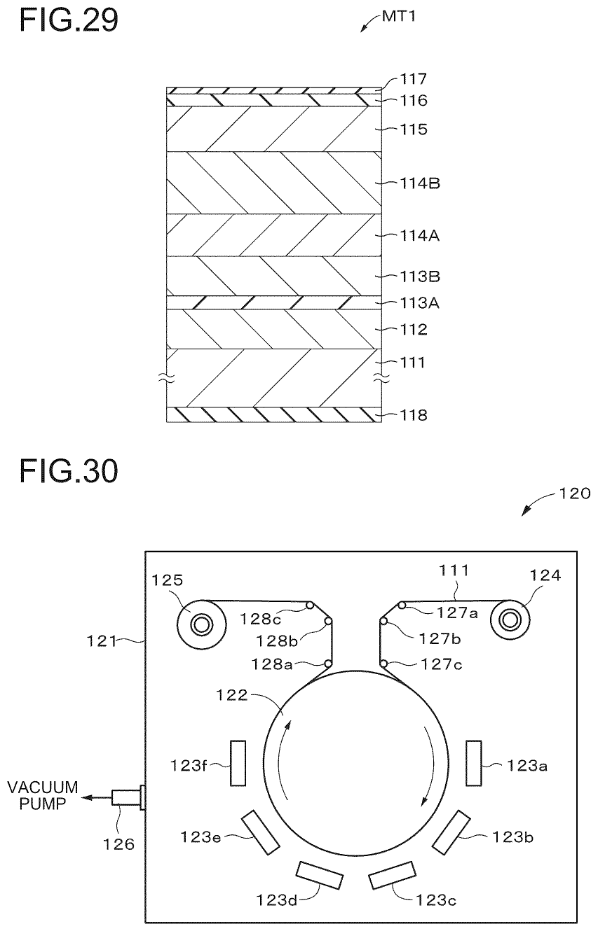

FIG. 29 is a cross-sectional view showing an exemplary configuration of a vacuum thin-film-type magnetic tape MT1 according to the second embodiment of the present technology. The magnetic tape MT1 is a vertical-recording-type magnetic recording medium and includes a film-like base layer 111, a soft magnetic underlayer (hereinafter, will be referred to as “SUL”) 112, a first seed layer 113A, a second seed layer 113B, a first underlayer 114A, a second underlayer 114B, and a magnetic layer 115 that is a recording layer. The SUL 112, the first and second seed layers 113A and 113B, the first and second underlayers 114A and 114B, and the magnetic layer 115 are each a vacuum thin film such as a sputtering film, for example.

The SUL 112, the first and second seed layers 113A and 113B, and the first and second underlayers 114A and 114B are provided between one of main surfaces (hereinafter referred to as “front surface”) of the base layer 111 and the magnetic layer 115, and are laminated in the order of the SUL 112, the first seed layer 113A, the second seed layer 113B, the first underlayer 114A, and the second underlayer 114B in a direction from the base layer 111 toward the magnetic layer 115.

The magnetic tape MT1 may further include a protective layer 116 provided on the magnetic layer 115 and a lubricating layer 117 provided on the protective layer 116 as necessary. Moreover, the magnetic tape MT1 may further include a back layer 118 provided on the other one of the main surfaces (hereinafter, will be referred to as “back surface”) of the base layer 111 as necessary.

Hereinafter, the longitudinal direction of the magnetic tape MT1 (the longitudinal direction of the base layer 111) will be referred to as MD (Machine Direction) direction. Herein, the MD direction refers to a relative movement direction of the recording and reproducing heads with respect to the magnetic tape MT1, that is, a direction in which the magnetic tape MT1 runs during recording/reproduction.

The magnetic tape MT1 according to the second embodiment is favorably used as a storage medium for data archives for which demand is expected to increase in the future. For example, this magnetic tape MT1 is capable of realizing a surface recording density that is 10 times or more than that of a current coating-type magnetic recording medium for storage, that is, a surface recording density of 50 Gb/in² or more. When a general linear-recording-type data cartridge is configured using the magnetic tape MT1 having such a surface recording density, a large capacity recording of 100 TB or more per data cartridge can be achieved.

The magnetic tape MT1 according to the second embodiment is favorably used in a recording/reproducing device (recording/reproducing device for recording and reproducing data) including a ring-type recording head and a giant magnetoresistive (Giant Magnetoresistive: GMR) type or tunneling magnetoresistive (Tunneling Magnetoresistive: TMR) type reproducing head. Further, it is favorable for the magnetic tape MT1 according to the second embodiment to be a magnetic tape for which a ring-type recording head is used as a servo signal writing head. Data signals are vertically recorded on the magnetic layer 115 by the ring-type recording head, for example. In addition, servo signals are vertically recorded on the magnetic layer 115 by the ring-type recording head, for example.

The average thickness t_{T} and width change amount of the magnetic tape MT1 according to the second embodiment, the storage elastic modulus and loss elastic modulus of the base layer 111, and the like are similar to those of the first embodiment.

### [Base Layer]

The base layer 111 is similar to the base layer 41 in the first embodiment.

### [SUL]

The SUL 112 contains a soft magnetic material in an amorphous state. The soft magnetic material includes at least one type selected from a Co-based material and an Fe-based material. The Co-based material includes, for example, CoZrNb, CoZrTa, or CoZrTaNb. The Fe-based material includes, for example, FeCoB, FeCoZr, or FeCoTa.

The SUL 112 is a single-layer SUL and is provided directly on the base layer 111. An average thickness of the SUL 112 is favorably 10 nm or more and 50 nm or less, more favorably 20 nm or more and 30 nm or less.

The average thickness of the SUL 112 is obtained similarly to the magnetic layer 43 in the first embodiment. It is noted that average thicknesses of the layers other than the SUL 112 (that is, the average thicknesses of the first and second seed layers 113A and 113B, the first and second underlayers 114A and 114B, and the magnetic layer 115) that are to be described later are also determined similarly to the magnetic layer 43 in the first embodiment. It is noted that the magnification of the TEM image is adjusted as appropriate in accordance with the thicknesses of the respective layers.

### [First and Second Seed Layers]

The first seed layer 113A contains an alloy containing Ti and Cr and is in an amorphous state. Further, this alloy may further contain O (oxygen). This oxygen may be impurity oxygen contained in a minute amount in the first seed layer 113A when the first seed layer 113A is formed by the film forming method such as the sputtering method.

Herein, the “alloy” refers to at least one type of a solid solution, a eutectic, and an intermetallic compound containing Ti and Cr, and the like. The “amorphous state” refers to a state where a halo is observed by an X-ray diffraction or electron diffraction method, or the like, and a crystal structure cannot be specified.

An atomic ratio of Ti to the total amount of Ti and Cr contained in the first seed layer 113A is favorably within the range of 30 atomic % or more and smaller than 100 atomic %, more favorably 50 atomic % or more and smaller than 100 atomic %. When the atomic ratio of Ti is smaller than 30%, a (100) plane of a body-centered cubic lattice (Body-Centered Cubic lattice: bcc) structure of Cr becomes oriented, and there is a fear that the orientation of the first and second underlayers 114A and 114B formed on the first seed layer 113A will be lowered.

The atomic ratio of Ti is obtained as follows. While ion milling the magnetic tape MT1 from the magnetic layer 115 side, a depth profile analysis (depth profile measurement) of the first seed layer 113A is performed by Auger electron spectroscopy (Auger Electron Spectroscopy; hereinafter, will be referred to as “AES”). Next, an average composition (average atomic ratio) of Ti and Cr in a film thickness direction is obtained from the obtained depth profile. Next, the atomic ratio of Ti is obtained using the obtained average composition of Ti and Cr.

When the first seed layer 113A contains Ti, Cr, and O, the atomic ratio of O to the total amount of Ti, Cr, and O contained in the first seed layer 113A is favorably 15 atomic % or less, more favorably 10 atomic % or less. When the atomic ratio of O exceeds 15 atomic %, there is a fear that TiO2 crystals will be generated to affect crystal nucleation of the first and second underlayers 114A and 114B formed on the first seed layer 113A, and the orientation of the first and second underlayers 114A and 114B will be lowered. The atomic ratio of O is obtained using an analysis method similar to that of the atomic ratio of Ti.

The alloy contained in the first seed layer 113A may further contain an element other than Ti and Cr as an additive element. Examples of the additive element include one or more types of elements selected from the group consisting of Nb, Ni, Mo, Al, W, and the like.

The average thickness of the first seed layer 113A is favorably 2 nm or more and 15 nm or less, more favorably 3 nm or more and 10 nm or less.

The second seed layer 113B contains, for example, NiW or Ta, and has a crystalline state. An average thickness of the second seed layer 113B is favorably 3 nm or more and 20 nm or less, more favorably 5 nm or more and 15 nm or less.

The first and second seed layers 113A and 113B have a crystal structure similar to that of the first and second underlayers 114A and 114B, and are not seed layers provided for the purpose of crystal growth, but are seed layers provided for improving the vertical orientation of the first and second underlayers 114A and 114B by the amorphous state of the first and second seed layers 113A and 113B.

### [First and Second Underlayers]

It is favorable for the first and second underlayers 114A and 114B to have crystal structures similar to that of the magnetic layer 115. When the magnetic layer 115 contains a Co-based alloy, it is favorable for the first and second underlayers 114A and 114B to contain a material having a hexagonal close-packed (hcp) structure similar to that of the Co-based alloy, and a c axis of that structure to be oriented in a vertical direction with respect to a film surface (that is, film thickness direction). This is because it enhances the orientation of the magnetic layer 115, and lattice constants of the second underlayer 114B and the magnetic layer 115 can be matched relatively favorably. As the material having a hexagonal close-packed (hcp) structure, it is favorable to use a material containing Ru, specifically, Ru alone or a Ru alloy is favorable. An example of the Ru alloy is Ru alloy oxide such as Ru-SiO₂, Ru—TiO₂, or Ru—ZrO₂.

As described above, the first and second underlayers 114A and 114B can be formed of similar materials. However, aimed effects of the first and second underlayers 114A and 114B differ. Specifically, the second underlayer 114B has a film structure that promotes a granular structure of the magnetic layer 115 as an upper layer thereof, and the first underlayer 114A has a film structure having high crystalline orientation. In order to obtain such film structures, it is favorable to use different film forming conditions such as sputtering conditions for the first and second underlayers 114A and 114B.

An average thickness of the first underlayer 114A is favorably 3 nm or more and 15 nm or less, more favorably 5 nm or more and 10 nm or less. An average thickness of the second underlayer 114B is favorably 7 nm or more and 40 nm or less, more favorably 10 nm or more and 25 nm or less.

### [Magnetic Layer]

The magnetic layer 115 is a perpendicular magnetic recording layer in which the magnetic material is oriented vertically. The magnetic layer 115 may be a vacuum thin film such as a sputtering film. From the viewpoint of improving the recording density, the magnetic layer 115 is favorably a granular magnetic layer containing a Co-based alloy. This granular magnetic layer is constituted of ferromagnetic crystal particles containing a Co-based alloy and non-magnetic grain boundaries (non-magnetic material) surrounding the ferromagnetic crystal particles. More specifically, this granular magnetic layer is constituted of columns (columnar crystals) containing a Co-based alloy and non-magnetic grain boundaries (for example, oxide such as SiO₂) that surround the columns and magnetically separate each of the columns. In this structure, the magnetic layer 115 having a structure in which each of the columns is magnetically separated can be formed.

The Co-based alloy has a hexagonal close-packed (hcp) structure, and a c-axis thereof is oriented in the vertical direction (film thickness direction) with respect to the film surface. As the Co-based alloy, it is favorable to use a CoCrPt-based alloy containing at least Co, Cr, and Pt. The CoCrPt-based alloy is not limited in particular, and the CoCrPt alloy may further contain an additive element. Examples of the additive element include one or more types of elements selected from the group consisting of Ni, Ta, and the like.

The non-magnetic grain boundaries surrounding the ferromagnetic crystal particles contain a non-magnetic metal material. Herein, metal includes semimetal. For example, at least one of metal oxide or metal nitride can be used as the non-magnetic metal material, and from the viewpoint of maintaining the granular structure more stably, it is favorable to use metal oxide. As the metal oxide, metal oxide containing at least one type of element selected from the group consisting of Si, Cr, Co, Al, Ti, Ta, Zr, Ce, Y, Hf, and the like is used, and metal oxide containing at least Si oxide (that is, SiO₂) is favorable. Specific examples of the metal oxide include SiO₂, Cr₂O₃, CoO, Al₂O₃, TiO₂, Ta₂O₅, ZrO₂, HfO₂, and the like. As the metal nitride, metal nitride containing at least one type of element selected from the group consisting of Si, Cr, Co, Al, Ti, Ta, Zr, Ce, Y, Hf, and the like is used. Specific examples of the metal nitride include SiN, TiN, AlN, and the like.

It is favorable for the CoCrPt-based alloy contained in the ferromagnetic crystal particles and the Si oxide contained in the non-magnetic grain boundaries to have an average composition expressed by the following formula (5). This is because an effect of a demagnetizing field can be suppressed and a saturation magnetization amount Ms with which a sufficient reproduction output can be secured can be realized, and thus further improvement of the recording/reproducing characteristics can be realized.

(CoₓPt_{y}C_{100-x-y})_{100-z}—(SiO₂)_{z} (5)

(In the formula (5), x, y, and z are values within ranges of 69≤X≤75, 10≤y≤16, and 9≤Z≤12, respectively.)

It is noted that the composition can be obtained as follows. While ion milling the magnetic tape MT1 from the magnetic layer 115 side, the depth profile analysis of the magnetic layer 115 is performed by AES, to obtain an average composition (average atomic ratio) of Co, Pt, Cr, Si and O in the film thickness direction.

An upper limit value of the average thickness of the magnetic layer 115 is, for example, 90 nm or less, favorably 80 nm or less, more favorably 70 nm or less, further more favorably 60 nm or less, particularly favorably 50 nm or less, 20 nm or less, or 15 nm or less. A lower limit value of the average thickness of the magnetic layer 115 is favorably 9 nm or more. When the average thickness of the magnetic layer 115 is 9 nm or more and 90 nm or less, the electromagnetic conversion characteristics can be improved.

The magnetic layer 115 includes a plurality of data bands in which data is written and a plurality of servo bands in which servo patterns are written. For details of the data bands and servo bands of the magnetic layer 115, the descriptions related to the data bands and servo bands in the first embodiment described in 1. (2) above can be applied. Therefore, the descriptions on the data bands and servo bands of the magnetic layer 115 will be omitted.

### [Protective Layer]

The protective layer 116 contains, for example, a carbon material or silicon dioxide (SiO₂), and favorably contains a carbon material from the viewpoint of a film strength of the protective layer 116. Examples of the carbon material include graphite, diamond-like carbon (Diamond-Like Carbon: DLC), diamond, and the like.

### [Lubricating Layer]

The lubricating layer 117 contains at least one type of lubricant. The lubricating layer 117 may further contain various additives, for example, a rust inhibitor, as necessary. A lubricant similar to that used in the magnetic layer 43 according to the first embodiment can be exemplified as the lubricant.

It is noted that the lubricant may not only be retained as the lubricating layer 117 on the surface of the magnetic tape MT1 as described above, but may also be contained and held in layers such as the magnetic layer 115 and the protective layer 116 constituting the magnetic tape MT1.

### [Back Layer]

The back layer 118 is similar to the back layer 44 in the first embodiment.

### (3) Configuration of Sputtering Device

Hereinafter, an exemplary configuration of a sputtering device 120 used in manufacturing the magnetic tape MT1 according to the second embodiment will be described with reference to FIG. 30. The sputtering device 120 is a continuous-winding-type sputtering device used to form the SUL 112, the first seed layer 113A, the second seed layer 113B, the first underlayer 114A, the second underlayer 114B, and the magnetic layer 115, and includes a film forming chamber 121, a drum 122 which is a metal can (rotating body), cathodes 123a to 123f, a supply reel 124, a take-up reel 125, and a plurality of guide rolls 127a to 127c and 128a to 128c. The sputtering device 120 is, for example, a device that uses a DC (direct current) magnetron sputtering method, but the sputtering method is not limited to this method.

The film forming chamber 121 is connected to a vacuum pump (not shown) via an exhaust port 126, and an atmosphere in the film forming chamber 121 is set to a predetermined vacuum level by the vacuum pump. The drum 122 configured to be rotatable, the supply reel 124, and the take-up reel 125 are arranged inside the film forming chamber 121. Inside the film forming chamber 121, the plurality of guide rolls 127a to 127c for guiding conveyance of the base layer 111 between the supply reel 124 and the drum 122 is provided, and the plurality of guide rolls 128a to 128c for guiding conveyance of the base layer 111 between the drum 122 and the take-up reel 125 is provided. During sputtering, the base layer 111 unwound from the supply reel 124 is reeled in by the take-up reel 125 via the guide rolls 127a to 127c, the drum 122, and the guide rolls 128a to 128c. The drum 122 has a cylindrical shape, and the elongated base layer 111 is conveyed along a cylindrical circumferential surface of the drum 122. The drum 122 is provided with a cooling mechanism (not shown) and is cooled to, for example, about −20° C. during sputtering. Inside the film formation chamber 121, the plurality of cathodes 123a to 123f is arranged so as to oppose the circumferential surface of the drum 122. A target is set in each of these cathodes 123a to 123f. Specifically, targets for forming the SUL 112, the first seed layer 113A, the second seed layer 113B, the first underlayer 114A, the second underlayer 114B, and the magnetic layer 115 are set in the cathodes 123a, 123b, 123c, 123d, 123e, and 123f, respectively. The plurality of types of films, that is, the SUL 112, the first seed layer 113A, the second seed layer 113B, the first underlayer 114A, the second underlayer 114B, and the magnetic layer 115, are formed by these cathodes 123a to 123f at the same time.

In the sputtering device 120 having the configuration described above, the SUL 112, the first seed layer 113A, the second seed layer 113B, the first underlayer 114A, the second underlayer 114B, and the magnetic layer 115 can be successively formed by a roll to roll method.

### (4) Manufacturing Method of Magnetic Tape

The magnetic tape MT1 according to the second embodiment can be manufactured as follows, for example.

First, the SUL 112, the first seed layer 113A, the second seed layer 113B, the first underlayer 114A, the second underlayer 114B, and the magnetic layer 115 are sequentially formed on the front surface of the base layer 111 using the sputtering device 120 shown in FIG. 30. Specifically, the films are formed as follows. First, the film forming chamber 121 is evacuated until reaching a predetermined pressure. After that, the targets set in the cathodes 123a to 123f are sputtered while introducing process gas such as Ar gas into the film forming chamber 121. Thus, the SUL 112, the first seed layer 113A, the second seed layer 113B, the first underlayer 114A, the second underlayer 114B, and the magnetic layer 115 are sequentially formed on the front surface of the running base layer 111.

The atmosphere in the film formation chamber 121 during sputtering is set to, for example, about 1×10⁻⁵ Pa to 5×10⁻⁵ Pa. The film thicknesses and characteristics of the SUL 112, the first seed layer 113A, the second seed layer 113B, the first underlayer 114A, the second underlayer 114B, and the magnetic layer 115 can be controlled by adjusting a tape line speed at which the base layer 111 is reeled in, a pressure of the process gas such as Ar gas to be introduced during sputtering (sputtering gas pressure), input power, and the like.

Next, the protective layer 116 is formed on the magnetic layer 115. As the film forming method of the protective layer 116, for example, a chemical vapor deposition (Chemical Vapor Deposition: CVD) method or a physical vapor deposition (physical vapor deposition: PVD) method can be used.

Next, a coating material for forming a back layer is prepared by kneading and dispersing a binding agent, inorganic particles, a lubricant, and the like in a solvent. Next, the coating material for forming a back layer is applied onto the back surface of the base layer 111 and dried so that the back layer 118 is formed on the back surface of the base layer 111.

Next, for example, a lubricant is applied onto the protective layer 116 to form the lubricating layer 117. As a method of applying a lubricant, various application methods such as gravure coating and dip coating can be used, for example. Next, the magnetic tape MT1 is cut to a predetermined width as necessary. Thus, the magnetic tape MT1 shown in FIG. 29 is obtained.

### (5) Operation and Effect

The descriptions on the operation and effect described in (5) of 2. above also applies to the second embodiment. That is, similar to the first embodiment, the magnetic tape MT1 according to the second embodiment can cope with a width change that may occur under a high-temperature environment. Accordingly, the magnetic tape MT1 according to the second embodiment is suited for storage and running under a high-temperature environment.

### 4. THIRD EMBODIMENT (EXAMPLE OF MAGNETIC RECORDING CARTRIDGE INCLUDING VACUUM-THIN-FILM-TYPE MAGNETIC TAPE)

### (1) Configuration of Magnetic Recording Cartridge

The magnetic recording cartridge according to the present embodiment is the same as the magnetic recording cartridge 10 described in “(1) Configuration of magnetic cartridge” of 2. above except that a vacuum thin-film-type magnetic tape MT2 is provided instead of the coating-type magnetic tape MT. Hereinafter, the vacuum thin-film-type magnetic tape MT2 will be described.

### (2) Configuration of Magnetic Tape

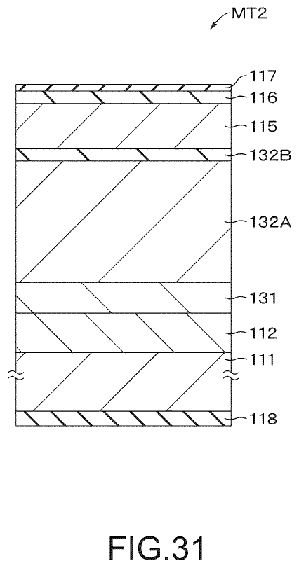

FIG. 31 is a cross-sectional view showing an exemplary configuration of a vacuum thin-film-type magnetic tape MT2 according to a third embodiment of the present technology. The magnetic tape MT2 includes the base layer 111, the SUL 112, a seed layer 131, a first underlayer 132A, a second underlayer 132B, and the magnetic layer 115. It is noted that in the third embodiment, parts similar to those of the second embodiment are denoted by the same reference symbols, and descriptions thereof will be omitted.

The SUL 112, the seed layer 131, and the first and second underlayers 132A and 132B are provided between one of the main surfaces of the base layer 111 and the magnetic layer 115 and are laminated in the order of the SUL 112, the seed layer 131, the first underlayer 132A, and the second underlayer 132B in the direction from the base layer 111 toward the magnetic layer 115.

### [Seed Layer]

The seed layer 131 contains Cr, Ni, and Fe, has a face centered cubic lattice (fcc) structure, and is preferentially oriented such that a (111) plane of this face centered cubic structure becomes parallel to the front surface of the base layer 111. Herein, the preferential orientation refers to a state where a diffraction peak intensity from the (111) plane of the face centered cubic lattice structure is larger than diffraction peaks from other crystal planes in 0-2θ scan of the X-ray diffraction method, or a state where only the diffraction peak intensity from the (111) plane of the face centered cubic lattice structure is observed in the θ-2θ scan of the X-ray diffraction method.

From the viewpoint of improving the SNR, an intensity ratio of the X-ray diffraction of the seed layer 131 is favorably 60 cps/nm or more, more favorably 70 cps/nm or more, further more favorably 80 cps/nm or more. Herein, the intensity ratio of the X-ray diffraction of the seed layer 131 is a value obtained by dividing an intensity I (cps) of the X-ray diffraction of the seed layer 131 by an average thickness D (nm) of the seed layer 131 (I/D (cps/nm)).

It is favorable for Cr, Ni, and Fe contained in the seed layer 131 to have an average composition expressed by the following formula (6).

Cr_{X}(Ni_{Y}Fe_{100-Y})_{100-X} (6)

(provided that in the formula (6), X is within the range of 10≤X≤45, and Y is within the range of 60≤Y≤90.)

When X is within the range described above, the (111) orientation of the face centered cubic lattice structure of Cr, Ni, and Fe is improved, and more favorable SNR can be obtained. Similarly, when Y is within the range described above, the (111) orientation of the face centered cubic lattice structure of Cr, Ni, and Fe is improved, and more favorable SNR can be obtained.

The average thickness of the seed layer 131 is favorably 5 nm or more and 40 nm or less. By setting the average thickness of the seed layer 131 within this range, the (111) orientation of the face centered cubic lattice structure of Cr, Ni, and Fe is improved, and more favorable SNR can be obtained. It is noted that the average thickness of the seed layer 131 is obtained similarly to the magnetic layer 43 according to the first embodiment. It is noted that the magnification of the TEM image is adjusted as appropriate in accordance with the thickness of the seed layer 131.

### [First and Second Underlayers]

The first underlayer 132A contains Co and O having a face centered cubic lattice structure, and has a column (columnar crystal) structure. The first underlayer 132A containing Co and o has an effect (function) substantially similar to that of the second underlayer 132B containing Ru. A concentration ratio of an average atomic concentration of O to an average atomic concentration of Co ((average atomic concentration of O)/(average atomic concentration of Co)) is 1 or more. When the concentration ratio is 1 or more, the effect of providing the first underlayer 132A is improved, and more favorable SNR can be obtained.

From the viewpoint of improving the SNR, it is favorable for the column structure to be tilted. It is favorable for the tilt direction to be the longitudinal direction of the elongated magnetic tape MT2. The reason why the longitudinal direction is favorable in this manner is because of the following reasons. The magnetic tape MT2 according to the present embodiment is a so-called magnetic recording medium for linear recording, and the recording track is parallel to the longitudinal direction of the magnetic tape MT2. Further, the magnetic tape MT2 according to the present embodiment is also a so-called perpendicular magnetic recording medium, and from the viewpoint of recording characteristics, it is favorable for a crystalline orientation axis of the magnetic layer 115 to be in the vertical direction, but the crystalline orientation axis of the magnetic layer 115 may be tilted by the effect of the tilt of the column structure of the first underlayer 132A. In the magnetic tape MT2 for linear recording, in relation to the head magnetic field during recording, a configuration in which the crystalline orientation axis of the magnetic layer 115 is tilted in the longitudinal direction of the magnetic tape MT2 can reduce the effect of the tilt of the crystalline orientation axis on the recording characteristics as compared to a configuration in which the crystalline orientation axis of the magnetic layer 115 is tilted in the width direction of the magnetic tape MT2. For causing the crystalline orientation axis of the magnetic layer 115 to tilt in the longitudinal direction of the magnetic tape MT2, it is favorable for the tilt direction of the column structure of the first underlayer 132A to be set in the longitudinal direction of the magnetic tape MT2 as described above.

A tilt angle of the column structure is favorably larger than 0° and equal to or smaller than 60°. When the tilt angle is within the range of larger than 0° and equal to or smaller than 60°, a change in the shape of the tip end of the column included in the first underlayer 132A is large and becomes an almost triangular mountain shape, so there is a tendency that the effect of the granular structure is enhanced, noises are reduced, and the SNR is improved. On the other hand, when the tilt angle exceeds 60°, the change in the shape of the tip end of the column included in the first underlayer 132A is small and difficult to become the almost triangular mountain shape, so the noise reduction effect tends to be weakened.

An average particle size of the column structure is 3 nm or more and 13 nm or less. When the average particle size is smaller than 3 nm, the average particle size of the column structure included in the magnetic layer 115 becomes small, and thus there is a fear that an ability to retain records will be lowered with the current magnetic material. On the other hand, when the average particle size is 13 nm or less, noises can be suppressed, and more favorable SNR can be obtained.

An average thickness of the first underlayer 132A is favorably 10 nm or more and 150 nm or less. When the average thickness of the first underlayer 132A is 10 nm or more, the (111) orientation of the face centered cubic lattice structure of the first underlayer 132A is improved, and more favorable SNR can be obtained. On the other hand, when the average thickness of the first underlayer 132A is 150 nm or less, the particle size of the column can be suppressed from becoming large. Accordingly, noises can be suppressed, and more favorable SNR can be obtained. It is noted that the average thickness of the first underlayer 132A is obtained similarly to the magnetic layer 43 according to the first embodiment. It is noted that the magnification of the TEM image is adjusted as appropriate in accordance with the thickness of the first underlayer 132A.

It is favorable for the second underlayer 132B to have a crystal structure similar to that of the magnetic layer 115. When the magnetic layer 115 contains a Co-based alloy, it is favorable for the second underlayer 132B to contain a material having a hexagonal close-packed (hcp) structure similar to the Co-based alloy, and the c axis of the structure to be oriented in the vertical direction (that is, film thickness direction) with respect to the film surface. This is because the orientation of the magnetic layer 115 can be enhanced, and lattice constants of the second underlayer 132B and the magnetic layer 115 can be matched relatively favorably. As the material having the hexagonal close-packed structure, it is favorable to use a material containing Ru, specifically, Ru alone or a Ru alloy is favorable. An example of the Ru alloy is Ru alloy oxide such as Ru—SiO₂, Ru—TiO₂, or Ru—ZrO₂.

The average thickness of the second underlayer 132B may be smaller than that of an underlayer in a general magnetic recording medium (for example, underlayer containing Ru), and can be set to be 1 nm or more and 5 nm or less, for example. Since the seed layer 131 and the first underlayer 132A having the configurations described above are provided below the second underlayer 132B, favorable SNR can be obtained even when the average thickness of the second underlayer 132B is small as described above. It is noted that the average thickness of the second underlayer 132B is obtained similarly to the magnetic layer 43 according to the first embodiment. It is noted that the magnification of the TEM image is adjusted as appropriate in accordance with the thickness of the second underlayer 132B.

The average thickness tT and width change amount of the magnetic tape MT2 according to the third embodiment, the loss elastic modulus of the base layer 111, and the like are similar to those of the first embodiment.

The data bands and servo bands of the magnetic layer 115 according to the third embodiment are similar to those of the first embodiment. That is, for details of the data bands and servo bands of the magnetic layer 115 according to the third embodiment, the descriptions given in 2. (2) above can be applied.

### (3) Operation and Effect

The descriptions on the operation and effect described in (5) of 2. above also applies to the third embodiment. That is, similar to the first embodiment, the magnetic tape MT2 according to the third embodiment can cope with a width change that may occur under a high-temperature environment. Accordingly, the magnetic tape MT2 according to the third embodiment is suited for storage and running under a high-temperature environment.

The magnetic tape MT2 according to the third embodiment includes the seed layer 131 and the first underlayer 132A between the base layer 111 and the second underlayer 132B. The seed layer 131 contains Cr, Ni, and Fe, has a face centered cubic lattice structure, and is preferentially oriented such that the (111) plane of this face centered cubic structure becomes parallel to the front surface of the base layer 111. The first underlayer 132A contains Co and O and has a column structure in which the ratio of the average atomic concentration of 0 to the average atomic concentration of Co is 1 or more and the average particle size is 3 nm or more and 13 nm or less. Thus, the magnetic layer 115 having favorable crystalline orientation and a high coercive force can be realized by reducing the thickness of the second underlayer 132B and without using Ru which is an expensive material as much as possible.

Ru contained in the second underlayer 132B has the same hexagonal close-packed lattice structure as Co as a main component of the magnetic layer 115. Therefore, Ru has an effect of improving the crystalline orientation of the magnetic layer 115 and promoting granularity at the same time. In addition, for further improving the crystalline orientation of Ru contained in the second underlayer 132B, the first underlayer 132A and the seed layer 131 are provided below the second underlayer 132B. In the magnetic tape MT2 according to the third embodiment, an effect (function) substantially similar to that of the second underlayer 132B containing Ru is realized by the first underlayer 132A containing inexpensive CoO having a face centered cubic lattice structure. Therefore, the thickness of the second underlayer 132B can be made thin. In addition, the seed layer 131 containing Cr, Ni, and Fe is provided for improving the crystalline orientation of the first underlayer 132A.

### 5. MODIFIED EXAMPLES

### Modified Example 1

Although the first embodiment above has described the case where the magnetic tape cartridge is the single-reel-type magnetic tape cartridge 10, the magnetic tape cartridge may alternatively be a two-reel-type cartridge.

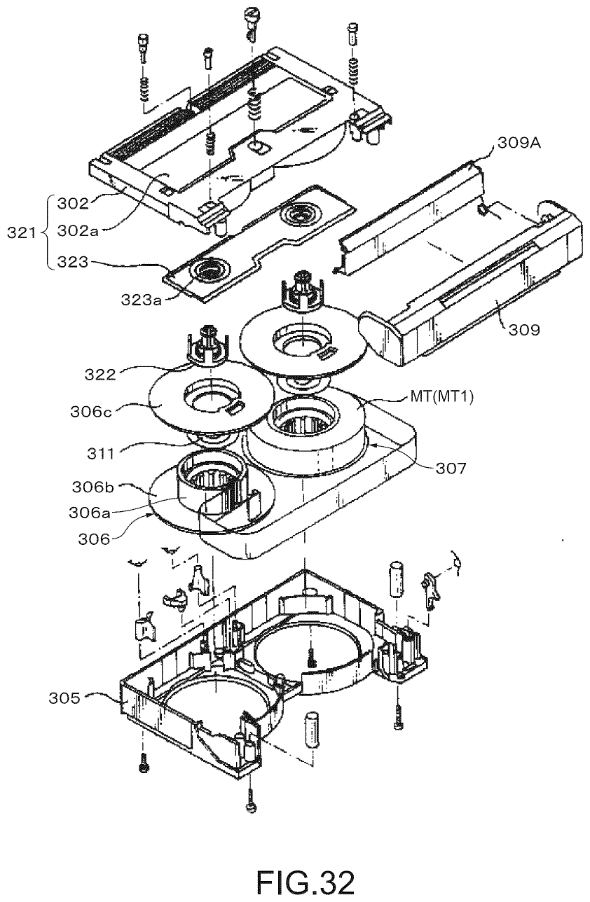

FIG. 32 is an exploded perspective view showing an exemplary configuration of a two-reel-type cartridge 321. The cartridge 321 includes: an upper half 302 formed of a synthetic resin; a transparent window member 323 fit into and fixed to a window portion 302a opened on an upper surface of the upper half 302; reel holders 322 which are fixed on an inner side of the upper half 302 and prevent an uplift of reels 306 and 307; a lower half 305 corresponding to the upper half 302; the reels 306 and 307 accommodated in a space formed by combining the upper half 302 and the lower half 305; the magnetic tape MT wound around the reels 306 and 307; a front lid 309 that closes a front-side opening portion formed by combining the upper half 302 and the lower half 305; and a back lid 309A which protects the magnetic tape MT exposed from the front-side opening portion.

The reels 306 and 307 are for winding up the magnetic tape MT. The reel 306 includes a lower flange 306b including, at a center portion thereof, a cylindrical hub portion 306a around which the magnetic tape MT is wound, an upper flange 306c having substantially the same size as the lower flange 306b, and a reel plate 311 situated between the hub portion 306a and the upper flange 306c. The reel 307 has a configuration similar to that of the reel 306.

In the window member 323, at positions respectively corresponding to the reels 306 and 307, attachment holes 323a for assembling the reel holders 322 as reel retention means for preventing an uplift of these reels are provided, respectively. The magnetic tape MT is similar to the magnetic tape MT in the first embodiment.

### Modified Example 2

The magnetic tape MT1 according to the second embodiment may further include an underlayer between the base layer 111 and the SUL 112. Since the SUL 112 has an amorphous state, the SUL 112 does not take a role in promoting epitaxial growth of the layers formed on the SUL 112, but the SUL 112 is required not to disturb the crystalline orientation of the first and second underlayers 114A and 114B formed above the SUL 112. For this purpose, it is favorable for the soft magnetic material to have a fine structure that does not form columns, but when an effect of degassing such as moisture from the base layer 111 is large, there is a fear that the soft magnetic material will become coarse to thus disturb the crystalline orientation of the first and second underlayers 114A and 114B formed above the SUL 112. In order to suppress the effect of degassing such as moisture from the base layer 111, it is favorable to provide an underlayer that contains an alloy containing Ti and Cr and has an amorphous state between the base layer 111 and the SUL 112 as described above. As a specific configuration of this underlayer, a configuration similar to that of the first seed layer 113A of the second embodiment can be adopted.

The magnetic tape MT1 does not need to include at least one of the second seed layer 113B or the second underlayer 114B. It is noted that from the viewpoint of improving the SNR, it is more favorable to include both the second seed layer 113B and the second underlayer 114B.

The magnetic tape MT1 may include an APC-SUL (Antiparallel Coupled SUL) in place of the single-layer SUL.

### 6. EXAMPLES

Hereinafter, the present technology will be specifically described by way of examples, but the present technology is not limited to these examples.

In the following examples and comparative examples, the loss elastic modulus of the base layer of the magnetic tape is a value obtained by the measurement method described in the first embodiment.

### [Width Change Amount]

The width change amount was obtained by the measurement method described in the first embodiment.

### [Method of Calculating Movement Angle of Drive Head Arranged to be Tilted]

FIG. 41 is a schematic diagram for explaining a method of calculating a movement angle of a drive head that is arranged to be tilted. The movement angle is a movement angle of the drive head requisite for coping with a width change when assuming storage under a high-temperature environment.

The left side of FIG. 41 shows the interval (h) between the two servo read heads of the drive head, the servo band pitch (SP), and the tilt angle (10°) of the drive head in the initial (before width change) magnetic tape. In the case of the left side of FIG. 35, Cos 10°=SP/h is obtained.

The right side of FIG. 41 shows the servo band pitch (SP−ΔSP), the drive head movement angle (α), and the tilt angle after the movement of the drive head (10°+α) in the magnetic tape after the servo band pitch has been narrowed (after width change). In the case of the right side of FIG. 41, Cos(10°+α)=(SP−ΔSP)/h is obtained. From this equation, the drive head movement angle (α) is calculated as follows.

10°+α=Cos⁻¹[(SP−ΔSP)/h]

α=Cos⁻[(SP−ΔSP)/h]−10°

[Running Characteristics after Rewinding and Long-Term Storage]

After storing the magnetic recording cartridge for two weeks at 65° C. and 40% RH, the outer winding side and inner winding side of the magnetic tape were reversed in a state where the magnetic tape is reeled in by the take-up reel 52 of the data recording/reproducing device 50, and the magnetic tape was further stored for two weeks. After that, entire-surface recording/reproduction of the magnetic tape was performed using the data recording/reproducing device 50, and determination values were given based on the following criteria of three levels regarding running characteristics. It is noted that evaluations “B, C” indicate undesirable determination results. When capable of performing the entire-surface recording/reproduction of the magnetic tape, a width change amount of a data band at a center portion of the magnetic tape in the width direction, in the width direction, from before storage was measured, and a difference between a portion with the smallest width and a portion with the largest width was calculated.
A: No anomaly (no occurrence of failure).
B: After running several times, servo cannot be read, and system stops due to error.
C: Servo cannot be read, and system stops immediately due to error.

### Example 1

### (Preparation Process of Coating Material for Forming Magnetic Layer)

The coating material for forming a magnetic layer was prepared as follows. First, a first composition of the following content was kneaded with an extruder. Next, the kneaded first composition and a second composition of the following content were added to a stirring tank equipped with a disperser and premixed. Then, dyno mill mixing was further performed and filter processing was performed, to prepare the coating material for forming a magnetic layer.

### (First Composition)

Barium ferrite (BaFe₁₂O₁₉) magnetic powder (hexagonal plate shape, average aspect ratio 3.0, average particle volume 1600 nm³): 100 parts by mass
Vinyl chloride-based resin (cyclohexanone solution 30 mass %): 35 parts by mass
(Vinyl chloride-based resin: polymerization degree 300, number average molecular weight Mn=10000, contains, as polar groups, OSO₃K=0.07 mmol/g and secondary OH=0.3 mmol/g.)
Polyurethane resin (resin solution: polyurethane resin content 30 mass %, cyclohexanone content 70 mass %): 10 parts by mass
(Polyurethane resin: number average molecular weight Mn=25000, glass transition temperature Tg=110° C.) Aluminum oxide powder: 7.5 parts by mass (α-Al₂O₃, average particle size 80 μm)

### (Second Composition)

Carbon black: 2.0 parts by mass (product name: SEAST S, manufactured by Tokai Carbon Co., Ltd., arithmetic average particle size 70 nm)
Polyurethane resin (resin solution: polyurethane resin content 30 mass %, cyclohexanone content 70 mass %): 5.0 parts by mass
(Polyurethane resin: number average molecular weight Mn=25000, glass transition temperature Tg=110° C.) n-butyl stearate: 2 parts by mass
Methyl ethyl ketone: 121.0 parts by mass
Toluene: 121.0 parts by mass
Cyclohexanone: 116.0 parts by mass

To the coating material for forming a magnetic layer that has been prepared as described above, polyisocyanate (product name: Coronate L, manufactured by Tosoh Corporation): 3.3 parts by mass and stearic acid: 2 parts by mass were added as a curing agent.

### (Preparation Process of Coating Material for Forming Underlayer)

The coating material for forming an underlayer was prepared as follows. First, a third composition of the following content was kneaded with an extruder. Next, the kneaded third composition and a fourth composition of the following content were added to a stirring tank equipped with a disperser and premixed. Then, dyno mill mixing was further performed and filter processing was performed, to prepare the coating material for forming an underlayer.

(Third composition)
Acicular iron oxide powder: 100 parts by mass
(α-Fe₂O₃, average long axis length 0.11 μm)
Vinyl chloride-based resin (cyclohexanone solution 30 mass %): 46 parts by mass
(Vinyl chloride-based resin: polymerization degree 300, number average molecular weight Mn=10000, contains, as polar groups, OSO₃K=0.07 mmol/g, secondary OH=0.3 mmol/g)
Aluminum oxide powder: 3 parts by mass (α-Al₂O₃, average particle size 0.1 μm)

### (Fourth Composition)

Carbon black: 30 parts by mass (product name: #80, manufactured by Asahi Carbon Co., Ltd.)
Polyurethane resin (resin solution: polyurethane resin content 30 mass %, cyclohexanone content 70 mass %): 40 parts by mass
(Polyurethane resin: number average molecular weight Mn=25000, glass transition temperature Tg=110° C.) n-butyl stearate: 2 parts by mass
Methyl ethyl ketone: 108.2 parts by mass
Toluene: 108.2 parts by mass
Cyclohexanone: 100.0 parts by mass

To the coating material for forming an underlayer that has been prepared as described above, polyisocyanate (product name: Coronate L, manufactured by Tosoh Corporation): 1.5 parts by mass and stearic acid: 1.5 parts by mass were added as a curing agent.

### (Preparation Process of Coating Material for Forming Back Layer)

The coating material for forming a back layer was prepared as follows. The following raw materials were mixed in a stirring tank equipped with a disperser, and filter processing was performed, to prepare the coating material for forming a back layer. Carbon black (product name: #80, manufactured by Asahi Carbon Co., Ltd.): 100 parts by mass
Polyester polyurethane: 100 parts by mass
(product name: N-2304, manufactured by Nippon Polyurethane Industry Co., Ltd.,)
Methyl ethyl ketone: 500 parts by mass
Toluene: 400 parts by mass
Cyclohexanone: 100 parts by mass

### (Film Forming Process)

Using the coating materials prepared as described above, an underlayer and a magnetic layer were formed as follows on one of main surfaces of an elongated polymer film as a non-magnetic supporting body.

First, the coating material for forming an underlayer was applied onto the polymer film to be a base layer and dried, to form the underlayer. At this time, application conditions were adjusted so that the average thickness of the underlayer after calender processing becomes 0.82 μm. As the polymer film, reinforced PET (product name “SPALTAN”®, manufactured by Toray Industries, Inc.) having an average thickness of 4.0 μm was used.

Next, the coating material for forming a magnetic layer was applied onto the underlayer and dried, to form the magnetic layer on the underlayer. At this time, the application conditions were adjusted so that the average thickness of the magnetic layer after calender processing becomes 0.08 μm. During drying of the coating material for forming a magnetic layer, a magnetic field of the magnetic powder was oriented in the thickness direction of the polymer film by a neodymium magnet. Drying conditions (drying temperature and drying time) for the coating material for forming a magnetic layer were adjusted, and a squareness ratio in the longitudinal direction was set to 34%.

Subsequently, the coating material for forming a back layer was applied onto the other one of the main surfaces of the reinforced PET film on which the underlayer and the magnetic layer have been formed and dried, to form the back layer. At this time, the application conditions were adjusted so that the average thickness of the back layer after the calender processing becomes 0.3 μm. Thus, a magnetic tape was obtained.

### (Curing Process)

Next, the magnetic tape was wound in a roll, and then the magnetic tape was subjected to heat processing in this state to cure the underlayer and the magnetic layer.

### (Calender Processing)

Next, the obtained magnetic tape was subjected to calender processing to smoothen a surface of the magnetic layer.

### (Cutting Process)

The magnetic tape obtained as described above was cut to a width of ½ inch (12.65 mm). Thus, a desired elongated magnetic tape (average thickness of 5.3 μm) was obtained. The magnetic tape obtained as described above had characteristics shown in Table 1 and Table 2. For example, the loss elastic modulus of the base layer of the magnetic tape at 65° C. was 0.07 GPa.

### (Demagnetization Process and Servo Pattern Writing Process)

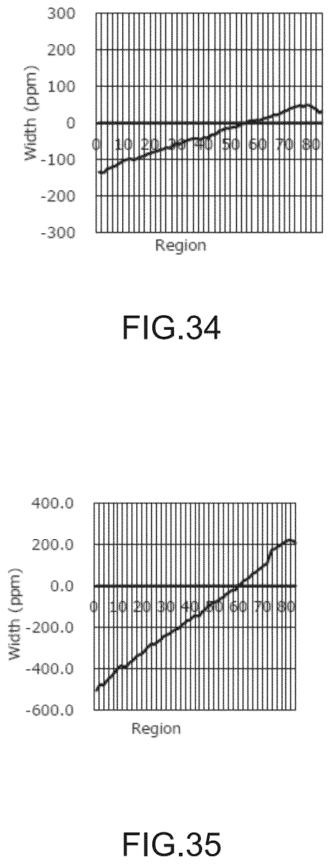

The magnetic tape having the width of ½ inch was wound around a reel provided inside a cartridge case to obtain a magnetic recording cartridge. After demagnetizing the magnetic tape, servo patterns were written on the magnetic tape. The servo patterns included first servo patterns and second servo patterns asymmetric with respect to the width direction of the magnetic tape. In addition, the servo patterns in the adjacent servo bands had a phase difference. After storing the magnetic tape at 65° C. and 40 RH % for 360 hours in a state where the magnetic tape is wound into the magnetic recording cartridge with a tension of 0.55 N, the servo band pitch was measured while running the magnetic tape accommodated in the magnetic recording cartridge, so that the magnetic tape is wound into a magnetic recording/reproducing device (while running the magnetic tape in a so-called forward direction). Further, the servo band pitch in the longitudinal direction was also similarly measured for the magnetic tape accommodated in the magnetic recording cartridge in the initial state before storage, and a width change amount expressed by a ratio between the servo band pitch after storage and the servo band pitch in the initial state was calculated. The results are shown in FIG. 34. In FIG. 34, the abscissa axis represents a position in the longitudinal direction of the magnetic tape. In FIG. 34, with a position of an end portion (BOT) on an outer circumferential side (outer winding side) of the magnetic tape wound on the tape reel being set as 0 and a position of an end portion (hereinafter, will also be referred to as EOT) on an inner circumferential side (inner winding side) of the magnetic tape wound on the tape reel being set as 84, the entire length of the magnetic tape was divided into 84 equal regions. In FIG. 34, the ordinate axis represents the width change amount after storage at 65° C. and 40 RH % for 360 hours, and represents width after storage/width before storage. In FIG. 34, when the width change amount exhibits a negative value, it means that the width of the magnetic tape has become narrower after storage than before storage, and when the width change amount exhibits a positive value, it means that the width of the magnetic tape has become wider after storage than before storage. It is noted that the descriptions on the abscissa axis and the ordinate axis in FIG. 34 also apply to FIGS. 35 to 40. As shown in FIG. 34, the width change amounts on the outer winding side at positions 0 to 20 exhibited negative values, the width change amounts on the inner winding side at positions 60 to 84 exhibited positive values, and the width change amount was 0 ppm between positions 55 and 56.

### Example 2a

A magnetic tape was obtained by the same method as in Example 1 except that a polyethylene naphthalate film (hereinafter, will be referred to as “PEN film”) was used as the base layer material. In the same manner as in Example 1, a magnetic recording cartridge was manufactured using the magnetic tape, and servo patterns were recorded onto the magnetic tape. Results of the width change amount in the longitudinal direction of the magnetic tape are shown in FIG. 35. As shown in FIG. 35, the width change amounts on the outer winding side at positions 0 to 20 exhibited negative values, the width change amounts on the inner winding side at positions 60 to 84 exhibited positive values, and the width change amount was 0 ppm between positions 59 and 60.

### Example 2b

A magnetic tape was obtained by the same method as in Example 2a except that an additive amount of aluminum oxide powder of the magnetic layer was 5.0 parts by mass, and a calender temperature was set to be 10° C. higher than that of Example 2a. In the same manner as in Example 1, a magnetic recording cartridge was manufactured using the magnetic tape, and servo patterns were recorded onto the magnetic tape.

### Example 2c

A magnetic tape was obtained by the same method as in Example 2a except that the size of aluminum oxide powder of the magnetic layer was set to 50 nm, and the calender temperature was set to be 10° C. higher than that of Example 2a. In the same manner as in Example 1, a magnetic recording cartridge was manufactured using the magnetic tape, and servo patterns were recorded onto the magnetic tape.

### Example 2b

A magnetic tape was obtained by the same method as in Comparative Example 1a except that the additive amount of aluminum oxide powder of the magnetic layer was 5.0 parts by mass, and the calender temperature was set to be 5° C. lower than that of Comparative Example 1a. In the same manner as in Example 1, a magnetic recording cartridge was manufactured using the magnetic tape, and servo patterns were recorded onto the magnetic tape.

### Example 3

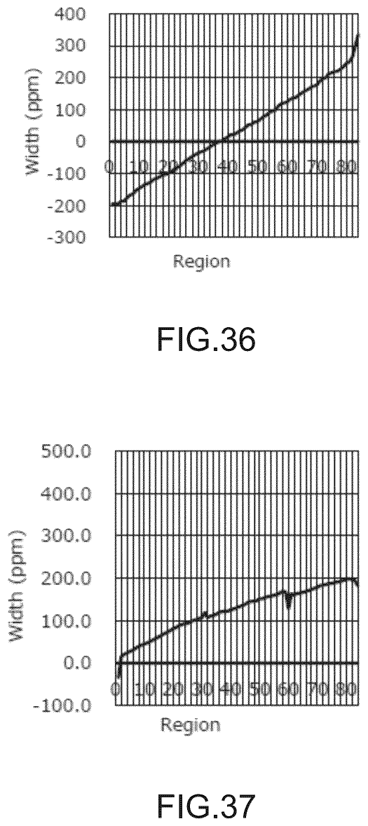

A magnetic tape was obtained by the same method as in Example 1 except that a polyether ether ketone film (hereinafter, will be referred to as “PEEK film”) was used as the base layer material, the average thickness of the back layer was set to 0.4 μm, and the average total thickness was set to 5.3 μm. In the same manner as in Example 1, a magnetic recording cartridge was manufactured using the magnetic tape, and servo patterns were recorded onto the magnetic tape. Results of the width change amount in the longitudinal direction of the magnetic tape are shown in FIG. 36. As shown in FIG. 36, the width change amounts on the outer winding side at positions 0 to 20 exhibited negative values, the width change amounts on the inner winding side at positions 60 to 84 exhibited positive values, and the width change amount was 0 ppm between positions 37 and 38.

### Comparative Example 1a

A magnetic tape was obtained by the same method as in Example 2a except that the size of aluminum oxide powder of the magnetic layer was set to 50 nm, and the calender temperature was set to be 10° C. lower than that of Comparative Example 1a. Results of the width change amount in the longitudinal direction of the magnetic tape are shown in FIG. 37. As shown in FIG. 37, the width change amounts on the outer winding side at positions 0 to 20 exhibited positive values, and the width change amounts on the inner winding side at positions 60 to 84 also exhibited positive values.

### Comparative Example 1b

A tape was obtained by the same method as in Comparative Example 1a except that the size and additive amount of aluminum oxide powder of the magnetic layer were respectively set to 50 nm and 5.0 parts by mass, and the calender temperature was set to be 5° C. lower than that of Comparative Example 1a.

### Comparative Example 2

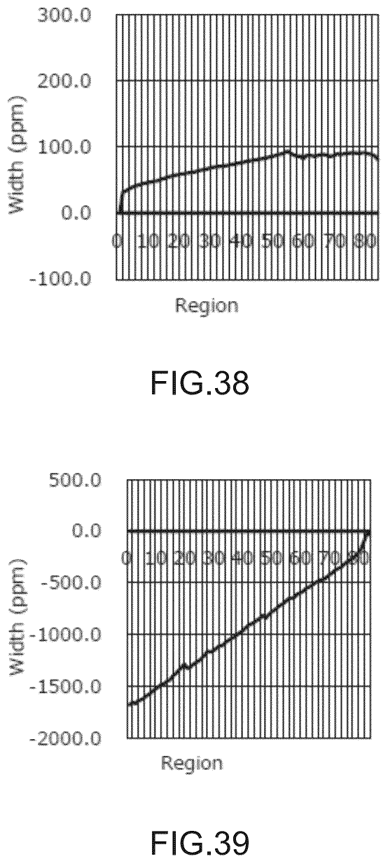

A magnetic tape was obtained by the same method as in Example 1 except that the average thickness of the base layer was set to 4.0 μm, the average thickness of the magnetic layer and the underlayer was set to 1.2 μm, the average thickness of the back layer was set to 0.4 μm, the average total thickness was set to 5.6 μm, a resin with Tg of 70° C. was used as a polyurethane-based resin to be mixed with the coating material for forming a magnetic layer and the coating material for forming an underlayer, 1.7 parts by mass of polyisocyanate (product name: Coronate L, manufactured by Tosoh Corporation) was added as a curing agent to the coating material for forming a magnetic layer, and 0.75 parts by mass of polyisocyanate (product name: Coronate L, manufactured by Tosoh Corporation) was added as a curing agent to the coating material for forming an underlayer. In the same manner as in Example 1, a magnetic recording cartridge was manufactured using the magnetic tape, and servo patterns were recorded onto the magnetic tape. Results of the width change amount in the longitudinal direction of the magnetic tape are shown in FIG. 38. As shown in FIG. 38, the width change amounts on the outer winding side at positions 0 to 20 exhibited positive values, and the width change amounts on the inner winding side at positions 60 to 84 also exhibited positive values.

### Comparative Example 3

A magnetic tape was obtained by the same method as in Example 2a except that a resin with Tg of 70° C. was used as the polyurethane-based resin to be mixed with the coating material for forming a magnetic layer and the coating material for forming an underlayer, and polyisocyanate was not added as the curing agent to the coating material for forming an underlayer. In the same manner as in Example 2a, a magnetic recording cartridge was manufactured using the magnetic tape, and servo patterns were recorded onto the magnetic tape. Results of the width change amount in the longitudinal direction of the magnetic tape are shown in FIG. 39. As shown in FIG. 39, the width change amounts on the outer winding side at positions 0 to 20 exhibited negative values, and the width change amounts on the inner winding side at positions 60 to 84 also exhibited negative values.

### Comparative Example 4

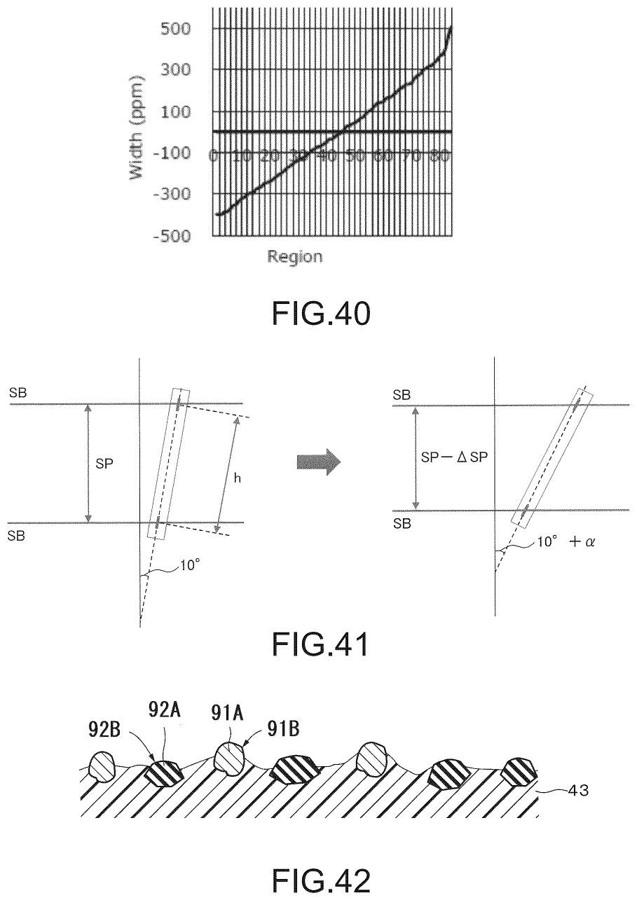

A magnetic tape was obtained by the same method as in Example 2a except that an aramid film (hereinafter, will be referred to as “ARAMID film”) was used as the base layer, a resin with Tg of 70° C. was used as the polyurethane-based resin to be mixed with the coating material for forming a magnetic layer and the coating material for forming an underlayer, and polyisocyanate was not added as the curing agent to the coating material for forming an underlayer. In the same manner as in Example 2, a magnetic recording cartridge was manufactured using the magnetic tape, and servo patterns were recorded onto the magnetic tape. Results of the width change amount in the longitudinal direction of the magnetic tape are shown in FIG. 40.

### Comparative Example 5

A magnetic tape was obtained by the same method as in Example 2a except that the average thickness of the base layer was set to 4.0 μm, the average thicknesses of the magnetic layer and the underlayer were set to 1.2 μm, the average thickness of the back layer was set to 0.4 μm, the average total thickness was set to 5.6 μm, a resin with Tg of 70° C. was used as a polyurethane-based resin to be mixed with the coating material for forming a magnetic layer and the coating material for forming an underlayer, and polyisocyanate was not added as the curing agent to the coating material for forming an underlayer. In the same manner as in Example 2, a magnetic recording cartridge was manufactured using the magnetic tape, and servo patterns were recorded onto the magnetic tape.

Table 1 and Table 2 show the configurations and evaluation results of the magnetic tapes of Examples 1 to 3 and Comparative Examples 1a to 5. Further, FIGS. 34 to 40 are diagrams respectively showing the width change amounts in the longitudinal direction in the magnetic tapes of Examples 1 to 3 and Comparative Examples 1a to 4.

TABLE 1

| | | | | | | Loss |
|---|---|---|---|---|---|---|
| | | Magnetic | | | | elastic |
| | | layer | | | | modulus |
| | | thickness, | | | Magnetic | of base |
| | Base | underlayer | Back | Total | particle | layer at |
| | thickness | thickness | thickness | thickness | size | 65 °C |
| | (μm) | (μm) | (μm) | (μm) | (nm³) | (Gpa) |
| Example 1 | 4.0 | 0.9 | 0.3 | 5.2 | 1600 | 0.07 |
| Example 2a | 4.0 | 0.9 | 0.3 | 5.2 | 1600 | 0.36 |
| Example 2b | 4.0 | 0.9 | 0.3 | 5.2 | 1600 | 0.36 |
| Example 2c | 4.0 | 0.9 | 0.3 | 5.2 | 1600 | 0.36 |
| Example 2d | 4.0 | 0.9 | 0.3 | 5.2 | 1600 | 0.36 |
| Example 3 | 4.0 | 0.9 | 0.4 | 5.3 | 1600 | 0.04 |
| Comparative | 4.0 | 0.9 | 0.3 | 5.2 | 1600 | 0.36 |
| Example 1a | | | | | | |
| Comparative | 4.0 | 0.9 | 0.3 | 5.2 | 1600 | 0.36 |
| Example 1b | | | | | | |
| Comparative | 4.0 | 1.2 | 0.4 | 5.6 | 1600 | 0.07 |
| Example 2 | | | | | | |
| Comparative | 4.0 | 0.9 | 0.3 | 5.2 | 1600 | 0.36 |
| Example 3 | | | | | | |
| Comparative | 4.0 | 0.9 | 0.3 | 5.2 | 1600 | 0.45 |
| Example 4 | | | | | | |
| Comparative | 4.0 | 1.2 | 0.4 | 5.6 | 1600 | 0.36 |
| Example 5 | | | | | | |

| | | | | | Running |
|---|---|---|---|---|---|
| | | | | | characteristics |
| | | | | | after rewinding |
| | | | | | and long-term |
| | | | | | storage |
| | Width change amount Δ after | | | | Presence/ |
| | storage at 65 °C for 360 hours | | | | absence of |
| | Outer | Inner | | | occurrence |
| | winding | winding | Maximum | Width change | of failure |
| | side | side | width − | zero position | (difference: |
| | (minimum | (maximum | minimum | Quadrisection | maximum − |
| | width ppm) | width ppm) | width | of entire length | minimum) |
| Example 1 | −136 | 49 | 185 | C region | A (98 ppm) |
| Example 2a | −134 | 194 | 328 | B region | A (240 ppm) |
| Example 2b | −134 | 194 | 328 | B region | A (240 ppm) |
| Example 2c | −134 | 194 | 328 | B region | A (240 ppm) |
| Example 2d | −134 | 194 | 328 | B region | A (240 ppm) |
| Example 3 | −194 | 335 | 529 | B region | A (272 ppm) |
| Comparative | −134 | 194 | 328 | B region | — |
| Example 1a | | | | | |
| Comparative | −134 | 194 | 328 | B region | — |
| Example 1b | | | | | |
| Comparative | 0 | 91 | 91 | No zero | B |
| Example 2 | | | | position | |
| Comparative | −1657 | −26 | 1631 | No zero | C |
| Example 3 | | | | position | |
| Comparative | −397 | 508 | 905 | C region | B |
| Example 4 | | | | | |
| Comparative | −34 | 196 | 230 | A region | B |
| Example 5 | | | | | |

TABLE 2

| | Carbon | | Alumina | | | |
|---|---|---|---|---|---|---|
| | size | Carbon | size | Alumina | Calender | Calender |
| | (nm) | amount | (nm) | amount | temperature | pressure |
| Example 1 | 70 | 2.0 | 80 | 7.5 | Reference | Reference |
| Example 2a | 70 | 2.0 | 80 | 7.5 | Low | Reference |
| | | | | | temperature | |
| Example 2b | 70 | 2.0 | 80 | 5.0 | Reference | Reference |
| Example 2c | 70 | 2.0 | 50 | 7.5 | High | Reference |
| | | | | | temperature | |
| Example 2d | 70 | 2.0 | 80 | 5.0 | Reference | Reference |
| Example 3 | 70 | 2.0 | 80 | 7.5 | Reference | Reference |
| Comparative | 70 | 2.0 | 50 | 7.5 | Low | Low |
| Example 1a | | | | | temperature | pressure |
| Comparative | 70 | 2.0 | 50 | 5.0 | Reference | Reference |
| Example 1b | | | | | | |
| Comparative | 70 | 2.0 | 80 | 7.5 | Reference | Reference |
| Example 2 | | | | | | |
| Comparative | 70 | 2.0 | 80 | 7.5 | High | Reference |
| Example 3 | | | | | temperature | |
| Comparative | 70 | 2.0 | 80 | 5.0 | Reference | Reference |
| Example 4 | | | | | | |
| Comparative | 70 | 2.0 | 80 | 5.0 | Reference | Reference |
| Example 5 | | | | | | |

| | Surface unevenness | | | | | Evaluation result | |
|---|---|---|---|---|---|---|---|
| | Carbon/ | Carbon C | Alumina A | | | | Friction |
| | alumina | protrusion | protrusion | | | | increase |
| | protrusion | average | average | | | | (PES |
| | height | height H1 | height H2 | Δ H | Δ A | SNR | increase) |
| | ratio | (nm) | (NM) | (nm) | (°) | (dB) | (NM) |
| Example 1 | 1.1 | 7.5 | 6.8 | 4.80 | 5.00 | 1.4 | 24 |
| Example 2a | 2.2 | 11.2 | 5.0 | 5.70 | 8.07 | 1.5 | 40 |
| Example 2b | 2.0 | 10.4 | 5.1 | 5.56 | 5.53 | 1.3 | 43 |
| Example 2c | 1.7 | 11.3 | 6.5 | 3.51 | 4.22 | 2.0 | 37 |
| Example 2d | 3.0 | 14.7 | 4.9 | 4.46 | 4.99 | 1.8 | 60 |
| Example 3 | 1.5 | 7.6 | 5.0 | 5.77 | 5.13 | 1.5 | 33 |
| Comparative | 1.8 | 11.5 | 6.4 | 4.50 | 9.50 | Powder | Powder |
| Example 1a | | | | | | falling | falling |
| Comparative | 2.2 | 13.8 | 6.3 | 2.82 | 7.30 | Sticking | Sticking |
| Example 1b | | | | | | | |
| Comparative | 2.2 | 11.3 | 5.1 | 6.33 | 5.90 | 0.0 | — |
| Example 2 | | | | | | | |
| Comparative | 2.1 | 10.3 | 5.0 | 4.50 | 3.85 | — | — |
| Example 3 | | | | | | | |
| Comparative | 1.9 | 11.8 | 6.1 | 6.28 | 5.75 | 0.5 | — |
| Example 4 | | | | | | | |
| Comparative | 2.4 | 12.2 | 5.1 | 9.58 | 7.01 | −0.8 | — |
| Example 5 | | | | | | | |

The following can be understood from the results shown in Table 1.

Upon performing entire-surface reproduction using a magnetic recording/reproducing device after being stored for two weeks under an environment of 65° C. and 40 RH %, rewound such that the outer and inner winding sides are reversed, and stored for another two weeks under the same environment, all of the magnetic tapes of Examples 1 to 3 showed favorable running characteristics with the running characteristics evaluation of A and with no occurrence of failure. Thus, it can be seen that the magnetic recording cartridge according to the present technology is suited for storage and use under the high-temperature environment of 60° C. or more.

From the results of the tape width change amount in the longitudinal direction of the magnetic tape for Example 1 and Comparative Example 2a, it can be seen that by the sign of the width change amount Δout on the outer winding side being different from the sign of the width change amount Δin on the inner winding side, the magnetic tape can improve the running characteristics by the rewinding and long-term storage.

It can be seen from comparing Example 2a and Comparative Example 3 that when (width change amount Δin on inner winding side of magnetic tape)−(width change amount Δout on outer winding side of magnetic tape) after storage at 65° C. for 360 hours is 800 ppm or less, the running characteristics by the rewinding and long-term storage can be improved.

It can be seen from comparing Example 1 and Comparative Example 3 that, by the width change amount Δ of the magnetic tape after storage at 65° C. for 360 hours being 0 ppm in C regions which are two regions between which a center line of the entire length of the magnetic tape is situated, the two regions being from among four regions into which the entire length of the magnetic tape in the longitudinal direction is quadrisected, the running characteristics by the rewinding and long-term storage can be improved.

It can be seen from comparing Example 2a and Comparative Example 4 that, by the loss elastic modulus of the base layer at 65° C. being 0.40 GPa or less, the running characteristics by the rewinding and long-term storage can be improved.

It can be seen from comparing Example 2c and Comparative Example 1b that, by setting the height range ΔH such that 3.00 nm≤ΔH≤6.00 nm, it is possible to obtain excellent electromagnetic conversion characteristics and suppress an increase in friction.

It can be seen from comparing Example 2a and Comparative Example 1a that, by setting the gradient range ΔA such that 3.80 degrees≤ΔA≤9.00 degrees, it is possible to obtain excellent electromagnetic conversion characteristics and suppress an increase in friction.

Heretofore, the embodiments and examples of the present technology have been specifically described. However, the present technology is not limited to the embodiments and examples described above and can be variously modified based on the technical idea of the present technology.

For example, the configurations, methods, processes, shapes, materials, numerical values, and the like given in the embodiments and examples described above are mere examples, and different configurations, methods, processes, shapes, materials, numerical values, and the like may be used as necessary. In addition, the chemical formulae of compounds and the like are representative ones and are not limited to the described valences and the like as long as they are of general names of the same compounds.

Further, the configurations, methods, processes, shapes, materials, numerical values, and the like of the embodiments and examples described above can be combined with one another without departing from the gist and scope of the present technology.

Furthermore, in the present specification, the numerical value range indicated using “to” indicates a range that includes numerical values respectively described before and after “to” as a minimum value and a maximum value. In the numerical value ranges described stepwise in the present specification, an upper limit value or lower limit value of a numerical value range of a certain stage may be replaced with an upper limit value or lower limit value of a numerical value range of another stage. Regarding the materials exemplified in the present specification, one type may be used alone, or two or more types may be used in combination unless stated otherwise.

It is noted that the present technology can also take the following configurations.
[1] A magnetic recording cartridge, including:
   a cartridge case;
   a reel; and
   a magnetic recording medium wound on the reel, the wound magnetic recording medium being accommodated in the cartridge case, in which
   when a width change amount of the magnetic recording medium is measured across an entire length of the magnetic recording medium after the magnetic recording medium wound on the reel is stored at 65° C. for 360 hours,
      a sign of a width change amount Δout on an outer winding side of the magnetic recording medium and a sign of a width change amount Δin on an inner winding side of the magnetic recording medium differ, and
      the width change amount is 0 ppm at a position of one of two regions between which a center line of the entire length of the magnetic recording medium is situated, the two regions being from among four regions into which the entire length is quadrisected,
   the magnetic recording medium includes a magnetic layer,
   the magnetic layer has a concavo-convex shape on a magnetic surface thereof,
   a height range ΔH obtained from statistical information regarding a height of the concavo-convex shape satisfies “3.00 nm≤ΔH≤6.00 nm”,
   a gradient range ΔA obtained from statistical information regarding a gradient of the concavo-convex shape satisfies “3.80 degrees≤ΔA≤9.00 degrees”, and
   the magnetic recording medium includes a base layer having a loss elastic modulus of 0.40 GPa or less at 65° C.
[2] The magnetic recording cartridge according to [1], in which
   the width change amount Δin of the magnetic recording medium exhibits a positive value, and the width change amount Δout of the magnetic recording medium exhibits a negative value.
[3] The magnetic recording cartridge according to [1] or [2], in which
   when the entire length of the magnetic recording medium in a longitudinal direction of the magnetic recording medium is set to be 100%, the width change amount Δ of the magnetic recording medium after being stored at 65° C. for 360 hours is 0 ppm at a position corresponding to a length of 25% to 75% as viewed from an end portion of the magnetic recording medium on the outer winding side.
[4] The magnetic recording cartridge according to any one of [1] to [3], in which
   with respect to the magnetic recording medium, the width change amount Δin of the magnetic recording medium minus the width change amount Δout of the magnetic recording medium is 800 ppm or less.
[5] The magnetic recording cartridge according to any one of [1] to [4], in which
   a storage elastic modulus of the base layer at 65° C. is 8.0 GPa or less.
[6] The magnetic recording cartridge according to any one of [1] to [5], in which
   the base layer is formed of polyethylene terephthalate (PET), polyethylene naphthalate (PEN), or polyether ether ketone (PEEK).
[7] The magnetic recording cartridge according to any one of [1] to [6], in which
   an average thickness t_{T} of the magnetic recording medium is 5.4 μm or less.
[8] The magnetic recording cartridge according to any one of [1] to [7], in which
   an average thickness t_{B} of the base layer is 4.6 μm or less.
[9] The magnetic recording cartridge according to any one of [1] to [8], in which
   the magnetic layer contains magnetic powder.
[10] The magnetic recording cartridge according to any one of [1] to [9], in which
   the magnetic layer contains magnetic particles, first particles having electrical conductivity, and second particles having a polishing effect,
   the concavo-convex shape includes first protrusions formed of the first particles and second protrusions formed of the second particles, and
   a ratio H1/H2 of an average height H1 of the first protrusions to an average height H2 of the second protrusions satisfies “H1/H2≤2.3”.
[11] The magnetic recording cartridge according to [10], in which
   the ratio H1/H2 satisfies “1.0≤H1/H2≤1.7 or less”.
[12] The magnetic recording cartridge according to any one of [1] to [11], in which
   the height range ΔH satisfies “3.00 nm≤ΔH≤4.00 nm”.
[13] The magnetic recording cartridge according to any one of [10] to [12], in which
   the average height H1 of the first protrusions is 5.0 nm or more and 12.0 nm or less, and
   the average height H2 of the second protrusions is 2.0 nm or more and 7.0 nm or less.
[14] The magnetic recording cartridge according to any one of [10] to [13], in which
   the first particles are carbon particles.
[15] The magnetic recording cartridge according to any one of [10] to [14], in which
   the second particles are alumina particles.
[16] The magnetic recording cartridge according to any one of [1] to [15], in which
   an average thickness of the magnetic layer is 80 nm or less.
[17] The magnetic recording cartridge according to any one of [1] to [16], in which
   the magnetic recording medium further includes an underlayer having an average thickness of 0.9 μm or less.
[18] The magnetic recording cartridge according to any one of [10] to [17], in which
   an average particle volume of the magnetic particles is 1600 nm³ or less.
[19] The magnetic recording cartridge according to any one of [1] to [18], in which
   the magnetic layer contains magnetic particles, carbon particles, and an abrasive,
   the concavo-convex shape includes first protrusions formed of the carbon particles, and second protrusions formed of the abrasive, and
   a ratio H1/H2 of an average height H1 of the first protrusions to an average height H2 of the second protrusions satisfies “H1/H2≤2.3”.
[20] A magnetic recording medium wound on a reel of a magnetic recording cartridge, the wound magnetic recording medium being accommodated in a cartridge case of the magnetic recording cartridge, in which
   when a width change amount of the magnetic recording medium is measured across an entire length of the magnetic recording medium after the magnetic recording medium wound on the reel is stored at 65° C. for 360 hours,
      a sign of a width change amount Δout on an outer winding side of the magnetic recording medium and a sign of a width change amount Δin on an inner winding side of the magnetic recording medium differ, and
      the width change amount is 0 ppm at a position of one of two regions between which a center line of the entire length of the magnetic recording medium is situated, the two regions being from among four regions into which the entire length is quadrisected,
   the magnetic recording medium includes a magnetic layer,
   the magnetic layer has a concavo-convex shape on a magnetic surface thereof,
   a height range ΔH obtained from statistical information regarding a height of the concavo-convex shape satisfies “3.00 nm≤ΔH≤6.00 nm”,
   a gradient range ΔA obtained from statistical information regarding a gradient of the concavo-convex shape satisfies “3.80 degrees≤ΔA≤9.00 degrees”, and
   the magnetic recording medium includes a base layer having a loss elastic modulus of 0.40 GPa or less at 65° C.

### REFERENCE SIGNS LIST

MT magnetic tape
10 magnetic recording cartridge
13 reel
41 base layer
42 underlayer
43 magnetic layer
44 back layer

1. A magnetic recording cartridge, comprising:
a cartridge case;
a reel; and
a magnetic recording medium wound on the reel, the wound magnetic recording medium being accommodated in the cartridge case, wherein
when a width change amount of the magnetic recording medium is measured across an entire length of the magnetic recording medium after the magnetic recording medium wound on the reel is stored at 65° C. for 360 hours,
a sign of a width change amount Δout on an outer winding side of the magnetic recording medium and a sign of a width change amount Δin on an inner winding side of the magnetic recording medium differ, and
the width change amount is 0 ppm at a position of one of two regions between which a center line of the entire length of the magnetic recording medium is situated, the two regions being from among four regions into which the entire length is quadrisected,
the magnetic recording medium includes a magnetic layer,
the magnetic layer has a concavo-convex shape on a magnetic surface thereof,
a height range ΔH obtained from statistical information regarding a height of the concavo-convex shape satisfies “3.00 nm≤ΔH≤6.00 nm”,
a gradient range ΔA obtained from statistical information regarding a gradient of the concavo-convex shape satisfies “3.80 degrees≤ΔA≤9.00 degrees”, and
the magnetic recording medium includes a base layer having a loss elastic modulus of 0.40 GPa or less at 65° C.

2. The magnetic recording cartridge according to claim 1, wherein
the width change amount Δin of the magnetic recording medium exhibits a positive value, and the width change amount Δout of the magnetic recording medium exhibits a negative value.

3. The magnetic recording cartridge according to claim 1, wherein
when the entire length of the magnetic recording medium in a longitudinal direction of the magnetic recording medium is set to be 100%, the width change amount Δ of the magnetic recording medium after being stored at 65° C. for 360 hours is 0 ppm at a position corresponding to a length of 25% to 75% as viewed from an end portion of the magnetic recording medium on the outer winding side.

4. The magnetic recording cartridge according to claim 1, wherein
with respect to the magnetic recording medium, the width change amount Δin of the magnetic recording medium minus the width change amount Δout of the magnetic recording medium is 800 ppm or less.

5. The magnetic recording cartridge according to claim 1, wherein
a storage elastic modulus of the base layer at 65° C. is 8.0 GPa or less.

6. The magnetic recording cartridge according to claim 1, wherein
the base layer is formed of polyethylene terephthalate (PET), polyethylene naphthalate (PEN), or polyether ether ketone (PEEK).

7. The magnetic recording cartridge according to claim 1, wherein
an average thickness t_{T} of the magnetic recording medium is 5.4 μm or less.

8. The magnetic recording cartridge according to claim 1, wherein
an average thickness t_{B} of the base layer is 4.6 μm or less.

9. The magnetic recording cartridge according to claim 1, wherein
the magnetic layer contains magnetic powder.

10. The magnetic recording cartridge according to claim 1, wherein
the magnetic layer contains magnetic particles, first particles having electrical conductivity, and second particles having a polishing effect,
the concavo-convex shape includes first protrusions formed of the first particles and second protrusions formed of the second particles, and
a ratio H1/H2 of an average height H1 of the first protrusions to an average height H2 of the second protrusions satisfies “H1/H2≤2.3”.

11. The magnetic recording cartridge according to claim 10, wherein
the ratio H1/H2 satisfies “1.0≤H1/H2≤1.7 or less”.

12. The magnetic recording cartridge according to claim 1, wherein
the height range ΔH satisfies “3.00 nm≤ΔH≤4.00 nm”.

13. The magnetic recording cartridge according to claim 10, wherein
the average height H1 of the first protrusions is 5.0 nm or more and 12.0 nm or less, and
the average height H2 of the second protrusions is 2.0 nm or more and 7.0 nm or less.

14. The magnetic recording cartridge according to claim 10, wherein
the first particles are carbon particles.

15. The magnetic recording cartridge according to claim 10, wherein
the second particles are alumina particles.

16. The magnetic recording cartridge according to claim 1, wherein
an average thickness of the magnetic layer is 80 nm or less.

17. The magnetic recording cartridge according to claim 1, wherein
the magnetic recording medium further includes an underlayer having an average thickness of 0.9 μm or less.

18. The magnetic recording cartridge according to claim 10, wherein
an average particle volume of the magnetic particles is 1600 nm³ or less.

19. The magnetic recording cartridge according to claim 1, wherein
the magnetic layer contains magnetic particles, carbon particles, and an abrasive,
the concavo-convex shape includes first protrusions formed of the carbon particles, and second protrusions formed of the abrasive, and
a ratio H1/H2 of an average height H1 of the first protrusions to an average height H2 of the second protrusions satisfies “H1/H2≤2.3”.

20. A magnetic recording medium wound on a reel of a magnetic recording cartridge, the wound magnetic recording medium being accommodated in a cartridge case of the magnetic recording cartridge, wherein
when a width change amount of the magnetic recording medium is measured across an entire length of the magnetic recording medium after the magnetic recording medium wound on the reel is stored at 65° C. for 360 hours,
a sign of a width change amount Δout on an outer winding side of the magnetic recording medium and a sign of a width change amount Δin on an inner winding side of the magnetic recording medium differ, and
the width change amount is 0 ppm at a position of one of two regions between which a center line of the entire length of the magnetic recording medium is situated, the two regions being from among four regions into which the entire length is quadrisected,
the magnetic recording medium comprises a magnetic layer,
the magnetic layer has a concavo-convex shape on a magnetic surface thereof,
a height range ΔH obtained from statistical information regarding a height of the concavo-convex shape satisfies “3.00 nm≤ΔH≤6.00 nm”,
a gradient range ΔA obtained from statistical information regarding a gradient of the concavo-convex shape satisfies “3.80 degrees≤ΔA≤9.00 degrees”, and
the magnetic recording medium comprises a base layer having a loss elastic modulus of 0.40 GPa or less at 65° C.
